(19) United States
(12) Patent Application Publication
(10) Pub. No.: US 2010/0318478 A1
(43) Pub. Date: Dec. 16, 2010

(54) INFORMATION PROCESSING DEVICE, INFORMATION PROCESSING METHOD, AND PROGRAM

(76) Inventors: Yukiko Yoshiike, Tokyo (JP); Kenta Kawamoto, Tokyo (JP); Kuniaki Noda, Tokyo (JP); Kohtaro Sabe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/791,240

(22) Filed: Jun. 1, 2010

(30) Foreign Application Priority Data
Jun. 11, 2009 (JP) P2009-140065

(51) Int. Cl. G06N 5/02; G06F 15/18

(52) U.S. Cl. 706/12; 706/52

(57) ABSTRACT

An information processing device includes: a calculating unit configured to calculate a current-state series candidate that is a state series for an agent capable of actions reaching the current state, based on a state transition probability model obtained by performing learning of the state transition probability model stipulated by a state transition probability that a state will be transitioned according to each of actions performed by an agent capable of actions, and an observation probability that a predetermined observation value will be observed from the state, using an action performed by the agent, and an observation value observed at the agent when the agent performs an action; and a determining unit configured to determine an action to be performed next by the agent using the current-state series candidate in accordance with a predetermined strategy.

### BACKGROUND OF THE INVENTION

1. Field of the Invention

The present invention relates to an information processing device, an information processing method, and a program, and specifically relates to, for example, an information processing device, an information processing method, and a program, which allows an agent capable of autonomously performing various types of actions to determine suitable actions.

2. Description of the Related Art

Examples of state predicting and behavior determining techniques include a method for applying a partially observed Markov decision process to automatically build a static partial observed Markov decision process from learned data (e.g., see Japanese Unexamined Patent Application Publication No. 2008-186326).

Also, examples of autonomous mobile robot and pendulum operation plan methods include a method for performing desired control by carrying out an operation plan dispersed by a Markov state model, further inputting a planed target to a controller, and deriving output to be given to an object to be controlled (e.g., see Japanese Unexamined Patent Application Publication Nos. 2007-317165 and 2006-268812).

### SUMMARY OF THE INVENTION

Various methods have been proposed as a method for determining a suitable action of an agent capable of autonomously performing various types of actions, and proposal of a further new method has been desired.

It has been found desirable to allow an agent to determine suitable actions, i.e., to allow an agent to determine suitable actions as actions to be performed by the agent.

An information processing device or program according to an embodiment of the present invention is an information processing device or a program causing a computer to serve as an information processing device including: a calculating unit configured to calculate a current-state series candidate that is a state series for an agent capable of actions reaching the current state, based on a state transition probability model obtained by performing learning of the state transition probability model stipulated by a state transition probability that a state will be transitioned according to each of actions performed by an agent capable of actions, and an observation probability that a predetermined observation value will be observed from the state, using an action performed by the agent, and an observation value observed at the agent when the agent performs an action; and a determining unit configured to determine an action to be performed next by the agent using the current-state series candidate in accordance with a predetermined strategy.

An information processing method according to an embodiment of the present invention is an information processing method including the steps of: calculating a current-state series candidate that is a state series for an agent capable of actions reaching the current state, based on a state transition probability model obtained by performing learning of the state transition probability model stipulated by a state transition probability that a state will be transitioned according to each of actions performed by an agent capable of actions, and an observation probability that a predetermined observation value will be observed from the state, using an action performed by the agent, and an observation value observed at the agent when the agent performs an action; and determining an action to be performed next by the agent using the current-state series candidate in accordance with a predetermined strategy.

With the above configurations, a current-state series candidate that is a state series for an agent capable of actions reaching the current state, based on a state transition probability model obtained by performing learning of the state transition probability model stipulated by a state transition probability that a state will be transitioned according to each of actions performed by an agent capable of actions, and an observation probability that a predetermined observation value will be observed from the state, using an action performed by the agent, and an observation value observed at the agent when the agent performs an action, is calculated. Also, an action to be performed next by the agent is determined using the current-state series candidate in accordance with a predetermined strategy.

Note that the information processing device may be a stand-alone device, or may be an internal block making up a device. Also, the program may be provided by being transmitted via a transmission medium, or by being recorded in a recording medium.

Thus, an agent can determine suitable actions as actions to be performed by the agent.

### BRIEF DESCRIPTION OF THE DRAWINGS

FIG. 1 is a diagram illustrating an action environment;

FIG. 2 is a diagram illustrating a situation where the configuration of an action environment is changed;

FIGS. 3A and 3B are diagrams illustrating actions performed by an agent, and observation values observed by the agent;

FIG. 4 is a block diagram illustrating a configuration example of an embodiment of an agent to which an information processing device according to the present invention has been applied;

FIG. 5 is a flowchart for describing processing in a reflective action mode;

FIG. 6 is a diagram for describing state transition probability of an expanded HMM (Hidden Marcov Model);

FIG. 7 is a flowchart for describing learning processing of the expanded HMM;

FIG. 8 is a flowchart for describing processing in a recognition action mode;

FIG. 9 is a flowchart for describing processing for determining a target state performed by a target determining unit;

FIGS. 10A through 10C are diagrams for describing calculation of an action plan performed by an action determining unit;

FIG. 11 is a diagram for describing correction of state transition probability of the expanded HMM performed by the action determining unit using an inhibitor;

FIG. 12 is a flowchart for describing updating processing of the inhibitor performed by a state recognizing unit;

FIG. 13 is a diagram for describing the state of the expanded HMM that is an open end detected by an open-edge detecting unit;

FIGS. 14A and 14B are diagrams for describing processing for the open-edge detecting unit listing a state in which an observation value is observed with probability equal to or greater than a threshold;

FIG. 15 is a diagram for describing a method for generating an action template using the state listed as to the observation value;

FIG. 16 is a diagram for describing a method for calculating action probability based on observation probability;

FIG. 17 is a diagram for describing a method for calculating action probability based on state transition probability;

FIG. 18 is a diagram schematically illustrating difference action probability;

FIG. 19 is a flowchart for describing processing for detecting an open edge;

FIG. 20 is a diagram for describing a method for detecting a branching structured state by a branching structure detecting unit;

FIGS. 21A and 21B are diagrams illustrating an action environment employed by simulation;

FIG. 22 is a diagram schematically illustrating the expanded HMM after learning by simulation;

FIG. 23 is a diagram illustrating simulation results;

FIG. 24 is a diagram illustrating simulation results;

FIG. 25 is a diagram illustrating simulation results;

FIG. 26 is a diagram illustrating simulation results;

FIG. 27 is a diagram illustrating simulation results;

FIG. 28 is a diagram illustrating simulation results;

FIG. 29 is a diagram illustrating simulation results;

FIG. 30 is a diagram illustrating the outline of a cleaning robot to which the agent has been applied;

FIGS. 31A and 31B are diagrams for describing the outline of state division for realizing a one-state one-observation-value constraint;

FIG. 32 is a diagram for describing a method for detecting a state which is the object of dividing;

FIGS. 33A and 33B are diagrams for describing a method for dividing a state which is the object of dividing into divided states;

FIGS. 34A and 34B are diagrams for describing the outline of state merge for realizing the one-state one-observation-value constraint;

FIGS. 35A and 35B are diagrams for describing a method for detecting states which are the object of merging;

FIGS. 36A and 36B are diagrams for describing a method for merging multiple branched states into one representative state;

FIG. 37 is a flowchart for describing processing for learning the expanded HMM performed under the one-state one-observation-value constraint;

FIG. 38 is a flowchart for describing processing for detecting a state which is the object of dividing;

FIG. 39 is a flowchart for describing state division processing;

FIG. 40 is a flowchart for describing processing for detecting states which are the object of merging;

FIG. 41 is a flowchart for describing the processing for detecting states which are the object of merging;

FIG. 42 is a flowchart for describing state merge processing;

FIGS. 43A through 43C are diagrams for describing learning simulation of the expanded HMM under the one-state one-observation-value constraint;

FIG. 44 is a flowchart for describing processing in the recognition action mode;

FIG. 45 is a flowchart for describing current state series candidate calculation processing;

FIG. 46 is a flowchart for describing current state series candidate calculation processing;

FIG. 47 is a flowchart for describing action determination processing in accordance with a first strategy;

FIG. 48 is a diagram for describing the outline of action determination in accordance with a second strategy;

FIG. 49 is a flowchart for describing action determination processing in accordance with the second strategy;

FIG. 50 is a diagram for describing the outline of action determination in accordance with a third strategy;

FIG. 51 is a flowchart for describing action determination processing in accordance with the third strategy;

FIG. 52 is a flowchart for describing processing for selecting a strategy to be followed at the time of determining an action out of multiple strategies;

FIG. 53 is a flowchart for describing processing for selecting a strategy to be followed at the time of determining an action out of multiple strategies; and

FIG. 54 is a block diagram illustrating a configuration example of an embodiment of a computer to which the present invention has been applied.

### DESCRIPTION OF THE PREFERRED EMBODIMENTS

### Environment in Which Agent Performs Actions

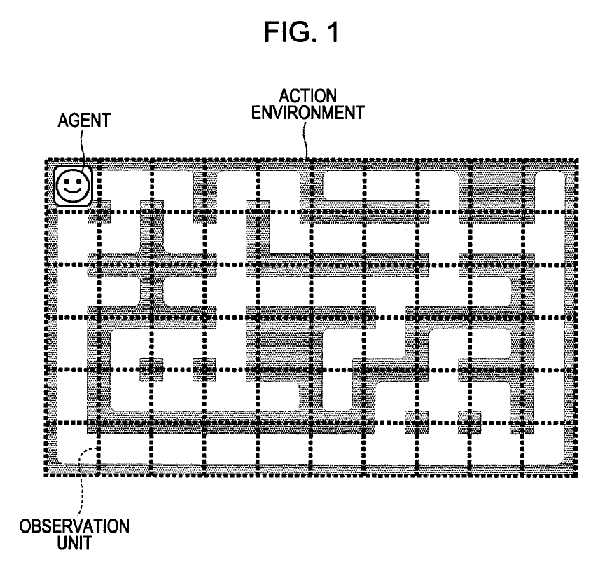

FIG. 1 is a diagram illustrating an example of an action environment that is an environment in which an agent to which an information processing device according to the present invention has been applied performs actions.

The agent is a device capable of autonomously performing actions (behaviors) such as movement and the like, for example, such as a robot (may be a robot which acts in the real world, or may be a virtual robot which acts in a virtual world), or the like.

The agent can change the situation of the agent itself by performing an action, and can recognize the situation by observing information that can be observed externally, and using an observation value that is an observation result thereof.

Also, the agent builds an action environment model (environment model) in which the agent performs actions to recognize situations, and to determine (select) an action to be performed in each situation.

The agent performs effective modeling (buildup of an environment model) regarding an action environment of which the configuration is not fixed but changed in a probabilistic manner as well as an action environment of which the configuration is fixed.

In FIG. 1, the action environment is made up of a two-dimensional plane maze, and configuration thereof is changed in a probabilistic manner. Note that, with the action environment in FIG. 1, the agent can move on a white portion in the drawing as a path.

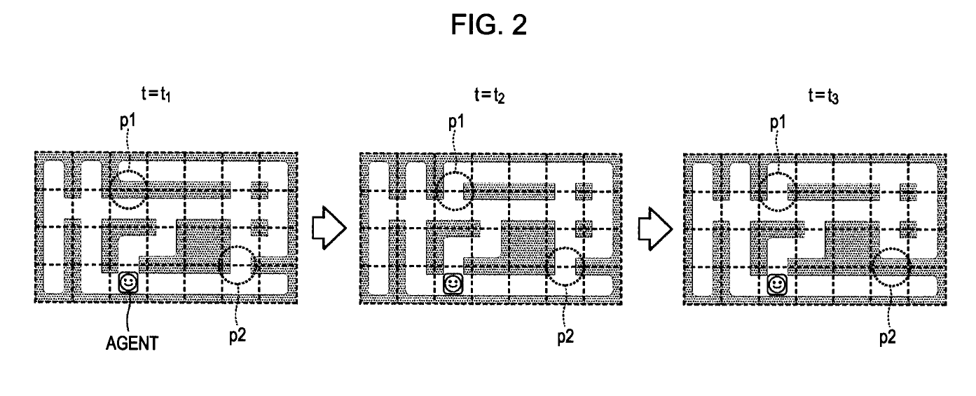

FIG. 2 is a diagram illustrating a situation in which the configuration of an action environment is changed. With the action environment in FIG. 2, at point-in-time t=t₁ a position p1 makes up the wall, and a position p2 makes up the path. Accordingly, at the point-in-time t=t₁ the action environment has a configuration wherein the agent can pass through the position p2 not but the position p1.

Subsequently, at point-in-time t=t₂ (>t₁) the position p1 is changed from the wall to the path, and as a result thereof, the action environment has a configuration wherein the agent can pass through both of the positions p1 and p2.

Further, subsequently at point-in-time t=t₃ the position p2 is changed from the path to the wall, and as a result thereof, the action environment has a configuration wherein the agent can pass through the position p1 not but the position p2.

### Actions Performed by Agent, and Observation Values Observed by Agent

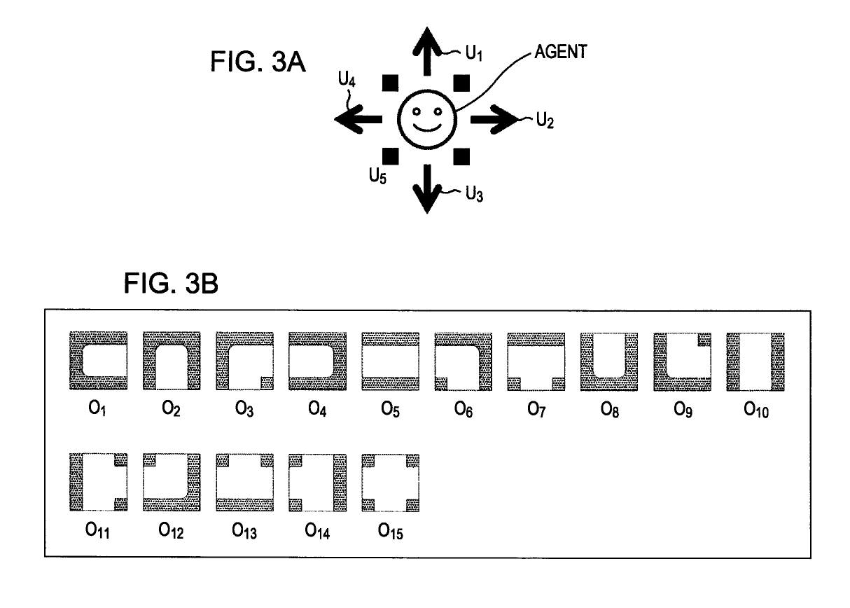

FIGS. 3A and 3B illustrate an example of actions performed by the agent, and observation values observed by the agent in the action environment.

The agent performs, with areas in an action environment such as shown in FIG. 1 sectioned in a square shape by a dotted line as units for observing an observation value (observation units), an action that moves in the observation units thereof.

FIG. 3A illustrates the types of actions performed by the agent. In FIG. 3A, the agent can perform an action U₁ for moving in the upper direction by the observation units, an action U₂ for moving in the right direction by the observation units, an action U₃ for moving in the bottom direction by the observation units, an action U₄ for moving in the left direction by the observation units, and an action U₅ for not moving (performing nothing) in total the five actions U₁ through U₅ in the drawing.

FIG. 3B schematically illustrates the types of observation values observed by the agent in the observation units. With the present embodiment, the agent observes any one of 15 types of observation values (symbols) O₁ through O₁₅ in the observation units.

The observation value O₁ is observed in the observation units wherein the top, bottom, and left make up the wall, and the right makes up the path, and the observation value O₂ is observed in the observation units wherein the top, left, and right make up the wall, and the bottom makes up the path.

The observation value O₃ is observed in the observation units wherein the top and left make up the wall, and the bottom and right makes up the path, and the observation value O₄ is observed in the observation units wherein the top, bottom, and right make up the wall, and the left makes up the path.

The observation value O₅ is observed in the observation units wherein the top and bottom make up the wall, and the left and right makes up the path, and the observation value O₆ is observed in the observation units wherein the top and right make up the wall, and the bottom and left make up the path.

The observation value O₇ is observed in the observation units wherein the top makes up the wall, and the bottom, left, and right make up the path, and the observation value O₈ is observed in the observation units wherein the bottom, left, and right make up the wall, and the top makes up the path.

The observation value O₉ is observed in the observation units wherein the bottom and left make up the wall, and the top and right makes up the path, and the observation value O₁₀ is observed in the observation units wherein the left and right make up the wall, and the top and bottom make up the path.

The observation value O₁₁ is observed in the observation units wherein the left makes up the wall, and the top, bottom, and right make up the path, and the observation value O₁₂ is observed in the observation units wherein the bottom and right make up the wall, and the top and left make up the path.

The observation value O₁₃ is observed in the observation units wherein the bottom makes up the wall, and the top, left, and right make up the path, and the observation value O₁₄ is observed in the observation units wherein the right makes up the wall, and the top, bottom, and left make up the path.

The observation value O₁₅ is observed in the observation units wherein all of the left, right, top, and bottom make up the path.

Note that an action Uₘ (m=1, 2, and so on through M (M is the total of (the types of) actions) and an observation value Oₖ (k=1, 2, and so on through K (K is the total of observation values) are both discrete values.

### Configuration Example of Agent

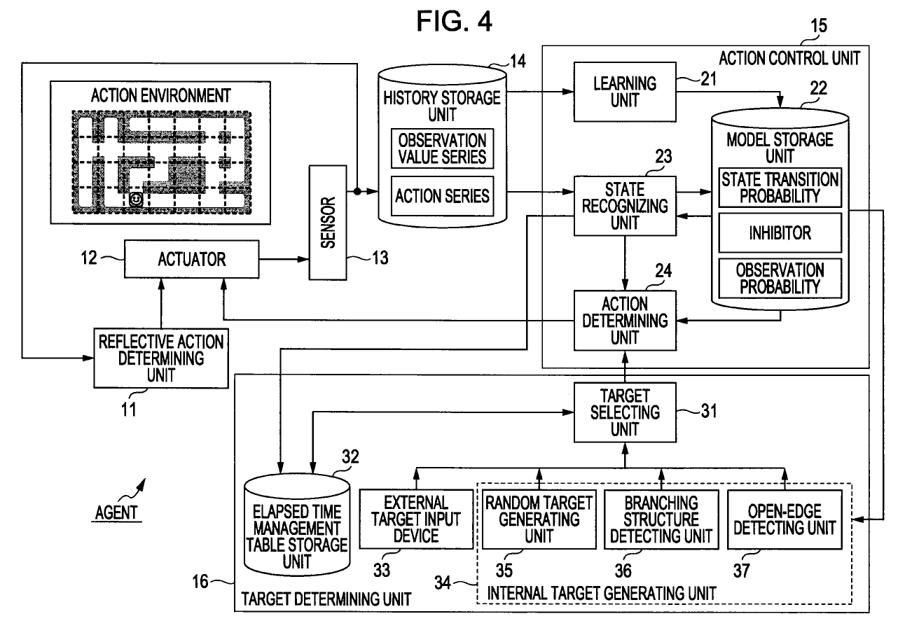

FIG. 4 is a block diagram illustrating a configuration example of an embodiment of the agent to which the information processing device according to the present invention has been applied. The agent obtains an environment model modeled from an action environment by learning. Also, the agent performs recognition of the current situation of the agent itself using the series of observation values (observation value series).

Further, the agent performs planning of the plan of an action to be performed toward a certain target from the current situation (action plan), and determines an action to be performed next in accordance with the action plan thereof.

Note that learning, recognition of situations, and planning of actions (determination of actions) that the agent performs can be applied to a problem that can be formulated with the framework of Marcov decision process (MDP) that is commonly taken as a reinforcement learning problem as well as a problem (task) wherein the agent moves in the upper, lower, left, or right direction in the observation units.

In FIG. 4, the agent moves in the observation units by performing the action Uₘ shown in FIG. 3A in the action environment, and obtains the observation value Oₖ observed in the observation units after movement.

Subsequently, the agent performs learning of ((the environment model modeled from) the configuration of) an action environment, or determination of an action to be performed next using action series that are series of (symbols representing) the action Uₘ performed up to now, and observation value series that are series of (symbols representing) the observation value Oₖ observed up to now.

Two modes of a reflective action mode (reflective behavior mode) and a recognition action mode (recognition behavior mode) are available as modes wherein the agent performs actions.

In the reflective action mode, a rule for determining an action to be performed next is designed from observation value series and action series obtained in the past as an innate rule beforehand.

Here, as an innate rule there may be employed a rule for determining an action (for allowing reciprocating motion within the path) so as not to be collided with the wall, or a rule for determining an action so as not to be collided with the wall, and also so as not to return to where the agent came from until the agent reaching the dead end, or the like.

The agent repeats determining an action to be performed next as to the observation value observed at the agent in accordance with the innate rule, and observing observation values in the observation units after the action thereof.

Thus, the agent obtains action series and observation value series at the time of moving in the action environment. The action series and observation value series thus obtained in the reflective action mode are used for learning of the action environment. That is to say, the reflective action mode is principally used for obtaining action series and observation value series serving as learned data to be used for learning of the action environment.

In the recognition action mode, the agent determines a target, recognizes the current situation, and determines an action plan for achieving the target from the current situation thereof. Subsequently, the agent determines an action to be performed next in accordance with the action plan thereof.

Note that switching between the reflective action mode and the recognition action mode can be performed, for example, according to a user's operation or the like.

In FIG. 4, the agent is configured of a reflective action determining unit 11, an actuator 12, a sensor 13, a history storage unit 14, an action control unit 15, and a target determining unit 16. The observation value observed in the action environment output from the sensor 13 is supplied to the reflective action determining unit 11.

In the reflective action mode, the reflective action determining unit 11 determines an action to be performed next as to the observation value supplied from the sensor 13 in accordance with the innate rule, and controls the actuator 12.

For example, in the case that the agent is a robot walking in the real world, the actuator 12 is a motor or the like for walking the agent, and is driven in accordance with the control of the reflective action determining unit 11 or a later-described action determining unit 24. According to the actuator being driven, with the action environment, the agent performs the action determined by the reflective action determining unit 11 or action determining unit 24.

The sensor 13 performs sensing of information that can be observed externally to output an observation value serving as a sensing result thereof. Specifically, the sensor 13 observes the observation units wherein the agent exists of the action environment, and outputs a symbol representing the observation units thereof as an observation value.

Note that, in FIG. 4, the sensor 13 also observes the actuator 12, and thus outputs (a symbol representing) the action performed by the agent. The observation value output from the sensor 13 is supplied to the reflective action determining unit 11 and the history storage unit 14. Also, the action output from the sensor 13 is supplied to the history storage unit 14.

The history storage unit 14 sequentially stores the observation values and actions output from the sensor 13. Thus, the series of the observation values (observation value series), and the series of the actions (action series) are stored in the history storage unit 14.

Note that a symbol representing the observation units wherein the agent exists is employed here as an observation value that can be observed externally, but a symbol representing the observation units wherein the agent exists, and a symbol representing the action performed by the agent may be employed as a set.

The action control unit 15 performs learning of a state transition probability model serving as an environment model for storing (obtaining) the configuration of the action environment using the observation value series and the action series stored in the history storage unit 14.

Also, the action control unit 15 calculates an action plan based on the state transition probability model after learning. Further, the action control unit 15 determines an action to be performed next at the agent in accordance with the action plan thereof, and controls the actuator 12 to cause the agent to perform an action in accordance with the action thereof.

The action control unit 15 is configured of a learning unit 21, a model storage unit 22, a state recognizing unit 23, and an action determining unit 24.

The learning unit 21 performs learning of the state transition probability model stored in the model storage unit 22 using the action series and observation value series stored in the history storage unit 14.

Now, the state transition probability model that the learning unit 21 employs as a learning object is a state transition probability model stipulated by state transition probability for each action, of which the state is transitioned by the action performed by the agent, and observation probability wherein a predetermined observation value is observed from states.

Examples of the state transition probability model include an HMM (Hidden Marcov Model), but the state transition probability of a common HMM does not exist for each action. Therefore, with the present embodiment, the state transition probability of the HMM is expanded to state transition probability for each action performed by the agent, and the HMM of which the state transition probability is thus expanded (hereafter, also referred to as “expanded HMM”) is employed as a learning object by the learning unit 21.

The model storage unit 22 stores (the state transition probability, observation probability, and the like that are model parameters stipulating) the expanded HMM. Also, the model storage unit 22 stores a later-described inhibitor.

The state recognizing unit 23 recognizes the current situation of the agent based on the expanded HMM stored in the model storage unit 22 using the action series and the observation value series stored in the history storage unit 14, and obtains (recognizes) the current state that is the state of the expanded HMM corresponding to the current situation thereof.

Subsequently, the state recognizing unit 23 supplies the current state to the action determining unit 24.

Also, the state recognizing unit 23 performs updating of the inhibitor stored in the model storage unit 22, and updating of an elapsed time management table stored in a later-described elapsed time management table storage unit 32, according to the current state and the like.

The action determining unit 24 serves as a planer for planning an action to be performed by the agent in the recognition action mode.

That is to say, in addition to the current state being supplied to the action determining unit 24 from the state recognizing unit 23, one state of the states the expanded HMM stored in the model storage unit 22 is supplied from the target determining unit 16 to the action determining unit 24 as a target state.

The action determining unit 24 calculates (determines) an action plan that is action series that increase the likelihood of state transition from the current state from the state recognizing unit 23 to the target state from the target determining unit 16 to the highest based on the expanded HMM stored in the model storage unit 22.

Further, the action determining unit 24 determines an action to be performed next by the agent in accordance with the action plan, and controls the actuator 12 in accordance with the determined action thereof.

The target determining unit 16 determines a target state and supplies this to the action determining unit 24 in the recognition action mode.

That is to say, the target determining unit 16 is configured of a target selecting unit 31, an elapsed time management table storage unit 32, an external target input unit 33, and an internal target generating unit 34.

An external target serving as a target state from the external target input unit 33, and an internal target serving as a target state from the internal target generating unit 34 are supplied to the target selecting unit 31.

The target selecting unit 31 selects the state serving as the external target from the external target input unit 33, or the state serving as the internal target from the internal target generating unit 34, determines the selected state thereof to be the target state, and supplies this to the action determining unit 24.

The elapsed time management table storage unit 32 stores an elapsed time management table. With regard to each state of the expanded HMM stored in the model storage unit 22, elapsed time elapsed since the state thereof became the current state, and the like are registered on the elapsed time management table.

The external target input unit 33 supplies a state given from the outside (of the agent) to the target selecting unit 31 as the external target serving as a target state. Specifically, for example, when the user externally specifying a state serving as the target state, the external target input unit 33 is operated by the user. The external target input unit 33 supplies the state specified by the user to the target selecting unit 31 as the external target serving as the target state.

The internal target generating unit 34 generates an internal target serving as the target state in the inside (of the agent), and supplies this to the target selecting unit 31. The internal target generating unit 34 is configured of a random target generating unit 35, a branching structure detecting unit 36, and an open-edge detecting unit 37.

The random target generating unit 35 selects one state out of the states of the expanded HMM stored in the model storage unit 22 at random as a random target, and supplies the random target thereof to the target selecting unit 31 as the internal target serving as the target state.

The branching structure detecting unit 36 detects a branching structured state that is a state in which state transition to a different state can be performed in the case that the same action is performed, based on the state transition probability of the expanded HMM stored in the model storage unit 22, and supplies the branching structured state thereof to the target selecting unit 31 as the internal target serving as the target state.

Note that, with the branching structure detecting unit 36, in the case that multiple states are detected as branching structured states from the expanded HMM, the target selecting unit 31 selects a branching structured state of which the elapsed time is the maximum out of the multiple branching structured states with reference to the elapsed time management table of the elapsed time management table storage unit 32 as the target state.

The open-edge detecting unit 37 detects an unperformed state transition that is another state in which the same observation value as a predetermined observation value is observed of state transitions that can be performed with a state in which a predetermined observation value is observed as the transition source, as an open edge, with the expanded HMM stored in the model storage unit 22. Subsequently, the open-edge detecting unit 37 supplies the open edge to the target selecting unit 31 as the internal target serving as the target state.

### Processing in Reflective Action Mode

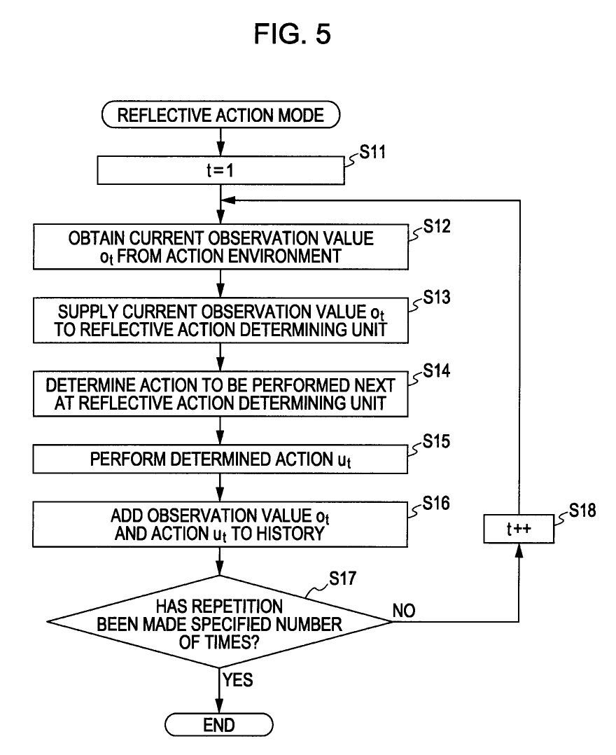

FIG. 5 is a flowchart for describing processing in the reflective action mode performed by the agent in FIG. 4.

In step S11, the reflective action determining unit 11 sets a variable t for counting a point in time to, for example, 1 serving as an initial value, and the processing proceeds to step S12.

In step S12, the sensor 13 obtains the current observation value (observation value at point-in-time t) oₜ from the action environment, outputs this, and the processing proceeds to step S13.

Here, with the present embodiment, the observation value oₜ at the point-in-time t is any one of the 15 observation values o₁ through O₁₅ shown in FIG. 3B.

In step S13, the agent supplies the observation value oₜ output from the sensor 13 to the reflective action determining unit 11, and the processing proceeds to step S14.

In step S14, the reflective action determining unit 11 determines an action uₜ to be performed at the point-in-time t as to the observation value oₜ from the sensor 13 in accordance with the innate rule, controls the actuator 12 in accordance with the action uₜ thereof, and the processing proceeds to step S15.

With the present embodiment, the action uₜ at the point-in-time t is any one of the five actions U₁ through U₅ shown in FIG. 3A.

Also, hereafter, the action uₜ determined in step S14 will also be referred to as determined action uₜ.

In step S15, the actuator 12 is driven in accordance with the control of the reflective action determining unit 11, and thus, the agent performs the determined action uₜ.

At this time, the sensor 13 is observing the actuator 12, and outputs (a symbol representing) the action uₜ performed by the agent.

Subsequently, the processing proceeds from step S15 to step S16, the history storage unit 14 stores the observation value oₜ and the action uₜ output from the sensor 13 in a manner for adding these to the already stored observation value and action series as the history of the observation values and actions, and the processing proceeds to step S17.

In step S17, the reflective action determining unit 11 determines whether or not the agent has performed an action by already specified (set) number of times serving as the number of times of actions performed in the reflective action mode.

In the case that determination is made in step S17 that the agent has not performed an action by already specified number of times, the processing proceeds to step S18, where the reflective action determining unit 11 increments the point-in-time t by one. Subsequently, the processing returns from step S18 to step S12, and hereafter, the same processing is repeated.

Also, in the case that determination is made in step S17 that the agent has performed an action by already specified number of times, i.e., in the case that the point-in-time t is equal to the already specified number of times, the processing in the reflective action mode ends.

According to the processing in the reflective action mode, the series of the observation value oₜ (observation value series), and the series of the action uₜ (action series) performed by the agent when the observation value oₜ is observed (the series of the action uₜ, and the series of the observation value oₜ₊₁ observed by the agent at the time of the action uₜ being performed) are stored in the history storage unit 14.

Subsequently, the learning unit 21 performs learning of the expanded HMM using the observation value series and the action series stored in the history storage unit 14 as learned data.

With the expanded HMM, the state transition probability of a common (existing) HMM is expanded to state transition probability for action performed by the agent.

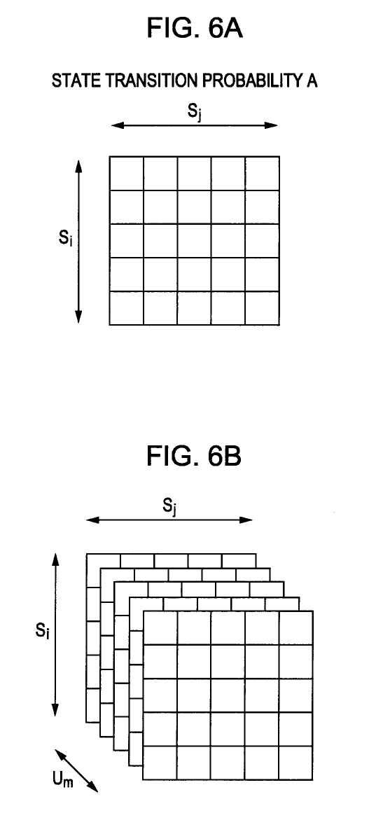

FIGS. 6A and 6B are diagrams for describing the state transition probability of the expanded HMM. Specifically, FIG. 6A illustrates the state transition probability of a common HMM.

Now, let us say that an ergodic HMM is employed as an HMM including an expanded HMM whereby state transition can be performed from a certain state to an arbitrary state. Also, let us say that the number of HMM states is N.

In this case, a common HMM includes state transition probability aᵢⱼ of N×N state transitions from each of N states Sᵢ to each of the N states Sⱼ as model parameters.

All the state transition probability of a common HMM can be represented by a two-dimensional table where the state transition probability aᵢⱼ of the state transition from the state Sᵢ to the state Sⱼ is disposed at the i'th from the top and the j'th from the left. Now, the state transition probability table of the HMM will also be referred to as state transition probability A.

FIG. 6B illustrates the state transition probability A of the expanded HMM. With the expanded HMM, state transition probability exists for each action Uₘ performed by the agent. Now, the state transition probability of the transition state from the state Sᵢ to the state Sⱼ regarding a certain action Uₘ will also be referred to as aᵢⱼ(Uₘ).

The state transition probability aᵢⱼ(Uₘ) represents probability that the state transition from the state Sᵢ to the state Sⱼ will occur at the time of the agent performing the action Uₘ.

All the state transition probability of the expanded HMM can be represented by a three-dimensional table where the state transition probability aᵢⱼ(Uₘ) of the state transition from the state Sᵢ to the state Sⱼ regarding the action Uₘ is disposed at the i'th from the top, the j'th from the left, and the m'th in the depth direction from the near side.

Now, let us say that, with the three-dimensional table of the state transition probability A, the axis in the vertical direction will be referred to as axis i, the axis in the horizontal direction will be referred to as axis j, and the axis in the depth direction will be referred to as axis m or action axis, respectively.

Also, a plane made up of the state transition probability aₗⱼ(Uₘ) obtained by cutting off the three-dimensional table of the state transition probability A at a certain position m of the action axis with a plane perpendicular to the action axis will also be referred to as a state transition probability plane regarding the action Uₘ.

Further, a plane made up of the state transition probability aᵢⱼ(Uₘ) obtained by cutting off the three-dimensional table of the state transition probability A at a certain position I of the i axis with a plane perpendicular to the i axis will also be referred to as an action plane regarding the state Sᵢ.

The state transition probability aᵢⱼ(Uₘ) making up the action plane regarding the state Sᵢ represents probability that each action Um will be performed when state transition occurs with the state Sᵢ as the transition source.

Note that the expanded HMM includes, as the model parameters, in the same way as a common HMM, initial state probability πᵢ that the state of the expanded HMM will be in the state Sᵢ at the first point-in-time t=1, and observation probability bᵢ(Oₖ) that the observation value Oₖ will be observed in the state Sᵢ as well as the state transition probability aᵢⱼ(Uₘ) for each action.

### Learning of Expanded HMM

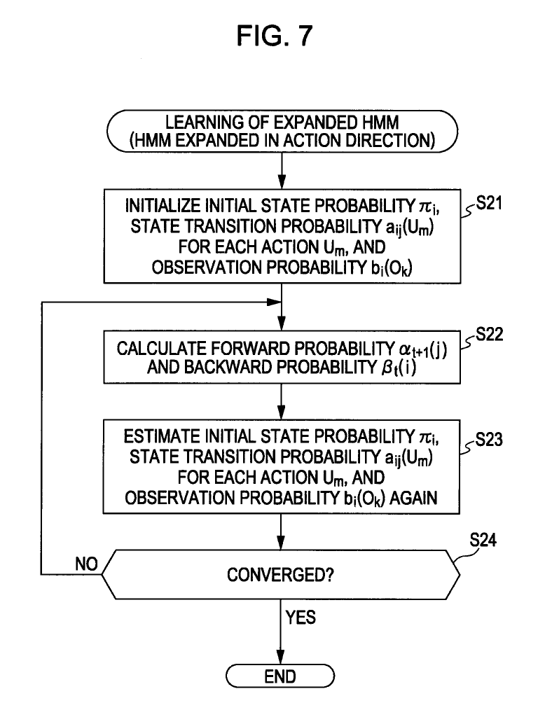

FIG. 7 is a flowchart for describing processing for learning the expanded HMM that the learning unit 21 in FIG. 4 performs using the observation value series and the action series serving as the learned data stored in the history storage unit 14.

In step S21, the learning unit 21 initializes the expanded HMM. Specifically, the learning unit 21 initializes the initial state probability πᵢ, state transition probability aᵢⱼ(Uₘ) (for each action), and observation probability bᵢ(Oₖ) that are the model parameters of the expanded HMM stored in the model storage unit 22.

Note that if we say that the number (total number) of the states of the expanded HMM is N, the initial state probability πᵢ is initialized to 1/N. Now, if we say that the action environment that is a two-dimensional plane maze of which the crosswise×the lengthwise is made up of a×b observation units, with an integer to be merged as Δ, (a+Δ)×(b×Δ) can be employed as the number N of the states of the expanded HMM.

Also, the state transition probability aᵢⱼ(Uₘ) and the observation probability bᵢ(Oₖ) are initialized to, for example, a random value that can be taken as a probability value.

Here, initialization of the state transition probability aᵢⱼ(Uₘ) is performed so as to obtain, with regard to each row of the state transition probability plane regarding each action Uₘ, 1.0 as the sum (a_{i,1}(Uₘ)+a_{i,2}(Uₘ) + . . . +a_{i,N}(Uₘ)) of the state transition probability aᵢⱼ(Uₘ) of the row thereof.

Similarly, initialization of the observation probability bᵢ(Oₖ) is performed so as to obtain, with regard to each state Sᵢ, 1.0 as the sum (bᵢ(O₁)+bᵢ(O₂)+ . . . +bᵢ(O_{K}) of the observation probability that observation values O₁, O₂, . . . , O_{K} will be observed from the state Sᵢ thereof.

Note that, in the case that so-called additional learning is performed, the initial state probability πᵢ, state transition probability aᵢⱼ(Uₘ), and observation probability bᵢ(Oₖ) of the expanded HMM stored in the model storage unit 22 are used as initial values without change. That is to say, the initialization in step S21 is not performed.

After step S21, the processing proceeds to step S22, and hereafter, in step S22 and thereafter, learning of the expanded HMM is performed wherein the initial state probability πᵢ, state transition probability aᵢⱼ(Uₘ) regarding each action, and observation probability bᵢ(Oₖ) are estimated using the action series and the observation value series serving as the learned data stored in the history storage unit 14 in accordance with (a method expanding) the Baum-Welch re-estimation method (regarding actions).

Specifically, in step S22 the learning unit 21 calculates forward probability αₜ₊₁(j) and backward probability βₜ(i).

Here, with the expanded HMM, upon the action Uₜ being performed at point-in-time t, state transition is performed from the current state Sᵢ to the state Sⱼ, and at the next point-in-time t+1, an observation value oₜ₊₁ is observed in the state Sⱼ after the state transition.

With such an expanded HMM, the forward probability αₜ₊ᵢ(j) is, with a model Λ that is the current expanded HMM (expanded HMM stipulated by the initial state probability πᵢ, state transition probability aᵢⱼ(Uₘ), and observation probability bᵢ(Oₖ) currently stored in the model storage unit 22), probability P (o₁, O₂, . . . , oₜ₊₁, u₁, u₂, . . . , uₜ, sₜ₊₁=j|Λ) that action series u₁, u₂, . . . , uₜ that are learned data will be observed, and also observation value series o₁, o₂, . . . , oₜ₊₁ will be observed, and the state of the expanded HMM will be in the state Sⱼ at the point-in-time t+1, and is represented by Expression (1).

$$\begin{matrix}{α}_{t + 1} ( j ) = P ( {o}_{1} , {o}_{2} , … , {o}_{t + 1} , {u}_{1} , {u}_{2} , … , {u}_{t} , {s}_{t + 1} = j \vert Λ ) \\ = {\sum }_{i = 1}^{N} {α}_{t} ( i ) {a}_{ij} ( {u}_{t} ) {b}_{j} ( {o}_{t + 1} )\end{matrix} \qquad ( 1 )$$

Note that the state sₜ represents a state that is present at the point-in-time t, and is, in the case that the number of the states of the expanded HMM is N, any one of states S₁ through S_{N}. Also, the Expression sₜ₊₁=j represents that the state sₜ₊₁ that is present at the point-in-time t+1 is the state Sⱼ.

The forward probability αₜ₊₁(j) in Expression (1) represents, in the case that the action series u₁, u₂, . . . , uₜ₋₁, and the observation value series O₁, O₂, . . . , oₜ that are the learned data are observed, and the state of the expanded HMM is in the state sₜ at the time-in-time t, probability that state transition will occur by the action uₜ (observation) being performed, the state of the expanded HMM will be in the state Sⱼ at the point-in-time t+1, and the observation value oₜ₊₁ will be observed.

Note that the initial value α₁(j) of the forward probability αₜ₊₁(j) is represented by Expression (2)

α₁(j)=πⱼbⱼ(o₁) (2)

where initial value α₁(j) represents probability that the state of the expanded HMM will be in the state Sⱼ first (point-in-time t=0), and the observation value o₁ will be observed.

Also, with the expanded HMM, the backward probability βₜ(i) is, with the model Λ that is the current expanded HMM, probability P (oₜ₊₁, Oₜ₊₂, . . . , o_{T}, uₜ₊₁, Uₜ₊₂, . . . , u_{T-1}, sₜ=i|Λ) that action series uₜ₊ᵢ, uₜ₊₂, . . . , u_{T-1} that are learned data will be observed, and also observation value series oₜ₊₁, oₜ₊₂, . . . , o_{T} will be observed at point-in-time t and in state Sᵢ, and is represented by Expression (3)

$$\begin{matrix}{β}_{t} ( i ) = P ( {o}_{t + 1} , {o}_{t + 2} , … , {o}_{T} , {u}_{t + 1} , {u}_{t + 2} , … , {u}_{T - 1} , {s}_{t} = j \vert Λ ) \\ = {\sum }_{j = 1}^{N} {α}_{ij} ( {u}_{t} ) {b}_{j} ( {o}_{t + 1} ) {β}_{t + 1} ( j )\end{matrix} \qquad ( 3 )$$

where T represents the number of observation values of the observation value series that are the learned data.

The backward probability βₜ(i) in Expression (3) represents, in the case that the state of the expanded HMM is in the state Sⱼ at the point-in-time t+1, and subsequently, the action series uₜ₊₁, uₜ₊₂, . . . , u_{T-1} that are learned data are observed, and also observation value series oₜ₊₂, oₜ₊₃, . . . , o_{T} are observed, probability that the state of the expanded HMM is in the state Sᵢ at the point-in-time t, state transition will occur by the action uₜ (observation) being performed, the state sₜ₊₁ at the point-in-time t+1 will become the state Sⱼ, and at the time of the observation value oₜ₊₁ being observed, the state sₜ at the point-in-time t will become the state Sᵢ.

Note that the initial value β_{T}(i) of the backward probability βₜ(i) is represented by Expression (4)

β_{T}(i)=1 (4)

where the initial value β_{T}(i) represents that probability that the state of the expanded HMM will be in the state Sᵢ at the last (point-in-time t=T) is 1.0, i.e., that the state of the expanded HMM will necessarily be in the state Sᵢ at the last.

The expanded HMM, such as shown in Expressions (1) and (3), differs from a common HMM in that state transition probability aᵢⱼ(uₜ) for each action is used as the state transition probability of state transition from a certain state Sᵢ to a certain state Sⱼ.

After the forward probability αₜ₊₁(i) and the backward probability βₜ(i) are calculated in step S22, the processing proceeds to step S23, where the learning unit 21 reestimates the initial state probability πᵢ, state transition probability aᵢⱼ(Uₘ) for each action Uₘ, and observation probability bᵢ(Oₖ) that are the model parameters Λ of the expanded HMM using the forward probability αₜ₊₁(j) and the backward probability βₜ(i).

Now, re-estimation of the model parameters will be performed as follows by expanding the Baum-Welch re-estimation method along with the state transition probability being expanded to the state transition probability aᵢⱼ(Uₘ) for each action Uₘ.

Specifically, with the model Λ that is the current expanded HMM, in the case that the action series u₁, u₂, . . . , u_{T-1} and the observation value series O=o₁, o₂, . . . , o_{T} are observed, probability ξtₜ₊₁(ij, Uₘ) that the state of the expanded HMM is in the state Sᵢ at the point-in-time t, state transition to the state Sⱼ at the point-in-time t+1 will occur by the action uₘ being performed, are represented by Expression (5) using the forward probability αₜ(i) and the backward probability βₜ₊₁(j).

$$\begin{matrix}{ξ}_{t + 1} ( i , j , {U}_{m} ) = P ( {s}_{t} = i , {s}_{t + 1} = j , {u}_{t} = {U}_{m} \vert O , U , Λ ) \\ = \frac{{α}_{t} ( i ) {a}_{ij} ( {U}_{m} ) {b}_{j} ( {o}_{t + 1} ) {β}_{t + 1} ( j )}{P ( O , U \vert Λ )}\end{matrix} \\ ( 1 \leq t \leq T - 1 ) \qquad ( 5 )$$

Further, probability γₜ(i, Uₘ) that the action uₜ=Uₘ will be performed in the state Sᵢ at the point-in-time t can be calculated as probability that marginalizes the probability ξₜ₊₁(ij, Uₘ) regarding the expanded HMM being in the state Sⱼ at the point-in-time t+1, and is represented by Expression (6).

$$\begin{matrix}{γ}_{t} ( i , {U}_{m} ) = P ( {s}_{t} = i , {u}_{t} = {U}_{m} \vert O , U , Λ ) \\ = {\sum }_{j = 1}^{N} {ξ}_{t + 1} ( i , j , {U}_{m} )\end{matrix} \\ ( 1 \leq t \leq T - 1 ) \qquad ( 6 )$$

The learning unit 21 performs re-estimation of the model parameters Λ of the expanded HMM using the probability ξₜ₊₁ (i,j, Uₘ) in Expression (5), and the probability γₜ(i, Uₘ) in Expression (6).

Now, if we say that the estimate value obtained by performing re-estimation of the model parameters Λ is represented with model parameters Λ' using an apostrophe ('), the estimate value π′ᵢ of the initial state probability that is included in the model parameters Λ' is obtained in accordance with Expression (7).

$${π}_{i}^{′} = \frac{{α}_{i} ( i ) {β}_{1} ( i )}{P ( O , U \vert Λ )} \\ ( 1 \leq i \leq N ) \qquad ( 7 )$$

Also, the estimate value a′ᵢⱼ(Uₘ) of the state transition probability for each action that is included in the model parameters Λ' is obtained in accordance with Expression (8).

$$\begin{matrix}{a}_{ij}^{′} ( {U}_{m} ) = \frac{{\sum }_{t = 1}^{T - 1} {ξ}_{t + 1} ( i , j , {U}_{m} )}{{\sum }_{t = 1}^{T - 1} {γ}_{t} ( i , {U}_{m} )} \\ = \frac{{\sum }_{t = 1}^{T - 1} {α}_{t} ( i ) {a}_{ij} ( {U}_{m} ) {b}_{j} ( {o}_{t + 1} ) {β}_{t + 1} ( j )}{{\sum }_{t = 1}^{T - 1} {\sum }_{j = 1}^{N} {α}_{t} ( i ) {a}_{ij} ( {U}_{m} ) {b}_{j} ( {o}_{t + 1} ) {β}_{t + 1} ( j )}\end{matrix} \qquad ( 8 )$$

Here, the numerator of the estimate value a′ᵢⱼ(Uₘ) of the state transition probability in Expression (8) represents the anticipated value of the number of state transition times that the expanded HMM is in the state Sᵢ, and transitions to the state Sⱼ by the action uₜ=Uₘ being performed, and the denominator thereof represents the anticipated value of the number of state transition times that the expanded HMM is in the state Sᵢ, and is transitioned by the action uₜ=Uₘ being performed.

The estimate value b′ᵢ(Oₖ) of the observation probability that is included in the model parameters Λ' is obtained in accordance with Expression (9).

$$\begin{matrix}{b}_{j}^{′} ( {O}_{k} ) = \frac{{\sum }_{t = 1}^{T - 1} {\sum }_{i = 1}^{N} {\sum }_{m = 1}^{M} {ξ}_{t + 1} ( i , j , {U}_{m} , {O}_{k} )}{{\sum }_{t = 1}^{T - 1} {\sum }_{i = 1}^{N} {\sum }_{m = 1}^{M} {ξ}_{t + 1} ( i , j , {U}_{m} )} \\ = \frac{{\sum }_{t = 1}^{T - 1} {α}_{t + 1} ( j ) {b}_{j} ( {O}_{k} ) {β}_{t + 1} ( j )}{{\sum }_{t = 1}^{T - 1} {α}_{t + 1} ( j ) {β}_{t + 1} ( j )}\end{matrix} \qquad ( 9 )$$

Here, the numerator of the estimate value b′ⱼ(Oₖ) of the observation probability in Expression (9) represents the anticipated value of the number of times that state transition to the state Sⱼ is performed, and in the state Sⱼ thereof the observation value Oₖ is observed, and the denominator thereof represents the anticipated value of the number of times that state transition to the state Sⱼ is performed.

After the estimate values π′ᵢ, a′ᵢⱼ(Uₘ), and b′ⱼ(Oₖ) of the initial state probability, state transition probability, and observation probability that are the model parameters Λ' are reestimated in step S23, the learning unit 21 stores the estimate values π′ᵢ, a′ᵢⱼ(Uₘ), and b′ⱼ(Oₖ) in the model storage unit 22 as new initial state probability πᵢ, new state transition probability aᵢⱼ(Uₘ), and new observation probability bⱼ(Oₖ) in an overwrite manner, respectively, and the processing proceeds to step S24.

In step S24, determination is made whether or not the model parameters of the expanded HMM, i.e., the (new) initial state probability π₁, state transition probability aᵢⱼ(Uₘ), and observation probability bⱼ(Oₖ) stored in the model storage unit 22 have converged.

In the case that determination is made in step S24 that the model parameters of the expanded HMM have not converged yet, the processing returns to step S22, where the same processing is repeated using the new initial state probability πᵢ, state transition probability aᵢⱼ(Uₘ), and observation probability bⱼ(Oₖ) stored in the model storage unit 22.

Also, in the case that determination is made in step S24 that the model parameters of the expanded HMM have converged, i.e., for example, in the case that the model parameters of the expanded HMM have little change before and after the re-estimation in step S23, the learning processing of the expanded HMM ends.

As described above, learning of the expanded HMM stipulated by the state transition probability aᵢⱼ(Uₘ) for each action is performed using the action series of actions performed by the agent, and the observation value series of the observation values observed by the agent when performing actions, and accordingly, with the expanded HMM, the configuration of the action environment is obtained through the observation value series, and also relationship between each observation value and the action at the time of the observation value thereof being observed (relationship between an action performed by the agent, and the observation value observed at the time of the action thereof being performed (the observation value observed after the action)) is obtained.

As a result thereof, in the recognition action mode, such as described later, a suitable action can be determined as an action to be performed by the agent within the action environment by using such an expanded HMM after learning.

### Processing in Recognition Action Mode

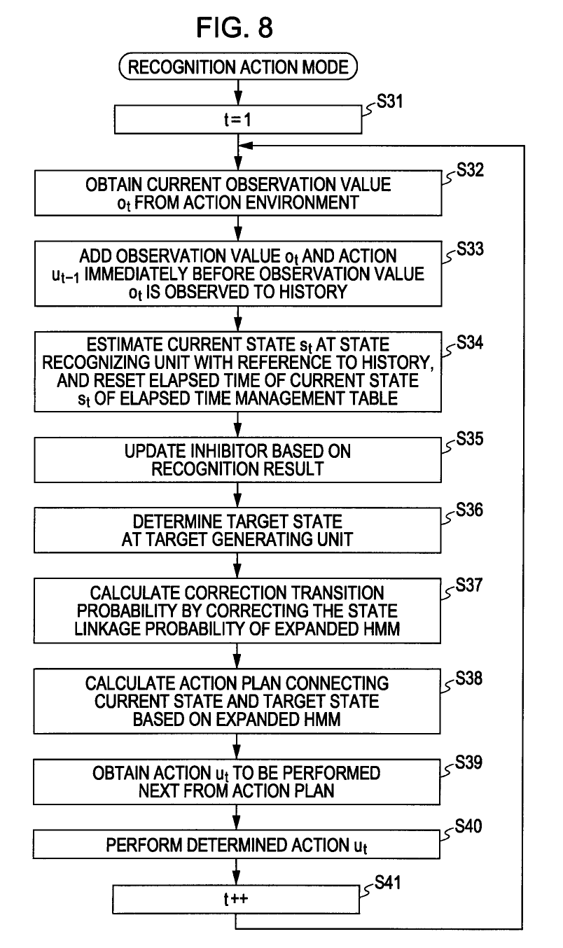

FIG. 8 is a flowchart for describing processing in the recognition action mode performed by the agent in FIG. 4.

In the recognition action mode, the agent performs, as described above, determination of a target, and recognition of the current situation, and calculates an action plan for achieving the target from the current situation. Further, the agent determines an action to be performed next in accordance with the action plan thereof, and performs the action thereof. Subsequently, the agent repeats the above processing.

Specifically, in step S31 the state recognizing unit 23 sets a variable t for counting a point in time to, for example, 1 serving as an initial value, and the processing proceeds to step S32.

In step S32, the sensor 13 obtains the current observation value (observation value at point-in-time t) oₜ from the action environment, outputs this, and the processing proceeds to step S33.

In step S33, the history storage unit 14 stores the observation value oₜ at the point-in-time t obtained by the sensor 13, and the action uₜ₋₁ output from the sensor 13 (the action uₜ₋₁ performed by the agent at the last point-in-time t−1) when the observation value oₜ is observed (immediately before the observation value oₜ is obtained at the sensor 13) as the histories of the observation value and the action in a manner for adding these to the already stored observation value and action series, and the processing proceeds to step S34.

In step S34, the state recognizing unit 23 recognizes the current situation of the agent using the action performed by the agent, and the observation value observed at the agent at the time of the action thereof being performed based on the expanded HMM, and obtains the current state that is the state of the expanded HMM corresponding to the current situation thereof.

Specifically, the state recognizing unit 23 reads out the action series of the latest zero or more actions, and the observation value series of the latest one or more observation values from the history storage unit 14 as the action series and observation value series for recognition used for recognizing the current situation of the agent.

Further, the state recognizing unit 23 observes the action series and observation value series for recognition with the learned expanded HMM stored in the model storage unit 22, and obtains optimal state probability δₜ(j) that is the maximum value of state probability that the expanded HMM will be in the state Sⱼ at the point-in-time (current point-in-time) t, and an optimal route (path) ψₜ(j) that is state series whereby the optimal state probability δₜ(j) is obtained in accordance with (an algorithm for actions expanded from) the Viterbi algorithm.

Now, according to the Viterbi algorithm, with a common HMM, of the series of states (state series) traced at the time of a certain observation value series are observed, state series that make likelihood wherein the observation value series thereof is observed the maximum (most likely state series) can be estimated.

However, with the expanded HMM, the state transition probability is expanded regarding actions, and accordingly, in order to apply the Viterbi algorithm to the expanded HMM, the Viterbi algorithm has to be expanded regarding actions.

Therefore, with the state recognizing unit 23, the optimal state probability δₜ(j) and the optimal route ψₜ(j) are obtained in accordance with Expressions (10) and (11), respectively.

$$\begin{matrix}{δ}_{t} ( j ) = {max}_{1 \leq i \leq N} [ {δ}_{t - 1} ( i ) {a}_{ij} ( {u}_{t - 1} ) {b}_{ij} ( {o}_{t} ) ] \\ ( 1 \leq t \leq T , 1 \leq j \leq N ) & ( 10 ) \\ {ψ}_{t} ( j ) = {argmax}_{1 \leq i \leq N} [ {δ}_{t - 1} ( i ) {a}_{ij} ( {u}_{t - 1} ) {b}_{ij} ( {o}_{t} ) ] \\ ( 1 \leq t \leq T , 1 \leq j \leq N ) & ( 11 )\end{matrix}$$

Here, max[X] in Expression (10) represents the maximum value of X obtained by changing a suffix i representing the state Sᵢ to an integer in a range from 1 to the number of states N. Also, argmax[X] in Expression (11) represents the suffix i that makes X obtained by changing the suffix i to an integer in a range from 1 to N the maximum.

The state recognizing unit 23 observes the action series and observation value series for recognition, and obtains the most likely state series that are state series reaching at point-in-time t the state Sⱼ that makes the optimal state probability δₜ(j) in Expression (10) the maximum from the optimal route ψₜ(j) in Expression (11).

Further, the state recognizing unit 23 takes the most likely state series as the recognition result of the current situation, and obtains (estimates) the last state of the most likely series as the current state sₜ.

Upon obtaining the current state sₜ, the state recognizing unit 23 updates the elapsed time management table stored in the elapsed time management table storage unit 32 based on the current state sₜ thereof, and the processing proceeds from step S34 to step S35.

Specifically, in a manner correlated with each state of the expanded HMM, elapsed time since the state thereof become the current state has been registered on the elapsed time management table of the elapsed time management table storage unit 32. The state recognizing unit 23 resets, with the elapsed time management table, the elapsed time in a state in which the expanded HMM reaches the current state sₜ to, for example, 0, and also increments the elapsed time of other states, for example, by one.

Here, the elapsed time management table is, as described above, referenced as appropriate when the target selecting unit 31 selects a target state.

In step S35, the state recognizing unit 23 updates the inhibitor stored in the model storage unit 22 based on the current state sₜ. Description will be made later regarding updating of the inhibitor.

Further, in step S35 the state recognizing unit 23 supplies the current state sₜ to the action determining unit 24, and the processing proceeds to step S36.

In step S36, the target determining unit 16 determines a target state out of the states of the expanded HMM, supplies this to the action determining unit 24, and the processing proceeds to step S37.

In step S37, the action determining unit 24 uses the inhibitor stored in the model storage unit 22 (the inhibitor updated in the immediately-preceding step S35) to correct the state transition probability of the expanded HMM similarly stored in the model storage unit 22, and calculates corrected transition probability that is the state transition probability after correction.

With later-described calculation of an action plan at the action determining unit 24, the corrected transition probability is used as the state transition probability of the expanded HMM.

Subsequently to step S37, the processing proceeds to step S38, where the action determining unit 24 calculates an action plan that is the series of actions that make the likelihood of the state transition up to the target state from the target determining unit 16 from the current state from the state recognizing unit 23 the highest based on the expanded HMM stored in the model storage unit 22, for example, in accordance with (an algorithm for actions expanded from) the Viterbi algorithm.

Now, according to the Viterbi algorithm, with a common HMM, of two states, state series reaching the other from one of the states, i.e., for example, of state series reaching the target state from the current state, the most likely state series that make the likelihood wherein certain observation value series are observed the highest can be estimated.

However, as described above, with the expanded HMM, the state transition probability is expanded regarding actions, and accordingly, in order to apply the Viterbi algorithm to the expanded HMM, the Viterbi algorithm has to be expanded regarding actions.

Therefore, with the action determining unit 24, state probability δ′ₜ(j) is obtained following Expression (12)

$${δ}_{t}^{′} ( j ) = {max}_{1 \leq i \leq N , 1 \leq m \leq M} [ {δ}_{t - 1}^{′} ( i ) {a}_{ij} ( {U}_{m} ) ] \qquad ( 12 )$$

where max[X] represents the maximum value of X obtained by changing a suffix i representing the state Sᵢ to an integer in a range from 1 to the number of states N, and also changing a suffix m representing the action Uₘ to an integer in a range from 1 to the number of actions M.

Expression (12) is an expression obtained by deleting the observation probability bⱼ(Oₜ) from Expression (10) for obtaining the most likely state probability δₜ(j). Also, in Expression (12), the state probability δ′ₜ(j) is obtained while taking the action Uₘ into consideration, and this point is equivalent to expansion regarding actions of the Viterbi algorithm.

The action determining unit 24 executes calculation of Expression (12) in the forward direction, and temporarily stores the suffix i taking the maximum state probability δ′ₜ(j), the suffix m representing the action Uₘ performed when state transition reaching the state Sᵢ that the suffix represents occurs, for each point-in-time.

Note that, when calculating Expression (12), corrected transition probability obtained by correcting the state transition probability aᵢⱼ(Uₘ) of the learned expanded HMM using the inhibitor is used as the state transition probability aᵢⱼ(Uₘ).

The action determining unit 24 sequentially calculates the state probability δ′ₜ(j) in Expression (12) with the current state sₜ as the first state, and ends calculation of the state probability S′ₜ(j) in Expression (12) when the state probability δ′ₜ(S_{goal}) of f the target state S_{goal} reaches a predetermined threshold δ′ₜₕ or more such as shown in Expression (13).

δ′ₜ(S_{goal})≧δ′ₜₕ (13)

Note that the threshold S′ₜₕ in Expression (13) is set, for example, in accordance with Expression (14)

δ′ₜₕ=0.9^{T′tm (}14)

where T′ represents the number of calculation times in Expression (12) (the series length of the most likely state series obtained from Expression (12)).

According to Expression (14), 0.9 is employed as state probability in the case that likelihood state transition has occurred once, and the threshold δ′ₜₕ is set.

Therefore, according to Expression (13), in the case that likelihood state transition has continued by T′ times, calculation of the state probability δ′ₜ(j) in Expression (12) ends.

When ending calculation of the state probability δ′ₜ(j) in Expression (12), the action determining unit 24 obtains the most likely state series (the shortest route in many cases) wherein the expanded HMM reaches from the current state sₜ to the target state S_{goal} by conversely tracing the suffixes i and m stored regarding the state Sᵢ and action Uₘ from the state of the expanded HMM at the ending time, i.e., from the target state S_{goal} to the current state sₜ, and the series of the action Uₘ performed when state transition whereby the most likely state series thereof is obtained occurs.

Specifically, as described above, when executing calculation of the state probability δ′ₜ(j) in Expression (12) in the forward direction, the action determining unit 24 stores the suffix i taking the maximum state probability δ′ₜ(j), the suffix m representing the action Uₘ performed when state transition reaching the state Sᵢ that the suffix represents occurs, for each point-in-time.

The suffix i for each point-in-time represents whether to obtain the maximum state probability when returning to which state Sᵢ from the state Sⱼ in the direction which goes back in time, and the suffix m for each point-in-time represents the action Uₘ whereby state transition occurs whereby the maximum state probability thereof is obtained.

Accordingly, upon reaching the point-in-time when calculation of the state probability δ′ₜ(j) in Expression (12) is started by going back in time the suffixes i and m for each point-in-time from the point-in-time when calculation of the state probability δ′ₜ(j) in Expression (12) ends one point-in-time at a time, series wherein each of the series of state suffixes of state series from the current state sₜ to the target state S_{goal}, and the series of action suffixes of action series performed when the state transition of the state series thereof occurs are arrayed in the order going back in time can be obtained.

The action determining unit 24 obtains state series from the current state sₜ to the target state S_{goal} (most likely state series), and action series performed when the state transition of the state series thereof occurs by arraying the series arrayed in the order going back in time, in time sequence again.

Such as shown in the above, the action series performed when the state transition of the most likely state series from the current state sₜ to the target state S_{goal} occurs, obtained at the action determining unit 24, are an action plan.

Here, the most likely state series obtained as well as the action plan at the action determining unit 24 are the state series of state transition occurs (ought to occur) in the case of the agent performing actions in accordance with the action plan. Accordingly, in the case that the agent performs actions in accordance with the action plan, when state transition of which the array is different from the array of states that are the most likely state series occurs, the expanded HMM may not reach the target state even in the event that the agent performs actions in accordance with the action plan.

Upon the action determining unit 24 obtaining an action plan such as described above in step S38, the processing proceeds to step S39, where the action determining unit 24 determines an action uₜ to be performed next by the agent in accordance with the action plan thereof, and the processing proceeds to step S40.

That is to say, the action determining unit 24 determines the first action of the action series serving as the action plan to be a determined action uₜ to be performed next by the agent.

In step S40, the action determining unit 24 controls the actuator 12 in accordance with the action (determined action) uₜ determined in the last step S39, and thus, the agent performs the action uₜ.

Subsequently, the processing proceeds from step S40 to step S41, where the state recognizing unit 23 increments the point-in-time t by one, and the processing returns to step S32, and hereafter, the same processing is repeated.

Note that the processing in the recognition action mode in FIG. 8 ends, for example, in the case that the agent is operated so as to end the processing in the recognition action mode, in the case that the power of the agent is turned off, in the case that the mode of the agent is changed from the recognition action mode to another mode (reflective action mode or the like), or the like.

As described above, based on the expanded HMM, the state recognizing unit 23 recognizes the current situation of the agent using an action performed by the agent, and an observation value observed at the agent when the action thereof is performed, and obtains the current state corresponding to the current situation thereof. The target determining unit 16 determines a target state, and the action determining unit 24 calculates, based on the expanded HMM, an action plan that is the series of actions that make the likelihood (state probability) of state transition from the current state to the target state the highest, and determines an action to be performed next by the agent in accordance with the action plan thereof, and accordingly, the agent reaches the target state, whereby a suitable action can be determined as an action to be performed by the agent.

Now, with the action determining method according to the related art, learning has been performed by separately preparing a state transition probability model for learning observation value series, and an action model that is a model of an action for realizing the state transition of the state transition probability model thereof.

Accordingly, learning of the two models of the state transition probability model and the action model has been performed, and accordingly, a great number of computation costs and storage resources have had to be used for learning.

On the other hand, the agent in FIG. 4 performs, with the expanded HMM serving as a model, learning by correlating the observation value series with the action series, and accordingly can perform learning with a small number of computation costs and storage resources.

Also, with the action determining method according to the related art, an arrangement has had to be provided wherein state series up to the target state are calculated using the state transition probability model, and calculation of an action for obtaining the state series thereof is performed using the action model. That is to say, calculation of state series up to the target state, and calculation of an action for obtaining the state series thereof have had to be performed using separate models.

Therefore, with the action determining method according to the related art, computation costs for calculating an action have been great.

On the other hand, the agent in FIG. 4 can simultaneously obtain the most likely state series from the current state to the target state, and action series for obtaining the most likely series thereof, and accordingly can determine an action to be performed next by the agent with a small number of computation costs.

### Determination of Target State

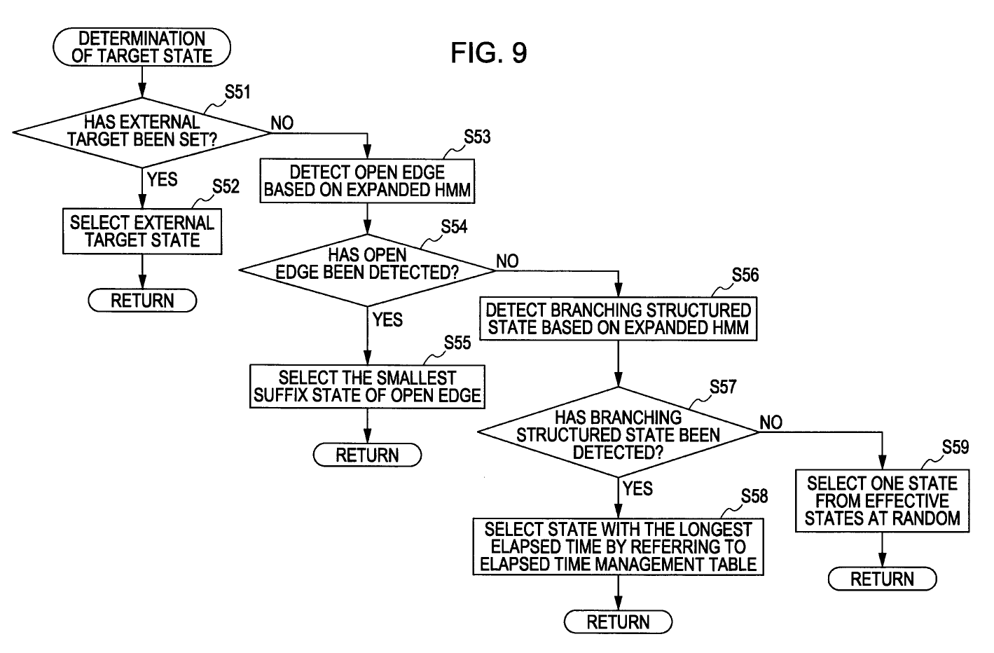

FIG. 9 is a flowchart for describing processing for determining a target state performed in step S36 in FIG. 8 by the target determining unit 16 in FIG. 4.

With the target determining unit 16, in step S51 the target selecting unit 31 determines whether or not an external target has been set.

In the case that determination is made in step S51 that an external target has been set, i.e., for example, in the case that the external target input unit 33 has been operated by the user, any one state of the expanded HMM stored in the model storage unit 22 has been specified as an external target serving as a target state, and (a suffix representing) the target state has been supplied from the external target input unit 33 to the target selecting unit 31, the processing proceeds to step S52, where the target selecting unit 31 selects the external target from the external target input unit 33, supplies this to the action selecting unit 24, and the processing returns.

Note that the user can specify (the suffix of) a state serving as the target state by operating a terminal such as an unshown PC (Personal Computer) or the like as well as by operating the external target input unit 33. In this case, the external target input unit 33 recognizes the state specified by the user by performing communication with the terminal operated by the user, and supplies this to the target selecting unit 31.

On the other hand, in the case that determination is made in step S51 that an external target has not been set, the processing proceeds to step S53, where the open-edge detecting unit 37 detects an open edge output of the states of the expanded HMM based on the expanded HMM stored in the model storage unit 22, and the processing proceeds to step S54.

In step S54, the target selecting unit 31 determines whether or not an open edge has been detected.

Here, in the case of having detected an open edge output of the states of the expanded HMM, the open-edge detecting unit 37 supplies (the suffix representing) the state that is the open edge thereof to the target selecting unit 31. The target selecting unit 31 determines whether or not an open edge has been detected by determining whether or not an open edge has been supplied from the open-edge detecting unit 37.

In the case that determination is made in step S54 that an open edge has been detected, i.e., in the case that one or more open edges have been supplied from the open-edge detecting unit 37 to the target selecting unit 31, the processing proceeds to step S55, where the target selecting unit 31 selects, for example, an open edge wherein the suffix representing a state is the minimum out of the one or more open edges from the open-edge detecting unit 37 as a target state, supplies this to the action determining unit 24, and the processing returns.

Also, in the case that determination is made in step S54 that no open edge has been detected, i.e., in the case that no open edge has been supplied from the open-edge detecting unit 37 to the target selecting unit 31, the processing proceeds to step S56, where the branching structure detecting unit 36 detects a branching structured state output of the states of the expanded HMM based on the expanded HMM stored in the model storage unit 22, and the processing proceeds to step S57.

In step S57, the target selecting unit 31 determines whether or not a branching structured state has been detected.

Here, in the case of having detected a branching structured state out of the states of the expanded HMM, the branching structure detecting unit 36 supplies (the suffix representing) the branching structured state thereof to the target selecting unit 31. The target selecting unit 31 determines whether or not a branching structured state has been detected by determining whether or not a branching structured state has been supplied from the branching structure detecting unit 36.

In the case that determination is made in step S57 that a branching structured state has been detected, i.e., in the case that one or more branching structured state has been supplied from the branching structure detecting unit 36 to the target selecting unit 31, the processing proceeds to step S58, where the target selecting unit 31 selects one state of the one or more branching structured states from the branching structure detecting unit 36 as a target state, supplies this to the action determining unit 24, and the processing returns.

Specifically, the target selecting unit 31 refers to the elapsed time management table of the elapsed time management table storage unit 32 to recognize the elapsed time of the one or more branching structured states from the branching structure detecting unit 36.

Further, the target selecting unit 31 detects a state of which the elapsed time is the longest out of the one or more branching structured states from the branching structure detecting unit 36, and selects the state thereof as a target state.

On the other hand, in the case that determination is made in step S57 that no branching structured state has been detected, i.e., in the case that no branching structured state has been supplied from the branching structure detecting unit 36 to the target selecting unit 31, the processing proceeds to step S59, where the random target generating unit 35 selects one state of the expanded HMM stored in the model storage unit 22 at random, and supplies this to the target selecting unit 31.

Further, in step S59 the target selecting unit 31 selects the state from the random target selecting unit 35 as a target state, supplies this to the action determining unit 24, and the processing returns.

Note that the details of detection of open edges by the open-edge detecting unit 37, and detection of branching structured states by the branching structure detecting unit 36 will be described later.

### Calculation of Action Plan

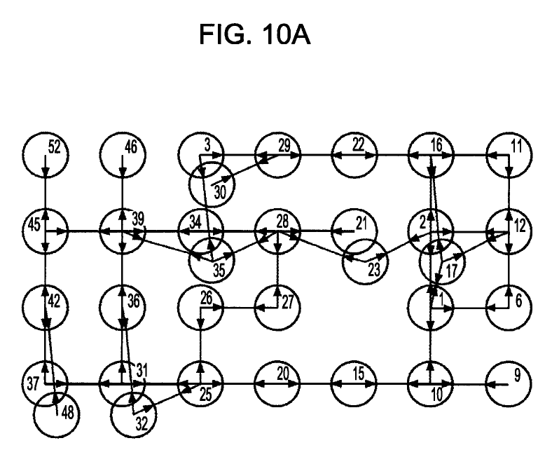

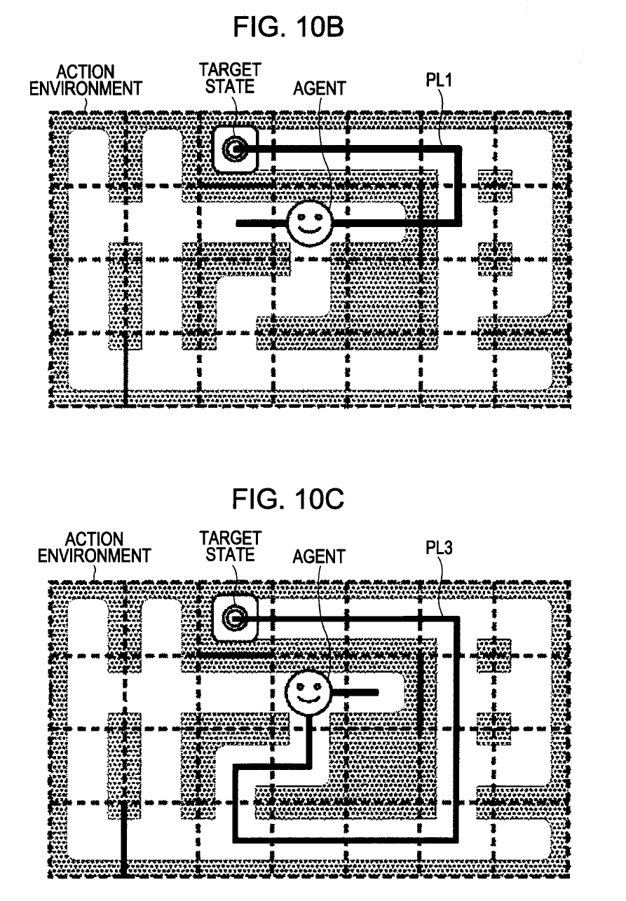

FIGS. 10A through 10C are diagrams for describing calculation of an action plan by the action determining unit 24 in FIG. 4. FIG. 10A schematically illustrates the learned expanded HMM used for calculation of an action plan. In FIG. 10A, the circles represent a state of the expanded HMM, and numerals within the circles are the suffixes of the states represented by the circles. Also, arrows indicating states represented by circles represent available state transition (state transition of which the state transition probability is deemed to be other than 0).

With the expanded HMM in FIG. 10A, the state Sᵢ is disposed in the position of the observation units corresponding to the state Sᵢ thereof.

Two states whereby state transition is available represent that the agent can move between two observation units corresponding to the two states thereof. Accordingly, arrows representing state transition of the expanded HMM represent the path where the agent can move within the action environment.

In FIG. 10A, there is a case where two (multiple) states Sᵢ and S_{i′} are disposed in the position of one of the observation units in a partially overlapped manner, which represents that the two (multiple) states Sᵢ and S_{i′} correspond to the one of the observation units.

For example, in FIG. 10A, states S₃ and S₃₀ correspond to one of the observation units, and states S₃₄ and S₃₅ also correspond to one of the observation units. Similarly, states S₂₁ and S₂₃, states S₂ and S₁₇, states S₃₇ and S₄₈, and states S₃₁ and S₃₂ also correspond to one of the observation units, respectively.

In the case that learning of the expanded HMM is performed using observation value series and action series obtained from the action environment of which the configuration is changed, as learned data, such as shown in FIG. 10A, an expanded HMM is obtained wherein multiple states correspond to one of the observation units.

Specifically, in FIG. 10A, for example, learning of the expanded HMM is performed using observation value series and action series obtained from the action environment having a configuration wherein between the observation units corresponding to the states S₂₁ and S₂₃, and the observation units corresponding to the states S₂ and S₁₇ make up one of the wall and the path, as learned data.

Further, in FIG. 10A, learning of the expanded HMM is performed using observation value series and action series obtained from the action environment having a configuration wherein between the observation units corresponding to the states S₂₁ and S₂₃, and the observation units corresponding to the states S₂ and S₁₇ make up the other of the wall and the path, as learned data.

As a result thereof, with the expanded HMM in FIG. 10A, the action environment having a configuration wherein between the observation units corresponding to the states S₂₁ and S₂₃, and the observation units corresponding to the states S₂ and S₁₇ make up the wall is obtained by the states S₂₁ and S₁₇.

That is to say, with the expanded HMM, no state transition is performed between the states S₂₁ of the observation units corresponding to the states S₂₁ and S₂₃, and the states S₁₇ of the observation units corresponding to the states S₂ and S₁₇, and accordingly, the configuration of the action environment is obtained wherein the wall prevents the agent from passing through.

Also, with the expanded HMM, the action environment having a configuration wherein between the observation units corresponding to the states S₂₁ and S₂₃, and the observation units corresponding to the states S₂ and S₁₇ make up the path is obtained by the states S₂₃ and S₂.

That is to say, with the expanded HMM, state transition is performed between the states S₂₃ of the observation units corresponding to the states S₂₁ and S₂₃, and the states S₂ of the observation units corresponding to the states S₂ and S₁₇, and accordingly, the configuration of the action environment is obtained wherein the agent is allowed to passing through.

As described above, with the expanded HMM, even in the case that the configuration of the action environment is changed, the configuration of the action environment can be obtained wherein such a configuration is changed.

FIGS. 10B and 100 illustrate an example of an action plan calculated by the action determining unit 24.

In FIGS. 10B and 100, the state S₃₀ (or S₃) in FIG. 10A is the target state, and with the state S₂₈ corresponding to the observation units where the agent exists as the current state, an action plan is calculated from the current state to the target state.

FIG. 10B illustrates an action plan PL1 calculated by the action determining unit 24 at the point-in-time t=1.

In FIG. 10B, with the series of the states S₂₈, S₂₃, S₂, S₁₆, S₂₂, S₂₉, and S₃₀ in FIG. 10A as the most likely state series reaching from the current state to the target state, the action series of actions to be performed at the time of state transition occurring whereby the most likely state series thereof are obtained are calculated as the action plan PL1.

The action determining unit 24 determines, of the action plan PL1, an action moving from the first state S₂₈ to the next state S₂₃ to be a determined action, and the agent performs the determined action.

As a result thereof, the agent moves in the right direction toward the observation units corresponding to the states S₂₁ and S₂₃ from the observation units corresponding to the state S₂₈ that is the current state (performs the action U₂ in FIG. 3A), and the point-in-time t becomes point-in-time t=2 that has elapsed by one point-in-time from point-in-time t=1.

In FIG. 10B (ditto with FIG. 100), between the observation units corresponding to the states S₂₁ and S₂₃, and the observation units corresponding to the states S₂ and S₁₇ make up the wall.

The state in which the configuration is obtained wherein between the observation units corresponding to the states S₂₁ and S₂₃, and the observation units corresponding to the states S₂ and S₁₇ make up the wall is recognized, as described above, as the states S₂₁ regarding the observation units corresponding to the states S₂₁ and S₂₃, and at the point-in-time t=2, the current state is recognized as the states S₂₁ at the state recognizing unit 23.

The state recognizing unit 23 updates the inhibitor for performing suppressing of state transition, regarding an action performed by the agent at the time of state transition from a state immediately before the current state to the current state, so as to suppress state transition between the last state and a state other than the current state but not suppress (hereafter, also referred to so as to enable) state transition between the last state and the current state.

Specifically, in this case, the current state is the state S₂₁, and the last state is the state S₂₈, and accordingly, the inhibitor is updated so as to suppress state transition between the last state S₂₈ and a state other than the current state S₂₁, i.e., for example, state transition between the first state S₂₈ and the next state S₂₃ of the action plan PL1 obtained at the point-in-time t=1, or the like. Further, the inhibitor is updated so as to enable state transition between the last state S₂₈ and the current state S₂₁.

Subsequently, at the point-in-time t=2, the action determining unit 24 sets the current state to the state S₂₁, also sets the target state to the state Sₘ, obtains the most likely state series S₂₁, S₂₈, S₂₇, S₂₆, S₂₅, S₂₀, S₁₅, S₁₀, S₁, S₁₇, S₁₆, S₂₂, S₂₉, and S₃₀ reaching from the current state to the target state, and calculates action series of actions performed when state transition occurs whereby the most likely state series thereof are obtained, as an action plan.

Further, the action determining unit 24 determines, of the action plan, an action moving from the first state S₂₁ to the next state S₂₈ to be a determined action, and the agent performs the determined action.

As a result thereof, the agent moves in the left direction toward the observation units corresponding to the state S₂₈ from the observation units corresponding to the state S₂₁ that is the current state (performs the action U₄ in FIG. 3A), and the point-in-time t becomes point-in-time t=3 that has elapsed by one point-in-time from the point-in-time t=2.

At the point-in-time t=3, the current state is recognized as the states S₂₈ at the state recognizing unit 23.

Subsequently, at the point-in-time t=3, the action determining unit 24 sets the current state to the state S₂₈, also sets the target state to the state S₃₀, obtains the most likely state series reaching from the current state to the target state, and calculates action series of actions performed when state transition occurs whereby the most likely state series thereof are obtained, as an action plan.

FIG. 10C illustrates an action plan PL3 calculated by the action determining unit 24 at the point-in-time t=3.

In FIG. 10C, the series of the states S₂₈, S₂₇, S₂₆, S₂₅, S₂₀, S₁₅, S₁₀, S₁, S₁₇, S₁₆, S₂₂, S₂₉, and S₃₀ are obtained as the most likely state series, and the action series of actions to be performed at the time of state transition occurring whereby the most likely state series thereof are obtained are calculated as the action plan PL3.

That is to say, at the point-in-time t=3, regardless of the current state being the same state S₂₈ as in the case of the point-in-time t=1, and also the target state being the same state S₃₀ as in the case of the point-in-time t=1, the action plan PL3 different from the action plan PL1 in the case of the point-in-time t=1 is calculated.

This is, as described above, because at the point-in-time t=2, the inhibitor was updated so as to suppress state transition between the states S₂₈ and S₂₃, and thus, at the point-in-time t=3, when obtaining the most likely state series, the state S₂₃ was suppressed from being selected as the transition destination of state transition from the state S₂₈ that is the current state, and the state S₂₇ that is a state whereby state transition from the state S₂₈ can be performed was selected, not the state S₂₃.

The action determining unit 24 determines, after calculation of the action plan PL3, of the action plan PL3 thereof, an action moving from the first state S₂₈ to the next state S₂₇ to be a determined action, and the agent performs the determined action.

As a result thereof, the agent moves in the lower direction toward the observation units corresponding to the state S₂₇ from the observation units corresponding to the state S₂₈ that is the current state (performs the action U₃ in FIG. 3A), and hereafter, similarly, calculation of an action plan is performed at each point-in-time.

### Correction of State Transition Probability Using Inhibitor

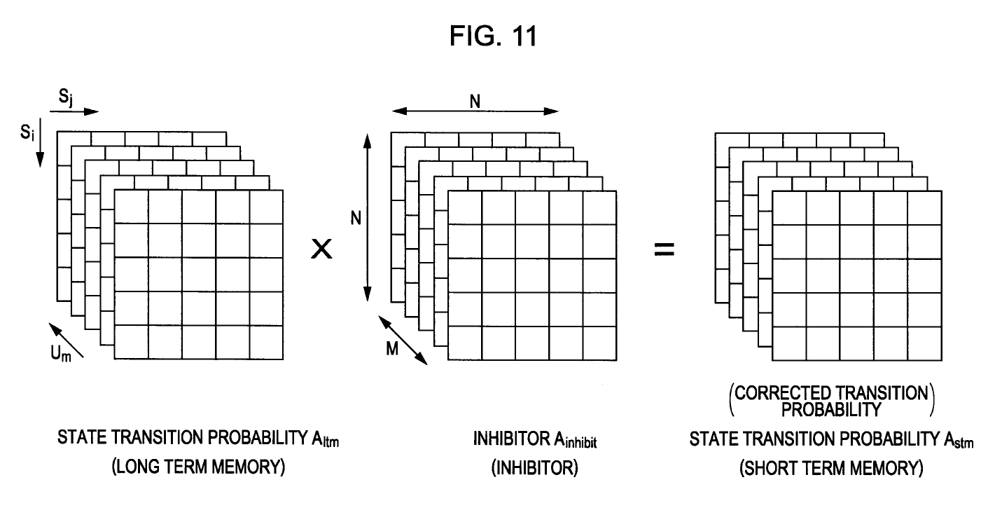

FIG. 11 is a diagram for describing correction of the state transition probability of the expanded HMM using the inhibitor performed in step S37 in FIG. 8 by the action determining unit 24.

The action determining unit 24 corrects, such as shown in FIG. 11, state transition probability Aₗₜₘ of the expanded HMM by multiplying the state transition probability Aₗₜₘ of the expanded HMM by inhibitor A_{inhibit}, and obtains corrected transition probability Aₛₜₘ that is the state transition probability Aₗₜₘ after correction.

Subsequently, the action determining unit 24 calculates an action plan using the corrected transition probability Aₛₜₘ as the state transition probability of the expanded HMM.

Here, when calculating an action plan, why the state transition probability used for calculation thereof is corrected by the inhibitor is due to the following reasons.

Specifically, the states of the expanded HMM after learning may include a branching structured state that is a state whereby state transition to a different state can be performed in the case of one action being performed.

For example, in the state S₂₉ in the above FIG. 10A, in the case of the action U₄ for moving the agent in the left direction (FIG. 3A) being performed, similar to state transition to the state S₃ on the left side, state transition to the state S₃₀ on the left side may be performed.

Accordingly, in the state S₂₉, different state transition may occur in the case of one action being performed, and the state S₂₉ is a branching structured state.

When different state transition may occur regarding a certain action, i.e., for example, in the case of a certain action being performed, when state transition to a certain state may occur, and also state transition to another state may occur, the inhibitor suppresses, of the different state transitions that may occur, so as to generate only one state transition, state transition other than the one state transition thereof from being generated.

That is to say, if we say that different state transitions to be generated regarding a certain action will be referred to as a branching structure, in the case that learning of the expanded HMM is performed using observation value series and action series obtained from the action environment of which the configuration is changed as learned data, the expanded HMM obtains change in the configuration of the action environment as a branching structure, and as a result thereof, a branching structured state occurs.

Thus, a branching structured state occurs, and accordingly, even in the case that the configuration of the action environment is changed to various configurations, the expanded HMM obtains all of the various configurations of the action environment thereof.

Here, the various configurations of the action environment of which the configuration is changed that the expanded HMM obtains are information not to be forgotten but to be stored on a long-term basis, and accordingly, (particularly, the state transition probability of) the expanded HMM obtaining such information will also be referred to as long-term memory.

In the case that the current state is a branching structured state, whether or not any one state transition of different state transitions serving as branching structured states can be performed as state transition from the current state depends on the current configuration of the action environment of which the configuration is changed.

Specifically, according to the state transition probability of the expanded HMM serving as long-term memory, even available state transition may not be performed depending on the current configuration of the action environment of which the configuration is changed.

Therefore, the agent updates the inhibitor independently from long-term memory based on the current state to be obtained recognition of the current situation of the agent. Subsequently, the agent suppresses state transition that is unavailable with the current configuration of the action environment by correcting the state transition probability of the expanded HMM serving as long-term memory using the inhibitor, and also obtains corrected transition probability that is the state transition probability after correction, which enables available state transition, and calculates an action plan using the corrected transition probability thereof.

Here, the corrected transition probability is information to be obtained at each point-in-time by correcting the state transition probability serving as long-term memory using the inhibitor to be updated based on the current state at each point-in-time, and is information to be stored on a short-term basis, and accordingly also referred to as short-term memory.

With the action determining unit 24 (FIG. 4), processing for obtaining corrected transition probability by correcting the state transition probability of the expanded HMM using the inhibitor will be performed as follows.

Specifically, in the case that all of the state transition probability Aₗₜₘ of the expanded HMM is represented by a three-dimensional table such as shown in FIG. 6B, the inhibitor A_{inhibit} is also represented by a three-dimensional table having the same size as the three-dimensional table of the state transition probability Aₗₜₘ of the expanded HMM.

Here, the three-dimensional table representing the state transition probability Aₗₜₘ of the expanded HMM will also be referred to as a state transition probability table. Also, the three-dimensional table representing the inhibitor A_{inhibit} will also be referred to as an inhibitor table.

In the case that the number of the states of the expanded HMM is N, and the number of actions that the agent can perform is M, the state transition probability table is a three-dimensional table of which the width×length×depth is N×N×M elements. Accordingly, in this case, the inhibitor table is also a three-dimensional table having N×N×M elements.

Note that, in addition to the inhibitor A_{inhibit}, the corrected transition probability Aₛₜₘ is also represented by a three-dimensional table having N×N×M elements. The three-dimensional table representing the corrected transition probability Aₛₜₘ will also be referred to as a corrected transition probability table.

For example, if we say that, of the state transition probability table, the position of the i'th from the top, the j'th from the left, and the m'th from the near side in the depth direction is represented with (i,j, m), the action determining unit 24 obtains the corrected transition probability Aₛₜₘ serving as an element of the position (i,j, m) of the corrected transition probability table by multiplying the state transition probability Aₗₜₘ (i.e., aₗⱼ (Uₘ)) serving as an element of the position (i,j, m) of the state transition probability table, and the inhibitor A_{inhibit} serving as an element of the position (i,j, m) of the inhibitor table in accordance with Expression (15).

Aₛₜₘ=A_{lym}×A_{inhibit} (15)

Note that the inhibitor is updated at the state recognizing unit 23 (FIG. 4) of the agent at each point-in-time as follows.

That is to say, the state recognizing unit 23 updates the inhibitor, regarding the action Uₘ performed by the agent at the time of state transition from the state Sᵢ immediately before the current state Sᵢ to the current state Sⱼ, so as to suppress state transition between the last state Sᵢ and a state other than the current state Sⱼ but not suppress (so as to enable) state transition between the last state Sᵢ and the current state Sⱼ.

Specifically, if we say that a plane obtained by cutting off the inhibitor table at a position m of the action axis with a plane perpendicular to the action axis will also be referred to as an inhibitor plane regarding the action Uₘ, the state recognizing unit 23 overwrites, of N×N inhibitors of the width×length of the inhibitor plane regarding the action Uₘ, 1.0 to the inhibitor serving as an element of the position (i, j) of the i'th from the top and the j'th from the left, and overwrites, of the N inhibitors positioned in one row of the i'th from the top, 0.0 to the inhibitor serving as an element of a position other than the position (i, j).

As a result thereof, according to the corrected transition probability obtained by correcting the state transition probability using the inhibitor, of state transitions (branching structure) from a branching structured state, the latest experience, i.e., only the state transition performed lately can be performed, but not other state transitions.

Here, the expanded HMM represents the configuration of the action environment that the agent has experienced up to now (obtained by learning). Further, in the case that the configuration of the action environment is changed to various configurations, the expanded HMM represents the various configurations of the action environment thereof as a branching structure.

On the other hand, the inhibitors represent which state transition of multiple state transitions that are a branching structure that the expanded HMM serving as long-term memory has models the current configuration of the action environment.

Accordingly, even in the event that the configuration of the action environment is changed by multiplying the state transition probability of the expanded HMM serving as long-term memory by the inhibitor to correct the state transition probability, and calculating an action plan using the corrected transition probability (short-term memory) that is the state transition probability after correction thereof, an action plan can be obtained wherein the changed configuration (current configuration) thereof is taken into consideration without relearning the changed configuration thereof using the expanded HMM.

Specifically, in the case that the changed configuration of the action environment is the configuration already obtained by the expanded HMM, the inhibitors are updated based on the current state, and the state transition probability of the expanded HMM is corrected using the inhibitors after updating thereof, whereby an action plan can be obtained wherein the changed configuration of the action environment is taken into consideration without performing relearning of the expanded HMM.

That is to say, an action plan adapted to change in the configuration of the action environment can be obtained effectively at high speed while suppressing computation costs.

Note that in the case that the action environment is changed to a configuration that the expanded HMM has not obtained, in order to determine a suitable action in the action environment having the changed configuration, relearning of the expanded HMM has to be performed using observation value series and action series observed in the changed action environment.

Also, in the case that an action plan is calculated using the state transition probability of the expanded HMM as is at the action determining unit 24, assuming that even when the current configuration of the action environment is a configuration wherein only one state transition of multiple state transitions serving as a branching structure can be performed, not but the other state transitions, all of the multiple state transitions serving as a branching structure can be performed in accordance with the Vitarbi algorithm, action series performed when the state transition of the most likely state series from the current state sₜ to the target state S_{goal} occurs are calculated as an action plan.

On the other hand, in the case that, with the action determining unit 24, the state transition probability of the expanded HMM is corrected by the inhibitors, and an action plan is calculated using the corrected transition probability that is the state transition probability after correction thereof, assuming that the state transitions suppressed by the inhibitors are incapable of being performed, action series performed when the state transition of the most likely state series from the current state sₜ to the target state S_{goal} occurs, which is not included in the above state transitions, are calculated as an action plan.

Specifically, for example, in the above FIG. 10A, when the action U₂ wherein the agent moves in the right direction is performed, the state S₂₈ is in a branching structured state in which state transition to either the state S₂₁ or the state S₂₃ can be performed.

Also, in FIG. 10B, as described above, at the point-in-time t=2, the state recognizing unit 23 updates the inhibitors so as to suppress state transition to the state S₂₃ other than the current state S₂₁ from the last state S₂₈, and also so as to enable state transition from the last state S₂₈ to the current state S₂₁, regarding the action U₂ wherein the agent moves in the right direction, performed by the agent at the time of state transition from the state S₂₈ immediately before the current state S₂₁ to the current state S₂₁.

As a result thereof, at the point-in-time t=3 in FIG. 10C, regardless of the current state being the state S₂₈, the target state being the state S₃₀, and accordingly, the current state and the target state being both the same as in the case of the point-in-time t=1 in FIG. 10B, state transition from the state S₂₈ to the state S₂₃ other than the state S₂₁ at the time of the action U₂ wherein the agent moves in the right direction being performed is suppressed by the inhibitors, and accordingly, state series different from the case of the point-in-time t=1, i.e., state series S₂₈, S₂₇, S₂₆, S₂₅, . . . , S₃₀ whereby state transition from the state S₂₈ to the state S₂₃ is not performed are obtained as the most likely state series reaching to the target state from the current state, and action series of actions performed when state transition whereby the state series thereof is obtained occurs are calculated as an action plan PL3.

Incidentally, updating of the inhibitors is performed so as to enable state transitions that the agent has experienced, of multiple state transitions serving as a branching structure, and so as to suppress the other state transitions other than the state transition thereof.

Specifically, with regard to the action performed by the agent at the time of state transition from a state immediately before the current state to the current state, the inhibitors are updated so as to suppress state transition between the last state and a state other than the current state (state transition from the last state to a state other than the current state), and also so as to enable state transition between the last state and the current state (state transition from the last state to the current state).

In the case that updating of the inhibitors is performed so as to enable state transitions that the agent has experienced, of multiple state transitions serving as a branching structure, and also so as to suppress the other state transitions other than the state transition thereof, state transition suppressed by the inhibitors being updated is still suppressed unless the agent experiences this state transition.

In the case that determination of an action to be performed by the agent is, as described above, performed in accordance with an action plan to be calculated using corrected transition probability obtained by correcting the state transition probability of the expanded HMM by the inhibitors at the action determining unit 24, an action plan including actions whereby the state transitions suppressed by the inhibitors occur is not calculated, and accordingly, state transition suppressed by the inhibitors is still suppressed unless the agent experiences the state transition suppressed by the inhibitors by performing determination of an action to be performed next using a method other than the method using an action plan, or by accident.

Accordingly, even if the configuration of the action environment is changed from a configuration wherein state transition suppressed by the inhibitors is incapable of being performed to a configuration wherein the state transition thereof can be performed, until the agent fortunately experiences the state transition suppressed by the inhibitors, an action plan including an action whereby the state transition thereof occurs is incapable of being calculated.

Therefore, as updating of the inhibitor the state recognizing unit 23 enables state transition experienced by the agent of multiple state transitions serving as a branching structure, and also suppresses other state transitions, and additionally relieves suppression of state transition according to passage of time.

That is to say, the state recognizing unit 23 updates the inhibitors so as to enable state transition experienced by the agent of multiple state transitions serving as a branching structure, and also so as to suppress other state transitions, and additionally updates the inhibitors so as to relieve suppression of state transition according to passage of time.

Specifically, the state recognizing unit 23 updates the inhibitors so as to converge on 1.0 according to passage of time, and for example, updates an inhibitor A_{inhibit}(t) at the point-in-time t to an inhibitor A_{inhibit}(t+1) at the point-in-time t+1, following Expression (16)

A_{inhibit}(t+1)=A_{inhibit}(t)+c(1−A_{inhibit}(t)) (0≦c≦1) (16)

where a coefficient c is a value greater than 0.0 but smaller than 1.0, and the greater the coefficient c is, the faster the inhibitor converges on 1.0.

According to Expression (16), suppression of state transition suppressed once (state transition of which the inhibitor is set to 0.0) is gradually relieved along with passage of time, and regardless of the agent having not experienced the state transition thereof, an action plan including an action whereby the state transition thereof. occurs can be calculated.

Now, updating of an inhibitor to be performed so as to relieve suppression of state transition over time, will be referred to as updating corresponding to forgetting due to natural attenuation.

### Updating of Inhibitors

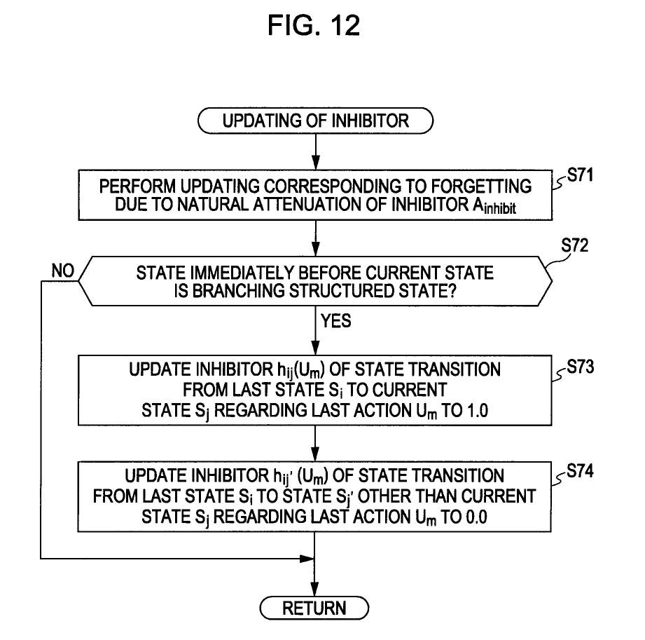

FIG. 12 is a flowchart for describing inhibitor updating processing performed in step S35 in FIG. 8 by the state recognizing unit 23 in FIG. 4.

Note that the inhibitor is initialized to 1.0 that is an initial value when the point-in-time t is initialized to 1 in step S31 in the processing in the recognition action mode in FIG. 8.

With the inhibitor updating processing, in step S71 the state recognizing unit 23 performs, regarding all of the inhibitors A_{inhibit} stored in the model storage unit 22, updating corresponding to forgetting due to natural attenuation, i.e., updating in accordance with Expression (16), and the processing proceeds to step S72.

In step S72, the state recognizing unit 23 determines whether or not the state Sᵢ immediately before the current state Sⱼ is a branching structured state, and also the current state Sⱼ is one state of different states capable of state transition by the same action being preformed from the branching structured state that is the last state Sᵢ, based on (the state transition probability of) the expanded HMM stored in the model storage unit 22.

Here, whether or not the last state Sᵢ is a branching structured state can be determined in the same way as with the case of the branching structure detecting unit 36 (FIG. 4) detecting a branching structured state.

In the case that determination is made in step S72 that the last state Sᵢ is not a branching structured state, or in the case that determination is made in step S72 that the last state Sᵢ is a branching structured state, but the current state Sⱼ is not one state of different states capable of state transition by the same action being preformed from the branching structured state that is the last state Sᵢ, the processing skips steps S73 and S74 and returns.

Also, in the case that determination is made in step S72 that the last state Sᵢ is a branching structured state, and the current state Sⱼ is one state of different states capable of state transition by the same action being preformed from the branching structured state that is the last state Sᵢ, the processing proceeds to step S73, where the state recognizing unit 23 updates, regarding the last action Uₘ of the inhibitor A_{inhibit} stored in the model storage unit 22, an inhibitor (inhibitor in a position (i,j, m) of the inhibitor table) hᵢⱼ(Uₘ) of state transition from the last state Sᵢ to the current state Sⱼ to 1.0, and the processing proceeds to step S74.

In step S74, the state recognizing unit 23 updates, regarding the last action Uₘ of the inhibitor A_{inhibit} stored in the model storage unit 22, an inhibitor (inhibitor in a position (i,j′, m) of the inhibitor table) h_{ij′}(Uₘ) of state transition from the last state Sᵢ to a state S_{j′} other than the current state Sⱼ to 0.0, and the processing returns.

Now, with the action determining method according to the related art, learning of a state transition probability model such as the HMM or the like is performed on the assumption that modeling of a static configuration is performed, and accordingly, in the case that the configuration to be subjected to learning is changed after learning of the state transition probability model, relearning of the state transition probability model has to be performed with the changed configuration as a target, and accordingly, computation costs for handling change in the configuration to be subjected to learning is great.

On the other hand, in the case that the expanded HMM obtains change in the configuration of the action environment as a branching structure, and the last state is a branching structured state, the agent in FIG. 4 updates, regarding an action performed by the agent at the time of state transition from the last state to the current state, the inhibitor so as to suppress state transition between the last state and a state other than the current state, corrects the state transition probability of the expanded HMM using the inhibitor after updating thereof, and calculates an action plan based on the corrected transition probability that is the state transition probability after correction.

Accordingly, in the case that the configuration of the action environment is changed, an action plan adapted to (following) the configured to be changed can be calculated with little computation costs (without performing relearning of the expanded HMM).

Also, the inhibitor is updated so as to relieve suppression of state transition according to passage of time, and accordingly, even if the agent has not experienced state transition suppressed in the past by chance, an action plan including an action whereby the state transition suppressed in the past occurs can be calculated along with passage of time, and as a result thereof, in the case that the configuration of the action environment is changed to a configuration different from a configuration at the time of state transition being suppressed in the past, an action plan appropriate to the changed configuration can rapidly be calculated.

### Detection of Open Edges

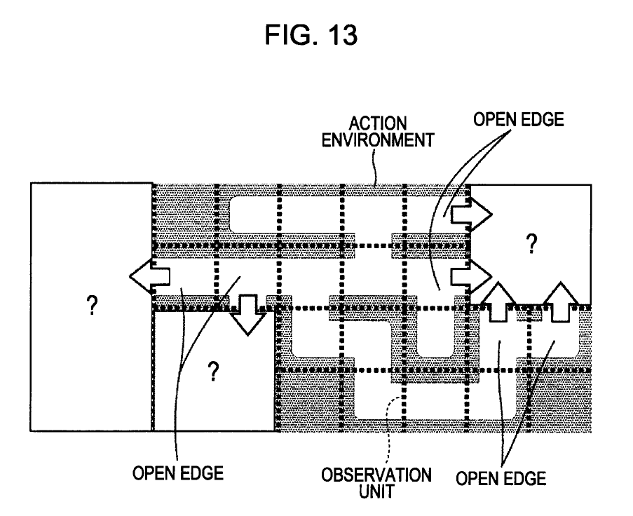

FIG. 13 is a diagram for describing a state of the expanded HMM that is an open edge that the open-edge detecting unit 37 in FIG. 4 detects.

The open edge is roughly, with the expanded HMM, when understanding beforehand that state transition that the agent has not experienced will occur with a certain state as the transition source, a state of the transition source thereof.

Specifically, in the case of comparing the state transition probability of a certain state, and the state transition probability of another state to which observation probability for observing the same observation value as with that state is assigned (a value other than (not regarded as)0.0), a state is equivalent to the open edge wherein regardless of understanding that state transition to the next state can be performed when a certain action is performed, in this state this action has not been performed, and accordingly, state transition probability has not been assigned thereto (deemed to be 0.0), and state transition is incapable of being performed.

Accordingly, with the expanded HMM, of state transitions that can be performed with a state in which a predetermined observation value is observed as the transition source, when another state is detected in which the same observation value as a predetermined observation value is observed with an unperformed state transition, the other state thereof is the open edge.

The open edge is conceptually, such as shown in FIG. 13, for example, a state corresponding to an entrance to a new room or the like which appears by adding a new room adjacent to the following room whereby the agent can move, after learning is performed with an edge portion of the configuration that the expanded HMM obtains (an edge portion in a learned range within the room) or the whole range of the room where the agent is disposed as a target by disposing the agent in a room, and performing learning with a certain range of the room thereof as a target.

When detecting the open edge, whether or not at the end of which portion of the configuration that the expanded HMM obtains the agent's unknown region is extended can be understood. Accordingly, an action plan is calculated with the open edge as the target state, and accordingly, the agent aggressively performs an action so as to get further into the unknown region. As a result thereof, the agent can effectively obtain experience used for widely learning the configuration of the action environment (obtaining observation value series and action series serving as learned data for learning of the configuration of the action environment), and reinforcing a vague portion of which the configuration has not obtained with the expanded HMM (configuration around the observation units corresponding to the state that is the open edge of the action environment).

In order to detect the open edge, the open-edge detecting unit 37 first generates an action template. When generating an action template, the open-edge detecting unit 37 subjects the observation probability B={bᵢ(Oₖ)} of the expanded HMM to threshold processing, and lists the state Sᵢ in which of each observation value Oₖ, the observation value Oₖ thereof is observed with probability of a threshold or more.

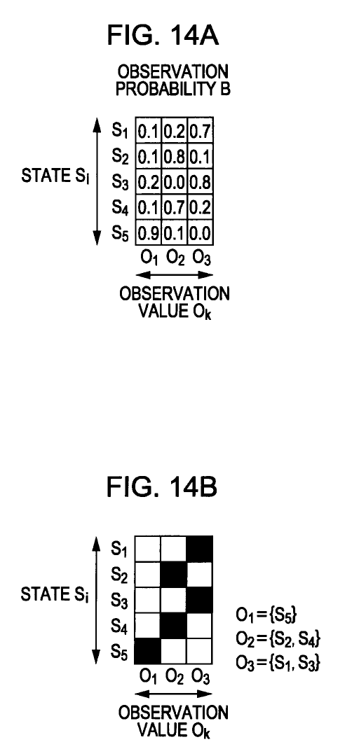

FIGS. 14A and 14B are diagrams for describing processing for the open-edge detecting unit 37 listing the state Sᵢ in which observation value Oₖ is observed with probability of a threshold or more. FIG. 14A illustrates an example of observation probability B of the expanded HMM. Specifically, FIG. 14A illustrates an example of the observation probability B of the expanded HMM of which the number N of the state Sᵢ is 5, and the number M of the observation value Oₖ is 3.

The open-edge detecting unit 37 performs threshold processing for detecting the observation probability B equal to or greater than a threshold with the threshold as 0.5 or the like, for example.

In this case, in FIG. 14A, as for a state S₁, observation probability b₁(O₃)=0.7 whereby an observation value O₃ is observed, as for a state S₂, observation probability b₂(O₂)=0.8 whereby an observation value O₂ is observed, as for a state S₃, observation probability b₃(O₃)=0.8 whereby the observation value O₃ is observed, as for a state S₄, observation probability b₄(O₂)=0.7 whereby the observation value O₂ is observed, as for a state S₅, observation probability b₅(O₁)=0.9 whereby an observation value O₁ is observed, each of which is detected by the threshold processing.

Subsequently, the open-edge detecting unit 37 detects the state Sᵢ in a listing manner whereby as to each of the observation values O₁, O₂, and O₃, the observation value Oₖ is observed with probability equal to or greater than the a threshold.

FIG. 14B illustrates the state Sᵢ to be listed as to each of the observation values O₁, O₂, and O₃. The state S₅ is listed as to the observation value O₁ as a state in which the observation value O₁ is observed with probability equal to or greater than a threshold, and the states S₂ and S₄ are listed as to the observation value O₂ as a state in which the observation value O₂ is observed with probability equal to or greater than a threshold. Also, the states S₁ and S₃ are listed as to the observation value O₃ as a state in which the observation value O₃ is observed with probability equal to or greater than a threshold.

Subsequently, the open-edge detecting unit 37 uses the state transition probability A={aᵢⱼ(Uₘ)} of the expanded HMM to calculate, regarding each of the observation value Oₖ, a transition probability response value that is a value corresponding to the state transition probability aᵢⱼ(Uₘ) that is the maximum state transition of the state transitions from the state Sᵢ listed as to the observation value Oₖ for each of the action Uₘ, and takes, regarding each of the observation value Oₖ, the transition probability response value calculated for each of the action Uₘ as action probability that the action Uₘ is performed when the observation value Oₖ is observed, to generate an action template C that is a matrix with the action probability as an element.

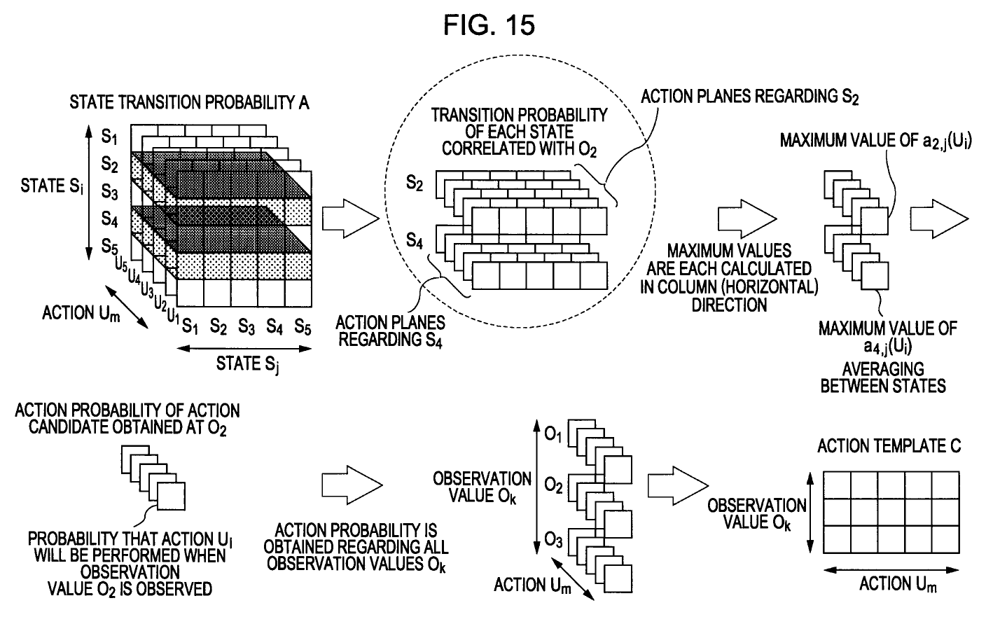

FIG. 15 is a diagram for describing a method for generating the action template C using the state Sᵢ listed as to the observation value Oₖ. The open-edge detecting unit 37 detects, with the three-dimensional state transition probability table, the maximum state transition probability from state transition probability arrayed in the column (horizontal) direction (j-axis direction) of the state transition from the state Sᵢ listed as to the observation value Oₖ.

That is to say, for example, now, let us say that the observation value O₂ is observed, and states S₂ and S₄ are listed as to the observation value O₂.

In this case, the open-edge detecting unit 37 observes an action plane regarding the state S₂ obtained by cutting off the three-dimensional table at a position i=2 of the i axis with a plane perpendicular to the i axis, and detects the maximum value of the state transition probability a₂ⱼ(U₁) of the state transition from the state S₂ that occurs when the action U₁ is performed of the action plane regarding the state S₂ thereof.

That is to say, the open-edge detecting unit 37 detects the maximum value of state transition probability a_{2,1}(U₁), a_{2,2}(U₁), . . . , a_{2,N}(U₁) arrayed in the j-axis direction at a position of m=1 of the action axis of the action plane regarding the state S₂.

Similarly, the open-edge detecting unit 37 detects the maximum value of the state transition probability of the state transition from the state S₂ that occurs when another action Uₘ is performed from the action plane regarding the state S₂.

Further, regarding the state S₄ that is another state listed as to the observation value O₂ as well, similarly, the open-edge detecting unit 37 detects the maximum value of the state transition probability of the state transition from the state S₄ that occurs when each action Uₘ is performed from the action plane regarding the state S₄.

As described above, the open-edge detecting unit 37 detects the maximum value of the state transition probability of state transition that occurs when each action Uₘ is performed regarding each of the sates S₂ and S₄ listed as to the observation valued O₂.

Subsequently, the open-edge detecting unit 37 averages the maximum value of the state transition probability detected such as described above regarding the states S₂ and S₄ listed as to the observation value O₂ for each action Uₘ, and takes an average value obtained by the averaging thereof as a transition probability response value corresponding to the maximum value of state transition probability regarding the observation value O₂.

The transition probability response value regarding the observation value O₂ is obtained for each action Uₘ, but this transition probability response value for each action Uₘ obtained regarding the observation value O₂ represents probability (action probability) that the action Uₘ is performed when the observation value O₂ is observed.

With regard to another observation value Oₖ as well, similarly, the open-edge detecting unit 37 obtains a transition probability response value serving as action probability for each action Uₘ.

Subsequently, the open-edge detecting unit 37 generates a matrix in which action probability that the action Uₘ is performed when the observation value Oₖ is observed is taken as an element at the k'th from the top and the m'th from the left, as an action template C.

Accordingly, the action template C is made up of a matrix of K rows and M columns wherein the number of rows is equal to the number K of the observation value Oₖ, and the number of columns is equal to the number M of the action Uₘ.

After generation of the action template C, the open-edge detecting unit 37 uses the action template C thereof to calculate action probability D based on observation probability.

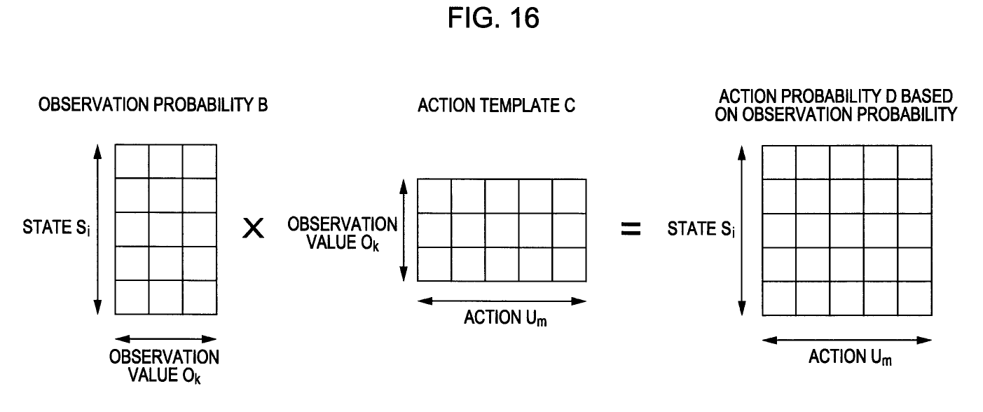

FIG. 16 is a diagram for describing a method for calculating the action probability D based on observation probability. Now, if we say that a matrix with the observation probability bᵢ(Oₖ) for observing the observation value Oₖ as an element at the i'th row and the k'th column in the state Sᵢ is an observation probability matrix B, the observation probability matrix B is made up of a matrix of N rows and K columns wherein the number of rows is equal to the number N of the state Sᵢ, and the number of columns is equal to the number K of the observation value Oₖ.

The open-edge detecting unit 37 multiplies the observation probability matrix B of N row and K columns by the action template C that is a matrix of K rows and M columns in accordance with Expression (17), thereby calculating the action probability D based on the observation probability that is a matrix with probability that the action Uₘ will be performed as an element at the i'th row and the m'th column in the state Sᵢ in which the observation value Oₖ is observed.

D=BC (17)

The open-edge detecting unit 37 calculates the action probability D based on the observation probability such as described above, and additionally calculates action probability E based on state transition probability.

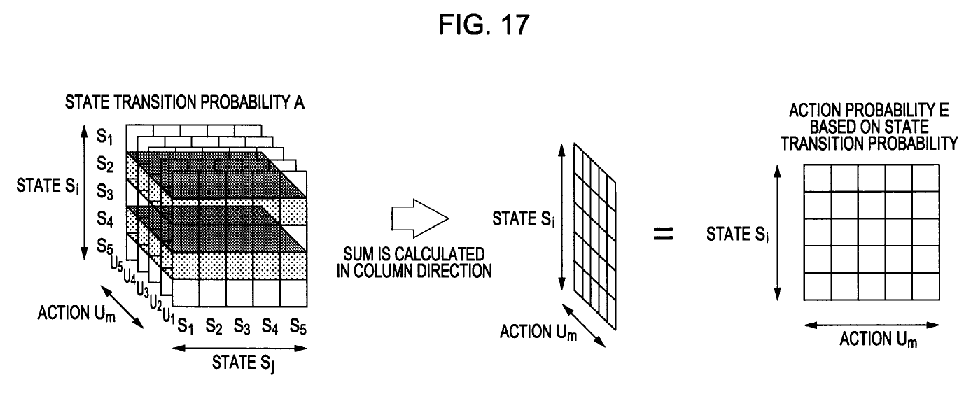

FIG. 17 is a diagram for describing a method for calculating the action probability E based on state transition probability. The open-edge detecting unit 37 adds the state transition probability aᵢⱼ(Uₘ) regarding each of the state Sᵢ in the i-axis direction of the three-dimensional state transition probability table A made up of the i axis, j axis, and action axis for each of the action Uₘ, thereby calculating the action probability E based on the state transition probability that is a matrix with probability that the action Uₘ will be performed as an element at the i'th row and the m'th column in the state Sᵢ.

Specifically, the open-edge detecting unit 37 obtains the sum of the state transition probability aᵢⱼ(Uₘ) arrayed in the horizontal direction (column direction) of the state transition probability table A made up of the i axis, j axis, and action axis, i.e., in the case of observing a certain position i of the i axis, and a certain position of m of the action axis, obtains the sum of the state transition probability aᵢⱼ(Uₘ) arrayed on a straight line parallel to the j axis passing through a point (i, m), and takes the sum thereof as an element at the i'th row and the m'th column, thereby calculating the action probability E based on the state transition probability that is a matrix of N rows and M columns.

After calculating the action probability D based on the observation probability, and the action probability E based on the state transition probability, such as described above, the open-edge detecting unit 37 calculates difference action probability F that is difference between the action probability D based on the observation probability, and the action probability E based on the state transition probability in accordance with Expression (18).

F=D−E

The difference action probability F is made up of a matrix of N rows and M columns in common with the action probability D based on the observation probability, and the action probability E based on the state transition probability.

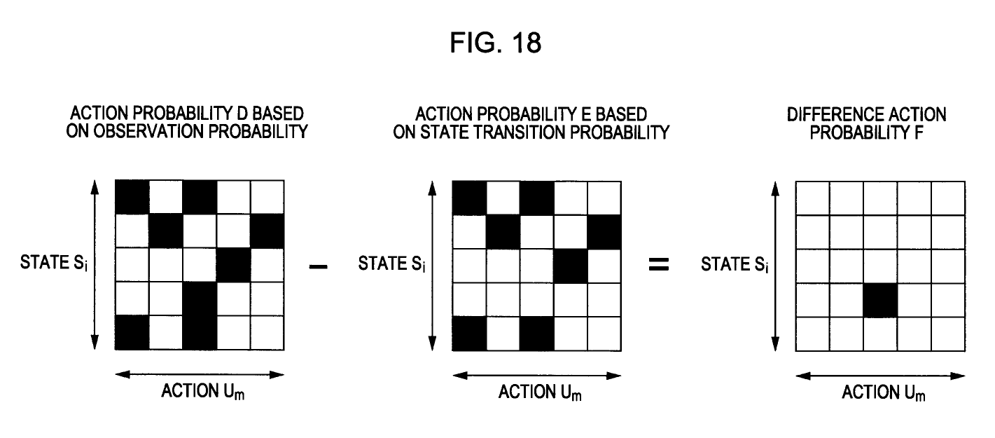

FIG. 18 is a diagram schematically illustrating the difference action probability F.

In FIG. 18, a small square represents an element in a matrix. Also, a square with no pattern represents an element that is deemed to be 0.0, and a square filled with black represents an element that is a value other than (not regarded as) 0.0.

According to the difference action probability F, in the case that there are multiple states as a state in which the observation value Oₖ is observed, it has been familiar that the action Uₘ can be performed from a partial state of the multiple states (a state that the agent has performed the action Uₘ), but remaining states in which state transition that occurs when the action Uₘ thereof is performed has not been reflected on the state transition probability aᵢⱼ(Uₘ) (a state in which the agent has not performed the action Uₘ), i.e., the open edge can be detected.

That is to say, in the case that state transition that occurs when the action Uₘ is performed has been reflected on the state transition probability aᵢⱼ(Uₘ) of the state Sᵢ, the element at the i'th row and the m'th column of the action probability D based on the observation probability, and the element at the i'th row and the m'th column of the action probability E based on the state transition probability have a similar value.

On the other hand, in the case that state transition that occurs when the action Uₘ is performed has not been reflected on the state transition probability aᵢⱼ(Uₘ) of the state Sᵢ, the element at the i'th row and the m'th column of the action probability D based on the observation probability has a value not regarded as 0.0, a certain level of value due to influence of state transition of a state in which the same observation value as with the state Si is observed, and the action Uₘ has been performed, but the element at the i'th row and the m'th column of the action probability E based on the state transition probability has 0.0 (including a small value regarded as 0.0).

Accordingly, in the case that state transition that occurs when the action Uₘ is performed has not been reflected on the state transition probability aᵢⱼ(Uₘ) of the state Sᵢ, the element at the i'th row and the m'th column of the difference action probability F has a value (absolute value) not regarded as 0.0, and accordingly, the open edge and an action that has not been performed at the open edge can be detected by detecting an element having a value not regarded as 0.0 of the difference action probability F.

That is to say, in the case that the value of the element at the i'th row and the m'th column of the difference action probability F is a value not regarded as 0.0, the open-edge detecting unit 37 detects the state Sᵢ as the open edge, and also detects the action Uₘ as an action that has not been performed in the state Sᵢ that is the open edge.

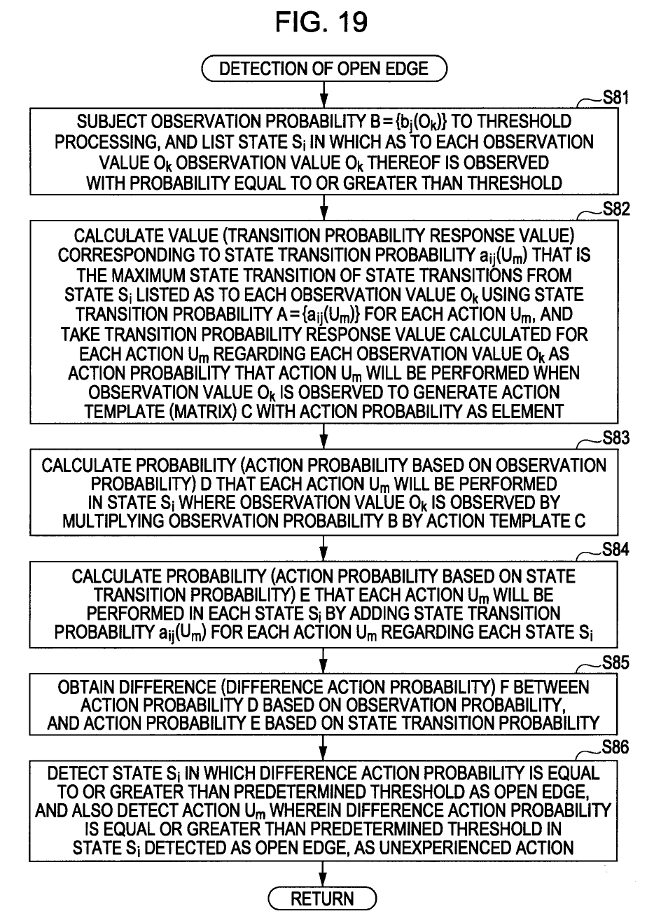

FIG. 19 is a flowchart for describing processing for detecting the open edge performed in step S53 in FIG. 9 by the open-edge detecting unit 37 in FIG. 4.

In step S81, the open-edge detecting unit 37 subjects the observation probability B={bᵢ(Oₖ)} of the expanded HMM stored in the model storage unit 22 (FIG. 4) to threshold processing, and thus, such as described in FIGS. 14A and 14B, lists, as to each of the observation value Oₖ, the state Sᵢ in which the observation value Oₖ is observed with probability equal to or greater than a threshold.

Subsequently to step S81, the processing proceeds to step S82 where, as described with reference to FIG. 15, the open-edge detecting unit 37 uses the state transition probability A={aᵢⱼ(Uₘ)} of the expanded HMM model to calculate, regarding each of the observation value Oₖ, a transition probability response value that is a value corresponding to the state transition probability aᵢⱼ(Uₘ) that is the maximum state transition of the state transitions from the state Sᵢ listed as to the observation value Oₖ for each of the action Uₘ, and takes, regarding each of the observation value Oₖ, the transition probability response value calculated for each of the action Uₘ as action probability that the action Uₘ is performed when the observation value Oₖ is observed, to generate an action template C that is a matrix with the action probability as an element.

Subsequently, the processing proceeds from step S82 to step S83, where the open-edge detecting unit 37 multiplies the observation probability matrix B by the action template C in accordance with Expression (17), thereby calculating the action probability D based on the observation probability, and the processing proceeds to step S84.

In step S84, as described with reference to FIG. 17, the open-edge detecting unit 37 adds the state transition probability aᵢⱼ(Uₘ) regarding each of the state Sᵢ in the T-axis direction of the state transition probability table A for each of the action Uₘ, thereby calculating the action probability E based on the state transition probability that is a matrix with probability that the action Uₘ will be performed as an element at the i'th row and the m'th column in the state Sᵢ.

Subsequently, the processing proceeds from step S84 to step S85, where the open-edge detecting unit 37 calculates the difference action probability F that is difference between the action probability D based on the observation probability, and the action probability E based on the state transition probability in accordance with Expression (18), and the processing proceeds to step S86.

In step S86, the open-edge detecting unit 37 subjects the difference action probability F to threshold processing, thereby detecting an element of which the value is equal to or greater than a predetermined threshold of the difference action probability F as a detection target element of a detection target.

Further, the open-edge detecting unit 37 detects the row i and column m of the detection target element, detects the state Sᵢ as the open edge, and also detects the action Uₘ as an inexperienced action that has not been performed at an open edge Sᵢ, and return.

The agent performs an inexperienced action at the open edge, and accordingly can pioneer an unknown region subsequently to the end of the open edge.

Now, with the action determining method according to the related art, the target of the agent is determined by equally handling a known region (learned region) and an unknown region (unlearned region) without taking the experience of the agent into consideration. Therefore, in order to gain experience of an unknown region, many actions have had to be performed, and as a result thereof, widely learning the configuration of the action environment has taken much trial-and-error over a great amount of time.

On the other hand, with the agent in FIG. 4, the open edge is detected, and an action is determined with the open edge thereof as a target state, and accordingly, the configuration of the action environment can effectively be learned.

Specifically, the open edge is a state in which an unknown region that the agent has not experienced is extended, and accordingly, the agent can aggressively get further into the unknown region by detecting the open edge, and determining an action with the open edge thereof as a target state. Thus, the agent can effectively gain experience for widely learning the configuration of the action environment.

### Detection of Branching Structured State

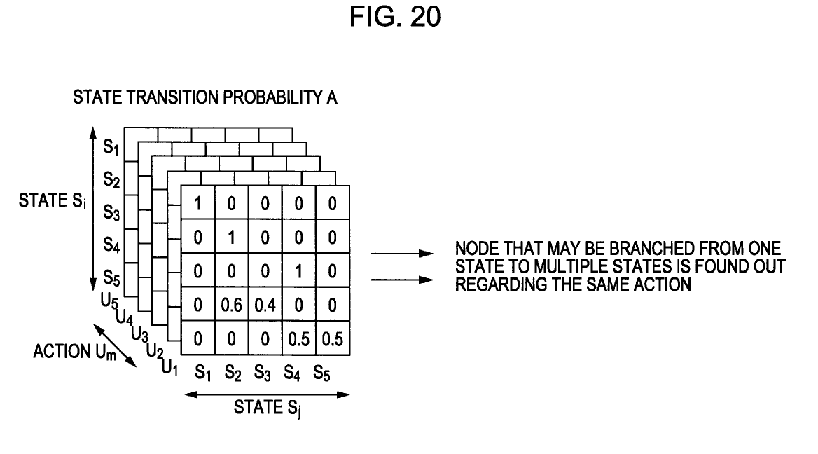

FIG. 20 is a diagram for describing a method for detecting a branching structured state by the branching structure detecting unit 36 in FIG. 4.

The expanded HMM obtains a portion of which the configuration is changed of the action environment, as a branching structured state. The branching structured state corresponding to change in the configuration that the agent has already experienced can be detected by referring to the state transition probability of the expanded HMM that is long-term memory. If a branching structured state has been detected, the agent can recognize that there is a portion of the action environment where the configuration changes.

In the case that there is a portion of which the configuration is changed of the action environment, with regard to such a portion, it is desirable to aggressively confirm the current configuration on regular or irregular basis, and to reflect this on the inhibitor, and consequently, corrected transition probability that is short-term memory.

Therefore, with the agent in FIG. 4, a branching structured state can be detected at the branching structure detecting unit 36, and a branching structured state can be selected as a target state at the target selecting unit 31.

The branching structure detecting unit 36 detects a branching structured state such as shown in FIG. 20. That is to say, the state transition probability plane of each of the action Uₘ of the state transition probability table A is normalized so that the sum of the horizontal direction (column direction) of each row becomes 1.0.

Accordingly, with the state transition probability plane regarding the action Uₘ, in the case of observing a certain row i, when the state Sᵢ is not a branching structured state, the maximum value of the state transition probability aᵢⱼ(Uₘ) of the i'th row is either 1.0 or a value extremely close to 1.0.

On the other hand, when the state Sᵢ is a branching structured state, the maximum value of the state transition probability aᵢⱼ(Uₘ) of the i'th row is sufficiently smaller than 1.0 such as 0.6 or 0.5 shown in FIG. 20, and also greater than a value (average value) 1/N in the case of equally dividing the state transition probability of which the sum is 1.0 by the number N of states.

Therefore, in the case that the maximum value of the state transition probability aᵢⱼ(Uₘ) of each row i of the state transition probability plane regarding each of the action Uₘ is smaller than a threshold aₘₐₓ_{_{—}}ₜₕ that is smaller than 1.0, and also greater than the average value 1/N, the branching structure detecting unit 36 detects the state Sᵢ as a branching structured state, following Expression (19)

$$1 / N < {max}_{j , i = S , m = U} ( {A}_{ijm} ) < {a}_{max\_th} \qquad ( 19 )$$

where Aᵢⱼₘ represents, with the three-dimensional state transition probability table A, the state transition probability aᵢⱼ (Uₘ) wherein the position in the i-axis direction is the i'th from the top, the position in the j-axis direction is the j'th from the left, and the position in the action-axis direction is the m'th from the near side.

Also, in Expression (19), max(Aᵢⱼₘ) represents, with the state transition probability table A, the maximum value of N state transition probabilities Ti_{1,S,U} through A_{N,S,U}(a_{1,S}(U) through a_{N,S}(U)) wherein the position in the j-axis direction is the S'th from the left (the state of the transition destination of state transition from the state Sᵢ is a state S), and the position in the action-axis direction is the U'th from the near side (the action to be performed when state transition from the state Sᵢ occurs is the action U).

Note that, in Expression (19), the threshold aₘₐₓ_{_{—}}ₜₕ can be adjusted in a range of 1/N<aₘₐₓ_{_{—}}ₜₕ<1.0 according to which level detection sensitivity of a branching structured state is set to, wherein the closer the threshold aₘₐₓ_{_{—}}ₜₕ is set to 1.0, the more sensitively a branching structured state can be detected.

In the case of having detected one or more branching structured states, the branching structure detecting unit 36 supplies, such as described in FIG. 9, the one or more branching structured states thereof to the target selecting unit 31.

Further, the target selecting unit 31 refers to the elapsed time management table of the elapsed time management table storage unit 32 to recognize elapsed time of the one or more branching structured states from the branching structure detecting unit 36.

Subsequently, the target selecting unit 31 detects a state having the longest elapsed time out of the one or more branching structured states from the branching structure detecting unit 36, and selects the state thereof as a target state.

As described above, a state having the longest elapsed time is selected out of the one or more branching structured states, and the state thereof is selected as a target state, whereby an action can be performed wherein how the configuration corresponding to the branching structure state is confirmed by taking each of the one or more branching structured states as a target state evenly in time.

Now, with the action determining method according to the related art, a target is determined without paying notice to a branching structured state, and accordingly, a state other than a branching structured state is frequently taken as a target. Therefore, in the case of recognizing the latest configuration of the action environment, a wasteful action has frequently been performed.

On the other hand, with the agent in FIG. 4, an action is determined with a branching structured state as a target state, whereby the latest configuration of a portion corresponding to a branching structured state can be recognized early and reflected on the inhibitor.

Note that, in the case that a branching structured state has been determined to be a target state, after reaching (the observation units corresponding to) the branching structured state serving as the target state, the agent can move by determining an action whereby state transition to a different state can be performed based on the expanded HMM and performing the action thereof, from that state in the branching structure, and thus can recognize (understand) the configuration of a portion corresponding to the branching structured state, i.e., a state to which state transition can now be made from the branching structured state.

### Simulation

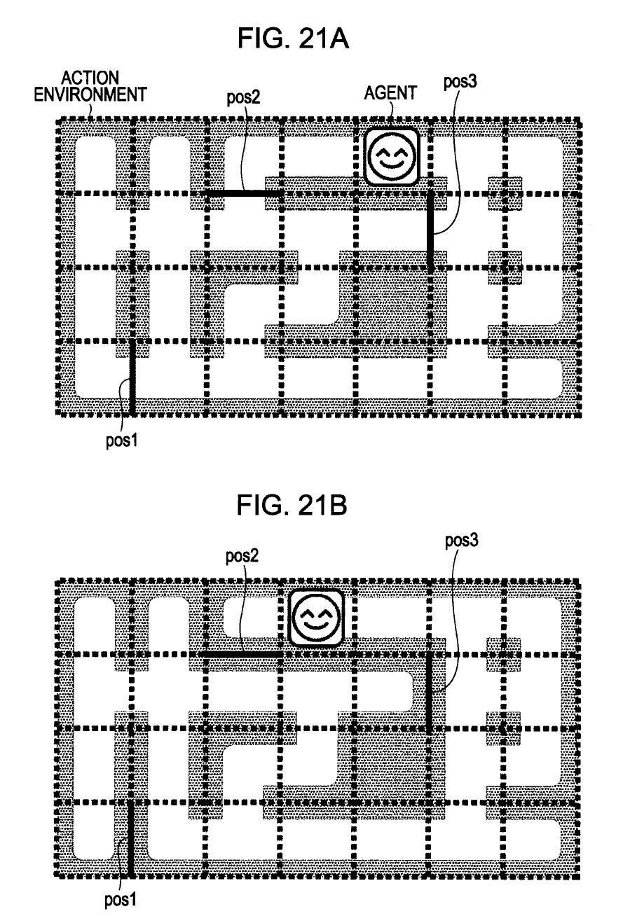

FIGS. 21A and 21B are diagrams illustrating an action environment used for simulation regarding the agent in FIG. 4 that has been performed by the present inventor.

Specifically, FIG. 21A illustrates an action environment having a first configuration, and FIG. 21B illustrates an action environment having a second configuration.

With the action environment having the first configuration, positions pos1, pos2, and pos3 are included in a path, where the agent can pass through these positions, but on the other hand, with the action environment having the second configuration, the positions pos1 through pos3 are included in the wall which prevents the agent from passing through these positions.

Note that each of the positions pos1 through pos3 can individually be included in the path or wall.

The simulation has caused the agent to perform actions at each of the action environment having the first configuration and the action environment having the second configuration in the reflective action mode (FIG. 5), whereby observation series and action series serving as 4000-step (point-in-time) worth of learned data have been obtained, and learning of the expanded HMM has been performed.

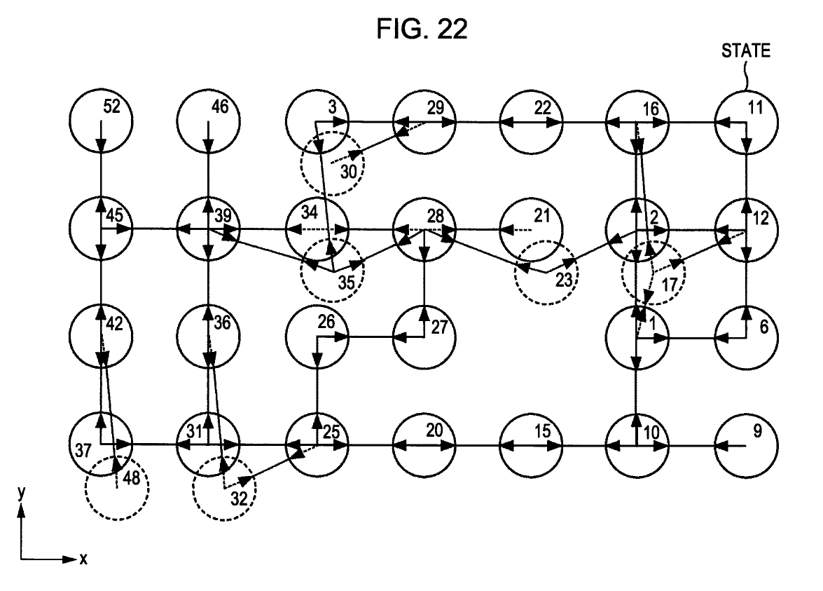

FIG. 22 is a diagram schematically illustrating the expanded HMM after learning. In FIG. 22, a circle represents a state of the expanded HMM, and a numeral described within the circle is the suffix of the state represented by the circle. Also, arrows indicating states represented by circles represent available state transition (state transition of which the state transition probability is deemed to be other than 0.0).

With the expanded HMM in FIG. 22, the state Sᵢ is disposed in the position of the observation units corresponding to the state Sᵢ thereof.

Two states whereby state transition is available represent that the agent can move between two observation units corresponding to the two states thereof respectively. Accordingly, arrows representing state transition of the expanded HMM represent the path where the agent can move within the action environment.

In FIG. 22, there is a case where two (multiple) states Sᵢ and S_{i′} are disposed in the position of one of the observation units in a partially overlapped manner, which represents that the two (multiple) states Sᵢ and S_{i′} correspond to the one of the observation units thereof.

In FIG. 22, in the same way as in the case of FIG. 10A, states S₃ and S₃₀ correspond to one of the observation units, and states S₃₄ and S₃₅ also correspond to one of the observation units. Similarly, states S₂₁ and S₂₃, states S₂ and S₁₇, states S₃₇ and S₄₈, and states S₃₁ and S₃₂ also correspond to one of the observation units, respectively.

Also, in FIG. 22, in the case that the action U₄ (FIG. 3B) wherein the agent moves in the left direction has been performed, the state S₂₉ of which the state transition to the different states S₃ and S₃₀ can be performed is a branching structured state, in the case that the action U₂ wherein the agent moves in the right direction has been performed, the state S₃₉ of which the state transition to the different states S₃₄ and S₃₅ can be performed is a branching structured state, in the case that the action U₄ wherein the agent moves in the left direction has been performed, the state S₂₈ of which the state transition to the different states S₃₄ and S₃₅ can be performed (the state S₂₈ is also a state wherein state transition to the different state S₂₁ and S₂₃ can be performed in the case that the action U₂ wherein the agent moves in the right direction) is a branching structured state, in the case that the action U₁ wherein the agent moves in the upper direction has been performed, the state S₁ of which the state transition to the different states S₂ and S₁₇ can be performed is a branching structured state, in the case that the action U₃ wherein the agent moves in the lower direction has been performed, the state S₁₆ of which the state transition to the different states S₂ and S₁₇ can be performed is a branching structured state, in the case that the action U₄ wherein the agent moves in the left direction has been performed, the state S₁₂ of which the state transition to the different states S₂ and S₁₇ can be performed is a branching structured state, in the case that the action U₃ wherein the agent moves in the lower direction has been performed, the state S₄₂ of which the state transition to the different states S₃₇ and S₄₈ can be performed is a branching structured state, in the case that the action U₃ wherein the agent moves in the lower direction has been performed, the state S₃₆ of which the state transition to the different states S₃₁ and S₃₂ can be performed is a branching structured state, and in the case that the action U₄ wherein the agent moves in the left direction has been performed, the state S₂₅ of which the state transition to the different states S₃₁ and S₃₂ can be performed is a branching structured state, respectively.

Note that, in FIG. 22, a dotted-line arrow represents state transition that can be performed at the action environment having the second configuration. Accordingly, in the case that the configuration of the action environment is the first configuration (FIG. 21A), the agent is not allowed to perform state transition represented with a dotted-line arrow in FIG. 22.

With the simulation, initial settings have been performed wherein the inhibitor corresponding to the state transition represented with a dotted-line arrow in FIG. 22 is set to 0.0, and the inhibitors corresponding to the other state transitions are set to 1.0, and thus, immediately after start of the simulation the agent can calculate an action plan including an action wherein state transition that can be performed only at the action environment having the second configuration occurs.

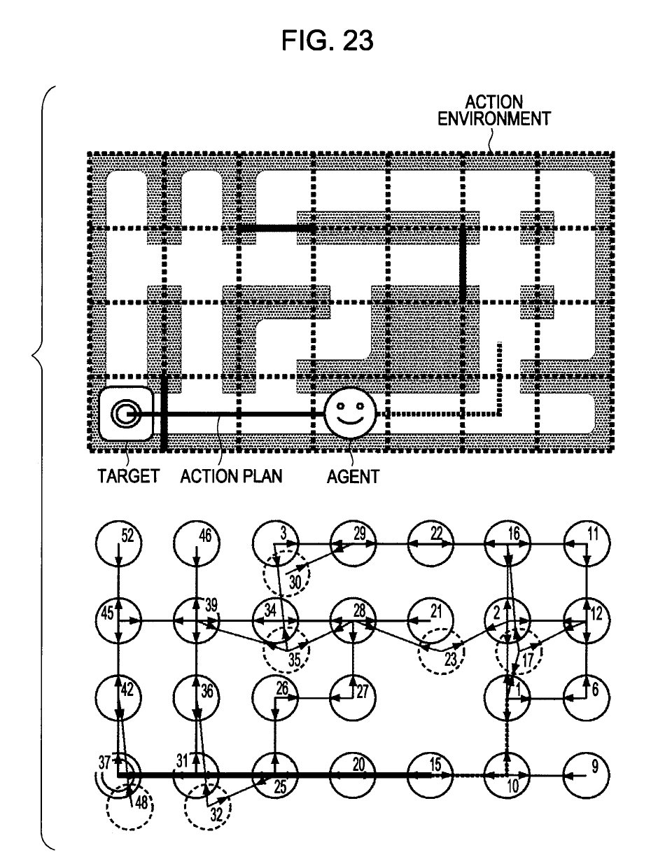

FIGS. 23 through 29 are diagrams illustrating the agent which calculates an action plan until it reaches a target state based on the expanded HMM after learning, and performs an action determined in accordance with the action plan thereof.

Note that, in FIGS. 23 through 29, the agent within the action environment, and (the observation units corresponding to) the target state are illustrated on the upper side, and the expanded HMM is illustrated on the lower side.

FIG. 23 illustrates the agent at point-in-time t=t₀. At the point-in-time t=t₀, the configuration of the action environment is the first configuration wherein the positions pos1 through pos3 are included in the path (FIG. 21A).

Further, at the point-in-time t=t₀, (the observation units corresponding to) the target state is the state S₃₇ left below, and the agent is positioned in (the observation units corresponding to) the state S₂₀-Subsequently, the agent calculates an action plan headed to the state S₃₇ that is the target state, and performs movement from the state S₂₀ that is the current state to the left direction as an action determined in accordance with the action plan thereof.

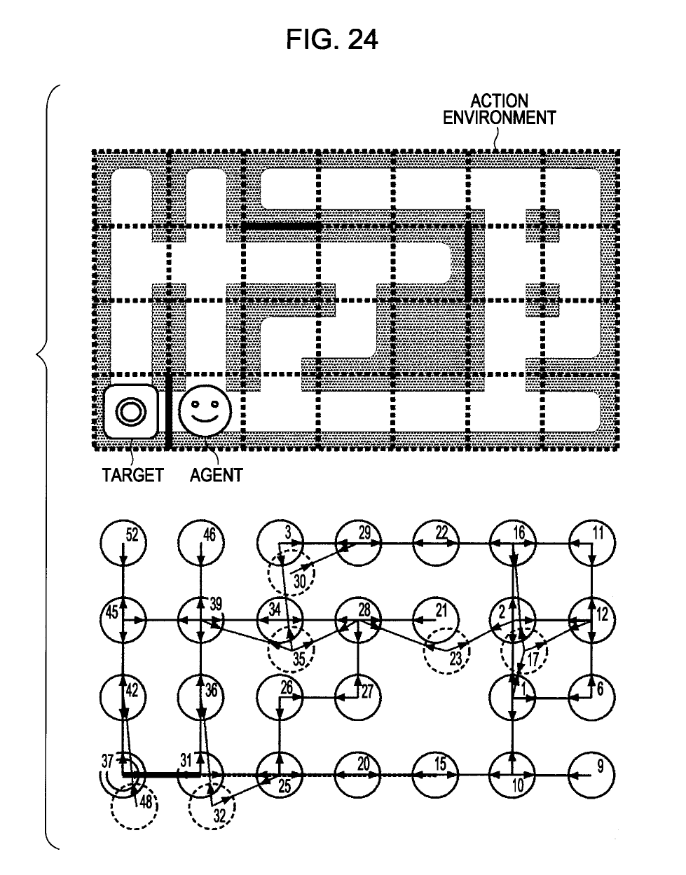

FIG. 24 illustrates the agent at point-in-time t=t₁ (>t₀). At the point-in-time t=t₁ the configuration of the action environment is changed from the first configuration to a configuration wherein the agent can pass through the position pos1 included in the path, not but the positions pos2 and pos3 included in the wall.

Further, at the point-in-time t=t₁, the target state is, in the same way in the case of the point-in-time t=t₀, the state S₃₇ left below, and the agent is positioned in the state S₃₁.

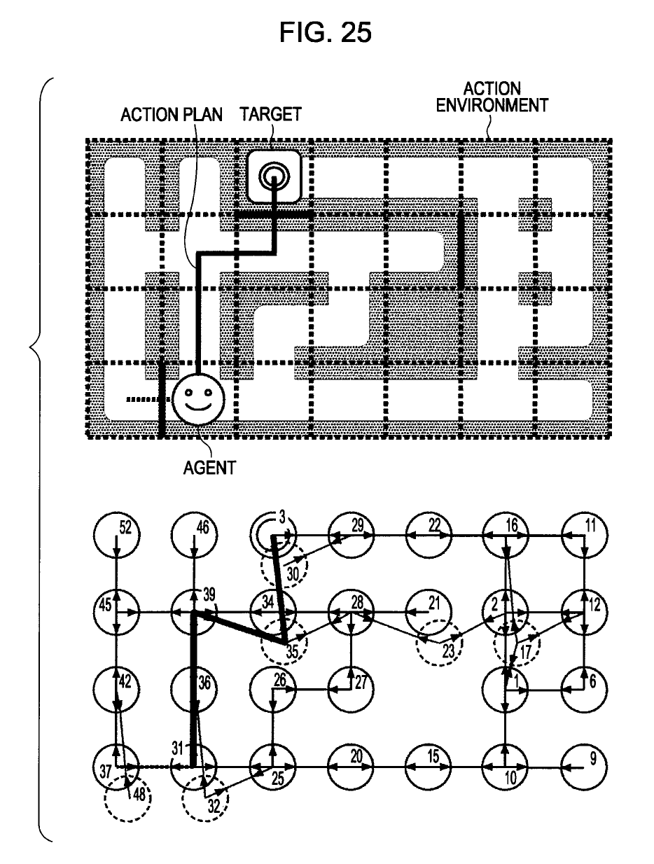

FIG. 25 illustrates the agent at point-in-time t=t₂ (>t₁). At the point-in-time t=t₂ the configuration of the action environment is changed to a configuration wherein the agent can pass through the position pos1 included in the path, not but the positions pos2 and pos3 included in the wall (hereafter, also referred to as “changed configuration”).

Further, at the point-in-time t=t₂, the target state is the state S₃ on the upper side, and the agent is positioned in the state S₃₁.

Subsequently, the agent calculates an action plan headed to the state S₃ that is the target state, and attempts to perform movement from the state S₃₁ that is the current state to the upper direction as an action determined in accordance with the action plan thereof.

Here, at the point-in-time t=t₂, an action plan is calculated wherein state transition of state series S₃₁, S₃₆, S₃₉, S₃₅, and S₃ occurs.

Note that, in the case that the action environment has the first configuration, the position pos1 (FIGS. 21A and 21B) between the observation units corresponding to the states S₃₇ and S₄₈, and the observation units corresponding to the states S₃₁ and S₃₂, the position pos2 between the observation units corresponding to the states S₃ and S₃₀, and the observation units corresponding to the states S₃₄ and S₃₅, and the position pos3 between the observation units corresponding to the states S₂₁ and S₂₃, and the observation units corresponding to the states S₂ and S₁₇ are all included in the path, and accordingly, the agent can pass through the positions post through pos3.

However, in the case that the action environment has a changed configuration, the positions pos2 and pos3 are included in the wall, and accordingly, the agent is prevented from passing through the positions pos2 and pos3.

As described above, with the initial settings of the simulation, only the inhibitor corresponding to state transition that can be performed only at the action environment having the second configuration is set 0.0, and at the point-in-time t=t₂ state transition that can be performed at the action environment having the first configuration is not suppressed.

Therefore, at the point-in-time t=t₂, the position pos2 between the observation units corresponding to the states S₃ and S₃₀, and the observation units corresponding to the states S₃₄ and S₃₅ is included in the wall, and accordingly, the agent is prevented from passing through the position pos2, but the agent has already calculated the action plan including an action wherein state transition from the state S₃₅ to the state S₃ occurs passing through the position pos2 between the observation units corresponding to the states S₃ and S₃₀, and the observation units corresponding to the states S₃₄ and S₃₅.

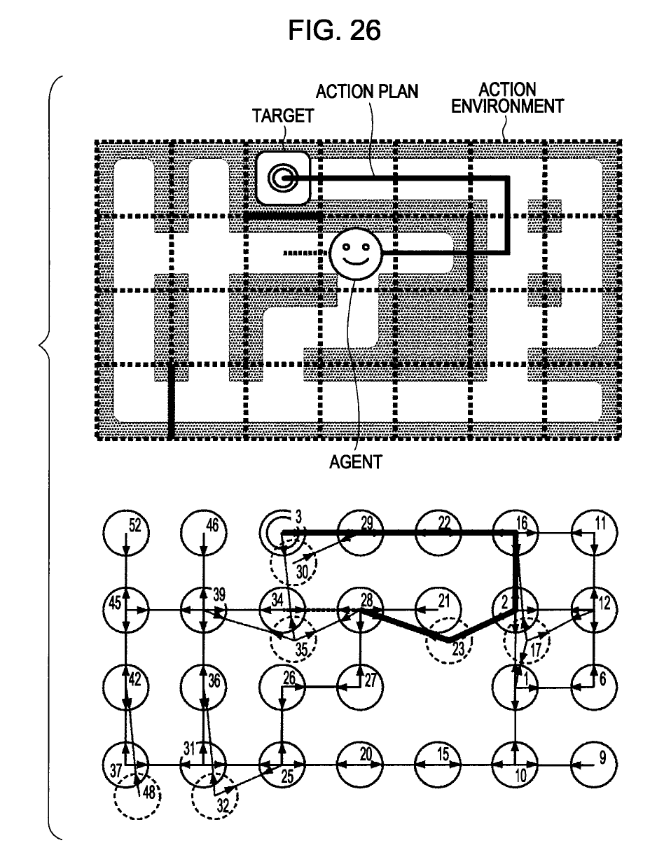

FIG. 26 illustrates the agent at point-in-time t=t₃ (>t₂). At the point-in-time t=t₃ the configuration of the action environment is still the changed configuration.

Further, at the point-in-time t=t₃, the target state is the state S₃ on the upper side, and the agent is positioned in the state S₂₈.

Subsequently, the agent calculates an action plan headed to the state S₃ that is the target state, and attempts to perform movement from the state S₂₈ that is the current state to the right direction as an action determined in accordance with the action plan thereof.

Here, at the point-in-time t=t₃, an action plan is calculated wherein state transition of state series S₂₈, S₂₃, S₂, S₁₆, S₂₂, S₂₉, and S₃ occurs.

At the point-in-time t=t₂ and thereafter, the agent moves to the observation units corresponding to the state S₃₅ by calculating an action plan similar to the action plan (FIG. 25) wherein the state transition of the state series S₃₁, S₃₆, S₃₉, S₃₅, and S₃ occurs, calculated at the point-in-time t=t₂, and performing an action determined in accordance with the action plan thereof, but at this time, recognizes that it is difficult to pass through the position pos2 between the observation units corresponding to the states S₃ (and S₃₀) and the observation units corresponding to the states (S₃₄ and) S₃₅, i.e., recognizes that a state reached from the state S₃₉ of the state series S₃₁, S₃₆, S₃₉, S₃₅, and S₃ corresponding to the action plan by performing an action determined in accordance with the action plan is not the state S₃₅ following the state S₃₉ but the state S₃₄, and updates the inhibitor corresponding to the state transition from the state S₃₉ to the state S₃₅ that has not been performed, to 0.0.

As a result thereof, at the point-in-time t=t₃ the agent calculates an action plan wherein the state transition of the state series S₂₃, S₂₃, S₂, S₁₆, S₂₂, S₂₉, and S₃ occurs, which is an action plan wherein the agent can pass through the position pos2, and the state transition from the state S₃₉ to the state S₃₅ does not occur.

Note that, in the case that the action environment has the changed configuration, the position pos3 between the observation units corresponding to the states S₂₁ and S₂₃ and the observation units corresponding to the states S₂ and S₁₇ (FIGS. 21A and 21B) is included in the wall, which prevents the agent from passing the position pos3.

As described above, with the initial settings of the simulation, only the inhibitor corresponding to state transition that can be performed only at the action environment having the second configuration wherein the positions pos1 through pos3 are included in the wall, and the agent is prevented from passing through these positions is set 0.0, and at the point-in-time t=t₃ state transition from the state S₂₃ to the state S₂ corresponding to passing through the position pos3 that can be performed at the action environment having the first configuration is not suppressed.

Therefore, at the point-in-time t=t₃, the agent calculates an action plan wherein state transition from the state S₂₃ to the state S₂ occurs passing through the position pos3 between the observation units corresponding to the states S₂₁ and S₂₃ and the observation units corresponding to the states S₂ and S₁₇.

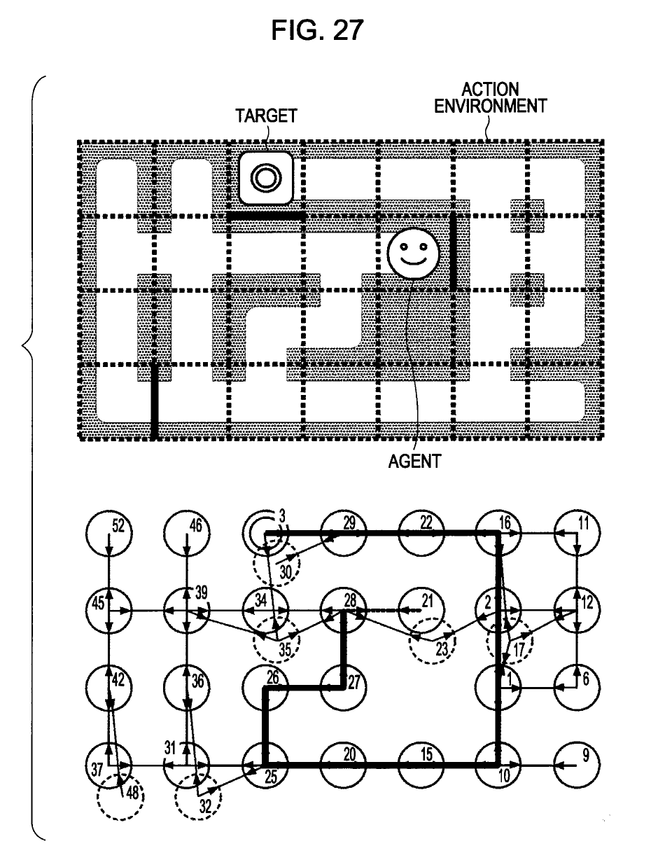

FIG. 27 illustrates the agent at point-in-time t=t₄ (i.e., t₃+1). At the point-in-time t=t₄ the configuration of the action environment is the changed configuration.

Further, at the point-in-time t=t₄, the target state is the state S₃ on the upper side, and the agent is positioned in the state S₂₁.

The agent moves from the observation units corresponding to the state S₂₈ to the observation units corresponding to the states S₂₁ and S₂₃ by performing an action determined in accordance with the action plane wherein the state transition of the state series S₂₈, S₂₃, S₂, S₁₆, S₂₂, S₂₉, and S₃ calculated at the point-in-time t=t₃ (FIG. 26) occurs, but at this time, recognizes that a state reached from the state S₂₈ of the state series S₂₈, S₂₃, S₂, S₁₆, S₂₂, S₂₉, and S₃ corresponding to the action plan by performing an action determined in accordance with the action plan is not the state S₂₃ following the state S₂₈ but the state S₂₁, and updates the inhibitor corresponding to the state transition from the state S₂₈ to the state S₂₃ to 0.0.

As a result thereof, at the point-in-time t=t₄ the agent calculates an action plan not including the state transition from the state S₂₈ to the state S₂₃ (further, as a result thereof, not passing through the position pos3 between the observation units corresponding to the states S₂₁ and S₂₃, and the observation units corresponding to the states S₂ and S₁₇).

Here, at the point-in-time t=t₄, an action plan is calculated wherein state transition of state series S₂₈, S₂₇, S₂₆, S₂₅, S₂₀, S₁₅, S₁₀, S₁, S₂, S₁₆, S₂₂, S₂₉, and S₃ occurs.

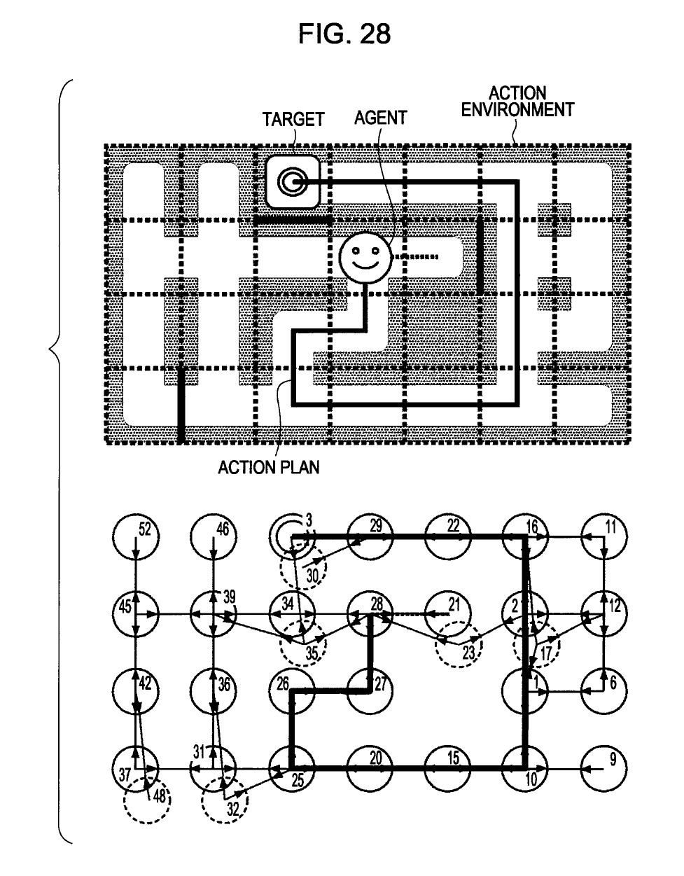

FIG. 28 illustrates the agent at point-in-time t=t₅ (i.e., t₄+1). At the point-in-time t=t₅ the configuration of the action environment is the changed configuration.

Further, at the point-in-time t=t₅, the target state is the state S₃ on the upper side, and the agent is positioned in the state S₂₈.

The agent moves from the observation units corresponding to the state S₂₁ to the observation units corresponding to the state S₂₈ by performing an action determined in accordance with the action plane wherein the state transition of the state series S₂₈, S₂₇, S₂₆, S₂₅, S₂₀, S₁₅, S₁₀, S₁, S₂, S₁₆, S₂₂, S₂₉, and S₃ calculated at the point-in-time t=t₄ (FIG. 27) occurs.

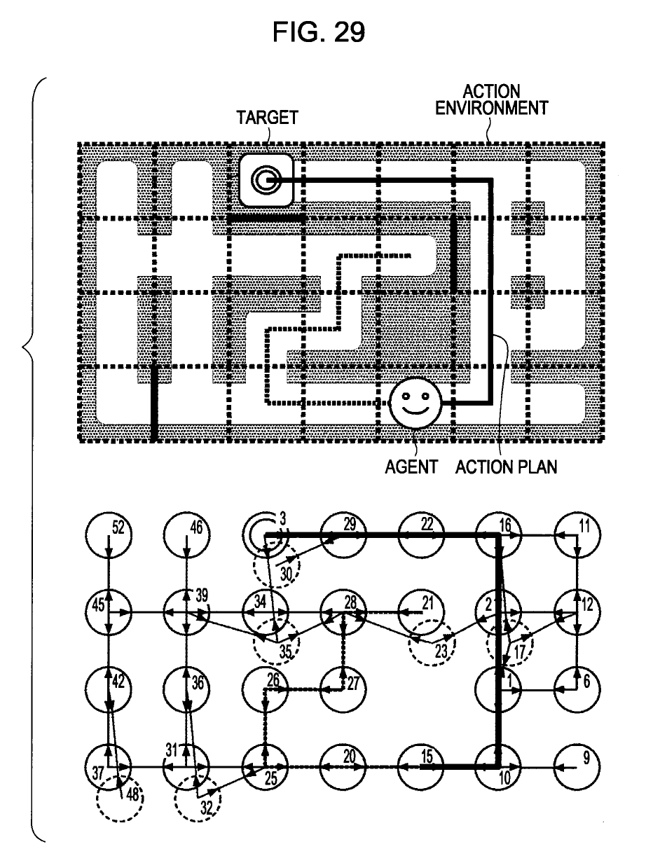

FIG. 29 illustrates the agent at point-in-time t=t₆ (>t₅). At the point-in-time t=t₆ the configuration of the action environment is the changed configuration.

Further, at the point-in-time t=t₆, the target state is the state S₃ on the upper side, and the agent is positioned in the state S₁₅.

Subsequently, the agent calculates an action plan headed to the state S₃ that is the target state, and attempts to perform movement from the state S₁₅ that is the current state to the right direction as an action determined in accordance with the action plan thereof.

Here, at the point-in-time t=t₆, an action plan is calculated wherein state transition of state series S₁₀, S₁, S₂, S₁₆, S₂₂, S₂₉, and S₃ occurs.

As described above, even in the event that the configuration of the action environment has been changed, the agent observes the changed configuration thereof (obtains (recognizes) which state the current state is), and updates the inhibitor. Subsequently, the agent can ultimately reach the target state by using the inhibitor after updating to calculate an action plan again.

### Applications of Agent

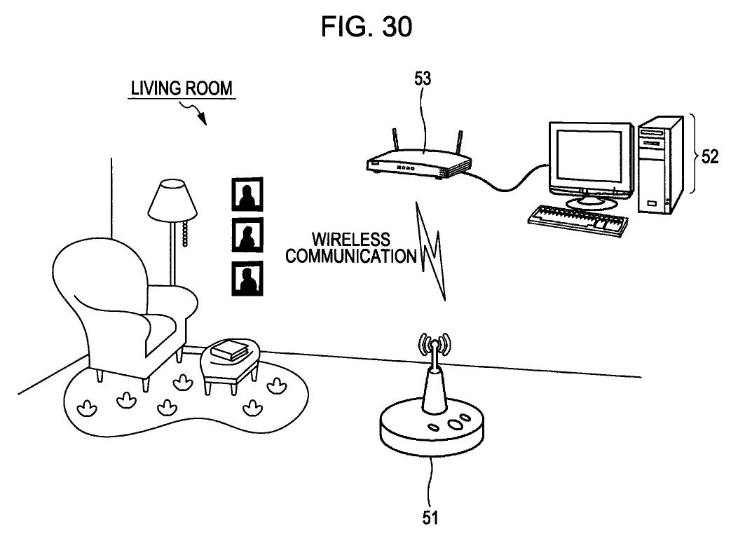

FIG. 30 is a diagram illustrating the outline of a cleaning robot to which the agent in FIG. 4 has been applied. In FIG. 30, a cleaning robot 51 houses a block serving as a cleaner, a block equivalent to the actuator 12 and the sensor 13 of the agent in FIG. 4, and a block for performing wireless communication. In FIG. 30, the cleaning robot performs movement serving as an action with a living room as an action environment, and performs cleaning of the living room.

A host computer 52 serves as the reflective action determining unit 11, history storage unit 14, action control unit 15, and target determining unit 16 (includes a block equivalent to the reflective action determining unit 11, history storage unit 14, action control unit 15, and target determining unit 16) shown in FIG. 4.

Also, the host computer 52 is connected to an access point 53, which is installed in the living room or another room, for controlling wireless communication by a wireless LAN (Local Area Network) or the like.

The host computer 53 exchanges data to be used by performing wireless communication with the cleaning robot 51 via the access point 53, and thus, the cleaning robot 51 performs movement serving as the same action as with the agent in FIG. 4.

Note that, in FIG. 30, in order to realize reduction in size of the cleaning robot 51, only the block equivalent to the actuator 12 and the sensor 13 which is the basic block of the blocks making up the agent in FIG. 4 is provided to the cleaning robot 51, and the other blocks are provided to the host computer 52 separately from the cleaning robot 51 while taking it into consideration that sufficient power and computation performance is not readily provided.

However, whether to provide which block of the blocks making up the agent in FIG. 4 to each of the cleaning robot 51 and the host computer 52 is not restricted to the above blocks.

Specifically, for example, an arrangement may be made wherein in addition to the actuator 12 and the sensor 13, a block equivalent to the reflective action determining unit 11 which does not demand such an advanced computation function is provided to the cleaning robot 51, and a block equivalent to the history storage unit 14, action control unit 15, and target determining unit 16, which demands an advanced computation function and large storage capacity, is provided to the host computer 53.

According to the expanded HMM, with an action environment where the same observation value is observed in the observation units of different positions, the current situation of the agent is recognized using observation series and action series, and the current state, and consequently, observation units (place) where the agent is positioned can uniquely be determined.

The agent in FIG. 4 updates the inhibitor according to the current state, and successively calculates an action plan while correcting the state transition probability of the expanded HMM using the updated inhibitor, whereby the target state can be reached even with an action environment of which the configuration is stochastically changed.

Such an agent can be applied to, for example, a practical use robot such as a cleaning robot or the like which acts within a living environment where a person lives of which the configuration is dynamically changed with the person's living activities.

For example, with a living environment such as a room or the like, the configuration is sometimes changed due to opening/closing of the door of a room, change in the layout of furniture within a room, or the like.

However, the shape of the room is not changed, and accordingly, a portion of which the configuration is changed, and an unchanged portion, coexist in the living environment.

According to the expanded HMM, the portion of which the configuration is changed can be stored as a branching structured state, and accordingly, the living environment including the portion of which the configuration is changed can effectively be represented (with small storage capacity).

On the other hand, with the living environment, in order to achieve a target for cleaning the whole room, a cleaning robot used as an alternate device of a cleaner operated by a person has to determine the position of the cleaning robot itself to move in the inside of the room of which the configuration is stochastically changed (the room of which the configuration may be changed) while switching the route in an adaptive manner.

Thus, with the living environment of which the configuration is stochastically changed, in order to realize the target (cleaning of the whole room) while determining the position of the cleaning robot itself and switching the route in an adaptive manner, the agent in FIG. 4 is particularly useful.

Note that, from a point of view of reducing the manufacturing costs of the cleaning robot, it is desirable to prevent a camera serving as an advanced sensor, and an image processing device for performing image processing such as recognition of images output from the camera from being mounted on the cleaning robot as a unit for observing observation values.

Specifically, in order to reduce the manufacturing costs of the cleaning robot, it is desirable to employ an inexpensive unit such as a distance measuring device or the like for measuring distance by performing output such as ultrasonic waves, laser, or the like in multiple directions, for the cleaning robot to observe observation values.

However, in the case of employing an inexpensive unit such as a distance measuring device or the like as a unit for observing observation values, the number of cases where the same observation value is observed at different positions of the living environment increases, and accordingly, the position of the cleaning robot is not readily uniquely determined only with an observation value at a point in time.

Thus, even with the living environment where the position of the cleaning robot is not readily uniquely determined only with an observation value at a point in time, according to the expanded HMM, the position can be uniquely determined using observation value series and action series.

### One-state One-observation-value Constraint

With the learning unit 21 in FIG. 4, learning of the expanded HMM using learned data is performed so as to maximize likelihood wherein learned data is observed in accordance with the Baum-Welch re-estimation method. The Baum-Welch re-estimation method is basically a method for subjecting model parameters to convergence by the gradient method, and accordingly, the model parameters may lapse into the local minimum.

There is initial value dependency wherein whether or not the model parameters lapse into the local minimum depends on the initial values of the model parameters.

With the present embodiment, an ergodic HMM is employed as the expanded HMM, which has particularly great initial value dependency.

With the learning unit 21 (FIG. 4), in order to reduce initial value dependency, learning of the expanded HMM can be performed under one-state one-observation-value constraint. Here, the one-state one-observation-value constraint is a constraint so as to observe only one observation value in one state of the (HMM including) expanded HMM.

Note that, with an action environment of which the configuration is changed, when learning of the expanded HMM is performed without any kind of constraint, with the expanded HMM after learning, a case where change in the configuration of the action environment is represented by having a distribution as to observation probability, and a case where change in the configuration of the action environment is represented by having the structure configuration of state transition may be mixed.

Here, a case where change in the configuration of the action environment is represented by having a distribution as to observation probability is a case where multiple observation values are observed in a certain state. Also, a case where change in the configuration of the action environment is represented by having the structure configuration of state transition is a case where state transition to different states is caused due to the same action (in the case that a certain action is performed, state transition from the current state to a certain state may be performed, or state transition to a different state as to the state thereof may be performed).

According to the one-state one-observation-value constraint, with the expanded HMM, change in the configuration of the action environment is represented only by having the branching structure of state transition.

Note that in the case that the configuration of the action environment is not changed, learning of the expanded HMM can be performed without imposing the one-state one-observation-value constraint. The one-state one-observation-value constraint can be imposed by introducing division of a state, further preferably, merge (integration) of states to learning of the expanded HMM.

### Division of State

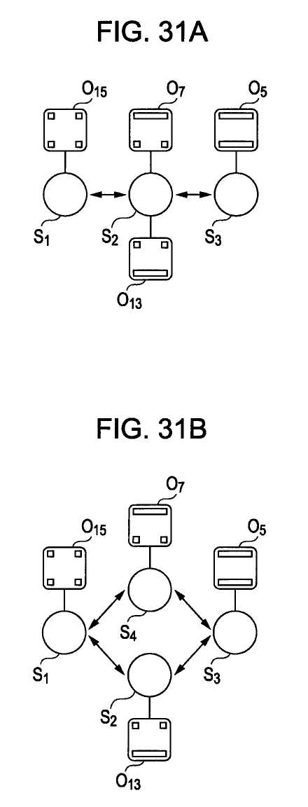

FIGS. 31A and 31B are diagrams for describing the outline of division of a state for realizing the one-state one-observation-value constraint. With division of a state, according to the Baum-Welch re-estimation method, in the case that, with the expanded HMM wherein the state transition probability aᵢⱼ(Uₘ) and the observation probability bᵢ(Oₖ) are converged, multiple observation values are observed in one state, the state is divided into multiple states of which the number is the same number of the multiple observation values so that each of the multiple observation values is observed in one state.

FIG. 31A illustrates (a portion of) the expanded HMM immediately after the model parameters are converged by the Baum-Welch re-estimation method. In FIG. 31A, the expanded HMM includes three states S₁, S₂, and S₃, wherein state transition can be performed between the states S₁ and S₂, and between the states S₂ and S₃.

Further, in FIG. 31A, an arrangement is made wherein one observation value O₁₅ is observed in the state S₁, two observation values O₇ and O₁₃ are observed in the state S₂, and one observation value O₅ is observed in the state S₃, respectively.

In FIG. 31A, the multiple two observation values O₇ and O₁₃ are observed in the state S₂, and accordingly, the state S₂ is divided into two states of which the number is the same as with the two observation values O₇ and O₁₃.

FIG. 31B illustrates (a portion of) the expanded HMM after division of a state. In FIG. 31B, the state S₂ before division in FIG. 31A is divided into two of the state S₂ after division, and a state S₄ that is one of the states (e.g., a state in which all of state transition probability and observation probability are set to (deemed to be) 0.0) that are invalid with the expanded HMM immediately after the model parameters are converged.

Further, in FIG. 31B, in the state S₂ after division, only the observation value O₁₃ that is one of the two observation values O₇ and O₁₃ observed in the state S₂ before division is observed, and in the state S₄ after division, only the observation value O₇ that is one of the two observation values O₇ and O₁₃ observed in the state S₂ before division is observed.

Also, in FIG. 31B, with regard to the state S₂ after division, in the same way as with the state S₂ before division, state transition may mutually be performed between the states S₁ and S₃. With regard to the state S₄ after division as well, in the same way as with the state S₂ before division, state transition may mutually be performed between the states S₁ and S₃.

At the time of division of a state, the learning unit 21 (FIG. 4) first detects a state in which multiple observation values are observed as the state which is the object of dividing with the expanded HMM after learning (immediately after the model parameters are converged).

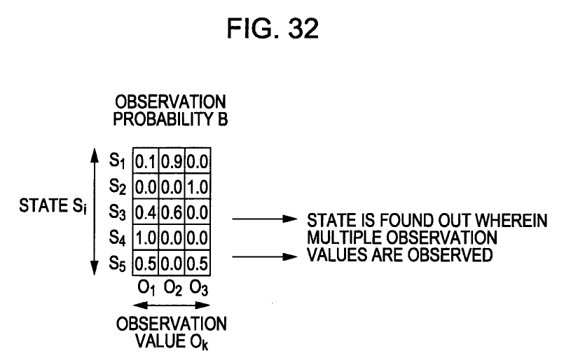

FIG. 32 is a diagram for describing a method for detecting a state which is the object of dividing. Specifically, FIG. 32 illustrates the observation probability matrix B of the expanded HMM.

The observation probability matrix B is, as described in FIG. 16, a matrix with the observation probability bᵢ(Oₖ) for observing the observation value Oₖ as an element of the i'th row and the k'th column in the state Sᵢ.

With regard to learning of (the HMM including) the expanded HMM, with the observation probability matrix B, in a certain state Sᵢ, each of the observation probability bᵢ(O₁) through bᵢ(Oₖ) for observing the observation values O₁ through Oₖ is normalized so that the sum of the observation probability bᵢ(O₁) through bᵢ(Oₖ) becomes 1.0.

Accordingly, in the case that one observation value (alone) is observed in one state Sᵢ, the maximum value of the observation probability bᵢ(O₁) through bᵢ(Oₖ) of the state Sᵢ thereof is deemed to be 1.0, and the observation probability other than the maximum value is deemed to be 0.0.

On the other hand, in the case that multiple observation values are observed in one state Sᵢ, the maximum value of the observation probability bᵢ(O₁) through bᵢ(Oₖ) of the state Sᵢ thereof is, such as 0.6 or 0.5 shown in FIG. 32, sufficiently smaller than 1.0, and also greater than a value (average value) 1/K in the case of evenly dividing the observation probability of which the sum is 1.0 by the number K of the observation values O₁ through Oₖ.

Accordingly, the state which is the object of dividing may be detected by searching the observation probability Bᵢₖ=bᵢ(Oₖ) that is smaller than the threshold bₘₐₓ_{_{—}}ₜₕ smaller than 1.0, and also greater than the average 1/K regarding each state Sᵢ in accordance with Expression (20)

$${arg find}_{k , i = S} ( 1 / K < {B}_{ik} < {b}_{max\_th} ) \qquad ( 20 )$$

where Bᵢₖ represents the element at the i'th row and the k'th column of the observation probability matrix B, and is equal to the observation probability bᵢ(Oₖ) for observing the observation value Oₖ in the state Sᵢ.

Also, in Expression (20), arg find(1/K<Bᵢₖ<bₘₐₓ_{_{—}}ₜₕ) represents, in the case that suffix i of the state Sᵢ is S, the suffixes k of all of the observation probability B_{Sk} satisfying the conditional expression 1/K<Bᵢₖ<bₘₐₓ_{_{—}}ₜₕ within parentheses when observation probability B_{Sk} satisfying the conditional expression 1/K<Bᵢₖ<bₘₐₓ_{_{—}}ₜₕ within parentheses can be searched (found).

Note that, in Expression (20), the threshold b be adjusted in a range of 1/K<bₘₐₓ_{_{—}}ₜₕ<1.0 according to which level detection sensitivity of the state which is the object of dividing is set to, wherein the closer the threshold bₘₐₓ_{_{—}}ₜₕ is set to 1.0, the more sensitively the state which is the object of dividing can be detected.

The learning unit 21 (FIG. 4) detects a state in which the suffix i is S when the observation probability B_{Sk} satisfying the conditional expression 1/K<Bᵢₖ<bₘₐₓ_{_{—}}ₜₕ within parentheses in Expression (20) can be searched (found), as the state which is the object of dividing.

Further, the learning unit 21 detects the observation values Oₖ of the all of the suffixes k represented with Expression (20) as multiple observation values observed in the state which is the object of dividing (state in which the suffix i is S).

Subsequently, the learning unit 21 divides the state which is the object of dividing into multiple states of which the number is the same as the number of the multiple observation values observed in the state which is the object of dividing thereof.

Now, if we say that states after the state which is the object of dividing is divided will be referred to as post-division states, the state which is the object of dividing may be employed as one of the post-division states, and a state that is not valid with the expanded HMM at the time of division may be employed as the remaining post-division states.

Specifically, for example, in the case that the state which is the object of dividing is divided into three post-division states, the state which is the object of dividing may be employed as one of the three post-division states, and a state that is not valid with the expanded HMM at the time of division may be employed as the remaining two states.

Also, a state that is not valid with the expanded HMM at the time of division may be employed as all of the multiple post-division states. However, in this case, the state which is the object of dividing has to be set to an invalid state after state division.

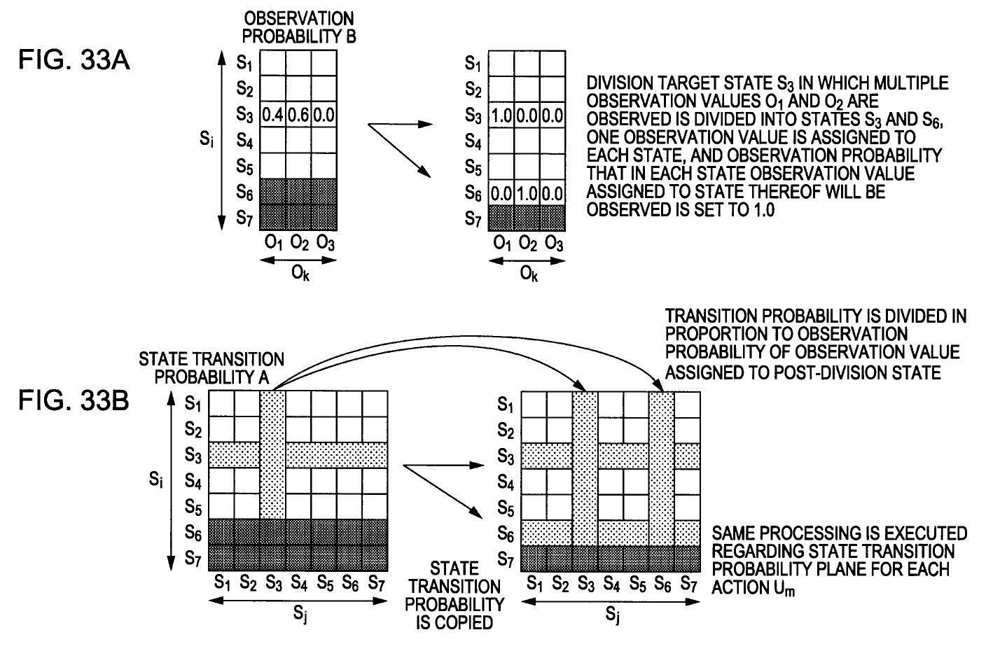

FIGS. 33A and 33B are diagrams for describing a method for dividing the state which is the object of dividing into post-division states. In FIGS. 33A and 33B, the expanded HMM includes seven states S₁ through S₇ of which the two states S₆ and S₇ are invalid states.

Further, in FIGS. 33A and 33B, the state S₃ is taken as the state which is the object of dividing in which two observation values O₁ and O₂ are observed, and the state S₃ which is the object of dividing is divided into a post-division state S₃ in which the observation value O₁ is observed, and a post-division state S₆ in which the observation value O₂ is observed.

The learning unit 21 (FIG. 4) divides the state S₃ which is the object of dividing into the two post-division states S₃ and S₆ as follows.

Specifically, the learning unit 21 assigns, for example, the observation value O₁ that is one observation value of the multiple observation values O₁ and O₂ to the post-division state S₃ divided from the state S₃ which is the object of dividing, and in the post-division state S₃, observation probability wherein the observation value O₁ assigned to the post-division state S₃ thereof is observed is set to 1.0, and also observation probability wherein the other observation values are observed is set to 0.0.

Further, the learning unit 21 sets the state transition probability a₃ⱼ(Uₘ) of state transition with the post-division state S₃ as the transition source to the state transition probability a₃ⱼ(Uₘ) of state transition with the state S₃ which is the object of dividing as the transition source, and also sets the state transition probability of state transition with the post-division state S₃ as the transition source to a value obtained by correcting the state transition probability of state transition with the state S₃ which is the object of dividing as the transition source by observation probability in the state S₃ which is the object of dividing, of the observation value assigned to the post-division state S₃.

The learning unit 21 also sets observation probability and state transition probability regarding the other post-division state S₆.

FIG. 33A is a diagram for describing the settings of the observation probability of the post-division states S₃ and S₆. In FIGS. 33A and 33B, the observation value O₁ that is one of the two observation values O₁ and O₂ observed in the state S₃ which is the object of dividing is assigned to the post-division state S₃ that is one of the two post-division states S₃ and S₆ obtained by dividing the state S₃ which is the object of dividing, and the other observation value O₂ is assigned to the other post-division state S₆.

In this case, such as shown in FIG. 33A, the learning unit 21 sets, in the post-division state S₃ to which the observation value O₁ is assigned, observation probability wherein the observation value O₁ thereof is observed to 1.0, and also sets observation probability wherein the other observation values are observed to 0.0.

Further, such as shown in FIG. 33A, the learning unit 21 sets, in the post-division state S₆ to which the observation value O₂ is assigned, observation probability wherein the observation value O₂ thereof is observed to 1.0, and also sets observation probability wherein the other observation values are observed to 0.0.

The settings of the above observation probability are represented with Expression (21)

B(S₃,:)=0.0

B(S₃,O₁)=1.0

B(S₆,:)=0.0

B(S₆,O₂)=1.0 (21)

where B(,) is a two-dimensional matrix, and the element B(S, O) of the matrix represents, in the state S, observation probability wherein the observation value O is observed.

Also, a matrix of which the suffix is a colon (:) represents all of the elements of the dimension represented with the colon thereof. Accordingly, in Expression (21), for example, Expression B(S₃,;)=0.0 represents that in the state S₃, all of the observation probability wherein each of the observation values O₁ through Oₖ is observed are set to 0.0.

According to Expression (21), in the state S₃, all of the observation probability wherein each of the observation values O₁ through Oₖ is observed are set to 0.0 (B(S₃,;)=0.0), and thereafter, only the observation probability wherein the observation value O₁ is observed is set to 1.0 (B(S₃, O₁)=1.0).

Further, according to Expression (21), in the state S₆, all of the observation probability wherein each of the observation values O₁ through Oₖ is observed are set to 0.0 (B(S₆,;)=0.0), and thereafter, only the observation probability wherein the observation value O₂ is observed is set to 1.0 (B(S₆, O₂)=1.0).

FIG. 33B is a diagram for describing the settings of the state transition probability of the post-division states S₃ and S₆. As for state transition with each of the post-division states S₃ and S₆ as the transition source, the same state transition as the state transition with the state S₃ which is the object of dividing as the transition source has to be performed.

Therefore, such as shown in FIG. 33B, the learning unit 21 sets the state transition probability of state transition with the post-division state S₃ as the transition source to the state transition probability of state transition with the state S₃ which is the object of dividing as the transition source. Further, such as shown in FIG. 33B, the learning unit 21 also sets the state transition probability of state transition with the post-division state S₆ as the transition source to the state transition probability of state transition with the state S₃ which is the object of dividing as the transition source.

On the other hand, as for state transition with each of the post-division state S₃ to which the observation value O₁ is assigned, and the post-division state S₆ to which the observation value O₂ is assigned, state transition has to be performed, such as state transition obtained by dividing state transition with the state S₃ which is the object of dividing as the transition destination by the percentage (ratio) of observation probability that each of the observation values O₁ and O₂ is observed in the state S₃ which is the object of dividing thereof.

Therefore, such as shown in FIG. 33B, the learning unit 21 multiplies the state transition probability of state transition with the state S₃ which is the object of dividing as the transition destination by the observation probability in the state S₃ which is the object of dividing, of the observation value O₁ assigned to the post-division state S₃, thereby correcting the state transition probability of the state transition with the state S₃ which is the object of dividing as the transition destination to obtain a corrected value serving the correction result of the state transition probability being corrected by the observation probability of the observation value O₁.

Subsequently, the learning unit 21 sets the state transition probability of state transition with the post-division state S₃ to which the observation value O₁ is assigned as the transition destination, to the corrected value serving the correction result of the state transition probability being corrected by the observation probability of the observation value O₁.

Further, such as shown in FIG. 33B, the learning unit 21 multiplies the state transition probability of state transition with the state S₃ which is the object of dividing as the transition destination by the observation probability in the state S₃ which is the object of dividing, of the observation value O₂ assigned to the post-division state Sₛ, thereby correcting the state transition probability of the state transition with the state S₃ which is the object of dividing as the transition destination to obtain a corrected value serving the correction result of the state transition probability being corrected by the observation probability of the observation value O₂.

Subsequently, the learning unit 21 sets the state transition probability of state transition with the post-division state S₆ to which the observation value O₂ is assigned as the transition destination, to the corrected value serving the correction result of the state transition probability being corrected by the observation probability of the observation value O₂.

The settings of the state transition probabilities such as described above are represented with Expression (22)

A(S₃,:,:)=A(S₃,:,:)

A(S₆,:,:)=A(S₃,:,:)

A(:,S₃,:)=B(S₃,O₁)A(:,S₃,:)

A(:,S₆,:)=B(S₃,O₂)A(:,S₃,:) (22)

where A(,,) is a three-dimensional matrix, wherein an element A(S, S′, U) of the matrix represents state transition probability that state transition to a state S′ will be performed with a state S as the transition source.

Also, a matrix including a suffix that is a colon (:) represents, in the same way as with the case of Expression (21), all of the elements of the dimension represented with the colon thereof.

Accordingly, in Expression (22), for example, A(S₃,;,;) represents, in the case that each action has been performed, all of the state transition probability of state transition to each state S with the state S₃ as the transition source. Also, in Expression (22), for example, A(:,S₃,;) represents, in the case that each action has been performed, all of the state transition probability of state transition from each state S to the state S₃ with the state S₃ as the transition destination.

According to Expression (22), regarding all actions, the state transition probability of state transition with the post-division state S₃ as the transition source is set to the state transition probability of state transition with the state S₃ which is the object of dividing as the transition source (A(S₃,;,;)=A(S₃,;,;)).

Also, regarding all actions, the state transition probability of state transition with the post-division state S₆ as the transition source is also set to the state transition probability of state transition with the state S₃ which is the object of dividing as the transition source (A(S₆,;,;)=A(S₃,;,;)).

Further, according to Expression (22), regarding all actions, the state transition probability A(:,S₃,;) of state transition with the post-division state S₃ as the transition destination is multiplied by observation probability B(S₃, O₁) in the state S₃ which is the object of dividing, of the observation value O₁ assigned to the post-division state S₃, and accordingly, a corrected value B(S₃, O₁) A(:,S₃,;) is obtained, which is a correction result of the state transition probability A(:,S₃,;) of state transition with the state S₃, which is the object of dividing, as the transition destination.

Subsequently, regarding all actions, the state transition probability A(:,S₃,;) of state transition with the post-division state S₆ to which the observation value O₂ is assigned as the transition destination is set to the corrected value B(S₃, O₁) A(:,S₃,;) (A(:,S₃,;)=B(S₃, O₁) A(:,S₃,;)).

Also, according to Expression (22), regarding all actions, the state transition probability A(:,S₃,;) of state transition with the state S₃, which is the object of dividing, as the transition destination is multiplied by observation probability B(S₃, O₂) in the state S₃ which is the object of dividing, of the observation value O₂ assigned to the post-division state S₆, and accordingly, a corrected value B(S₃, O₂) A(:,S₃,;) is obtained, which is a correction result of the state transition probability A(:,S₃,;) of state transition with the state S₃, which is the object of dividing, as the transition destination.

Subsequently, regarding all actions, the state transition probability A(:,S₆,;) of state transition with the post-division state S₆ to which the observation value O₂ is assigned as the transition destination is set to the corrected value B(S₃, O₂) A(:,S₃,;) (A(:,S₆,;)=B(S₃, O₂) A(:,S₃,;)).

### Merging of States

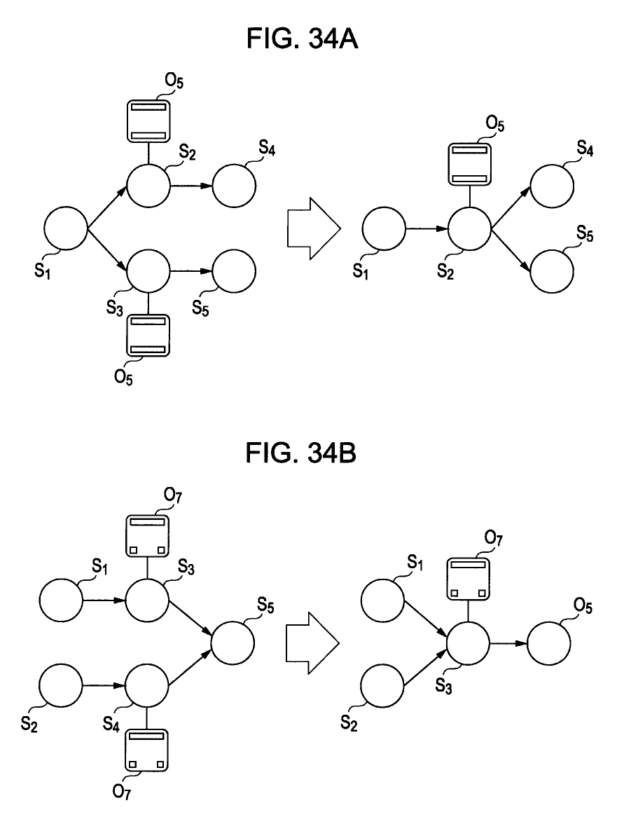

FIGS. 34A and 34B are diagrams illustrating an overview of state merging for realizing the one-state one-value constraint. With state merging, in an expanded HMM with converged model parameters due to Baum-Welch re-estimation, in the event that there are multiple states (different states) as transition destination states of state transition with regarding to a certain action having been performed, with a single state as the transition source, and there are states in the multiple states in which the same observation value is observed, the multiple states regarding with the same observation value is observed, are merged into one state.

Also, with state merging, in an expanded HMM with converged model parameters, in the event that there are multiple states as transition source states of state transition with regarding to a certain action having been performed, with a single state as the transition destination, and there are states in the multiple states in which the same observation value is observed, the multiple states regarding with the same observation value is observed, are merged into one state.

That is to say with state merging, in an expanded HMM with converged model parameters, in the event that there are multiple states regarding which state transition occurs in which the same state is the transition source or the transition destination with regard to each action, and also the same observation value is observed, such multiple states are redundant and accordingly are merged into one state.

Now, state merging includes forward merging where, in the event that there are multiple states as states at the transition destination of state transition from a single state at which an action was performed, the multiple states at the transition destination are merged, and backward merging where, in the event that there are multiple states at which an action was performed as states at the transition source of state transition to multiple states, the multiple states at the transition source are merged.

FIG. 34A illustrates an example of forward merging. In FIG. 34A, the expanded HMM has states S₁ through S₅, enabling state transition from state S₁ to states S₂ and S₃, state transition from state S₂ to state S₄, and state transition from state S₃ to state S₅. Further, the state transitions from state Sᵢ of which the transition destinations are the multiple states S₂ and S₃, i.e., the state transition from state Sᵢ of which the transition destination is state S₂, and the state transition from state Sᵢ of which the transition destination is state S₃, are performed in the event that the same action is performed at state S₁. Moreover, the same observation value O₅ is observed at both states S₂ and S₃.

In this case, the learning unit 21 (FIG. 4) takes the multiple states S₂ and S₃ which are transition destinations of state transition from the single state Sᵢ and at which the same observation value O₅ is observed, as states which are the object of merging, and merge the states S₂ and S₃ which are the object of merging into one state.

Now, the one state obtained by merging the multiple states which are the object of merging will also be referred to as a “representative state”. In FIG. 34A, the two states S₂ and S₃ which are the object of merging are merged into one representative state S₂.

Also, when a certain action is performed, multiple state transitions occurring from a certain state to states where the same observation value is observed appears to be branching from the one transition source state to the multiple transition destination states, so such state transition is also referred to as forward-direction branching. In FIG. 34A, the state transitions from state S_{i to state S}₂ and state S₃ are forward-direction branching. Note that in forward-direction branching, the branching source state is the transition source state S₁ and the branching destination states are the transition destination states S₂ and S₃ where the same observation value is observed. The branching destination states S₂ and S₃ which are also transition destination states are the states which are the object of merging.

FIG. 34B illustrates an example of backward merging. In FIG. 34B, the expanded HMM has states S₁ through S₅, enabling state transition from state S₁ to state S₃, state transition from state S₂ to state S₄, state transition from state S₃ to state S₅, and state transition from state S₄ to state S₅. Further, the state transitions to state S₅ of which the transition sources are the multiple states S₃ and S₄, i.e., the state transition to state S₅ from state S₃, of which the transition source is S₃, and the state transition to state S₅ of which the transition source is S₄, are performed in the event that the same action is performed at states S₃ and S₄. Moreover, the same observation value O₇ is observed at both states S₃ and S₄.

In this case, the learning unit 21 (FIG. 4) takes the multiple states S₃ and S₄ which are transition sources of state transition to the single state S₅ and at which the same observation value O₇ is observed, due to the same action being performed, as states which are the object of merging, and merge the states S₃ and S₄ which are the object of merging into one representative state. In FIG. 34B, state S₃, which is one of the states S₃ and S₄ which are the object of merging, is the representative state.

Also, state transitions occurring from multiple states where the same observation value is observed and with the same state as the transition destination in the event that a certain action is performed, appear to be branching from the one transition destination state to the multiple transition source states, so such state transition is also referred to as backward-direction branching. In FIG. 34B, the state transitions to state S₅ from state S₃ and state S₄ are backward-direction branching. Note that in backward-direction branching, the branching source state is the transition destination state S₅ and the branching destination states are the transition source states S₃ and S₄ where the same observation value is observed. The branching destination states S₃ and S₄ which are also transition source states are the states which are the object of merging.

At the time of state merging, the learning unit 21 (FIG. 4) first detects, in an expanded HMM after learning (immediately after model parameters have converged), multiple states which are branching destination states, as states which are the object of merging.

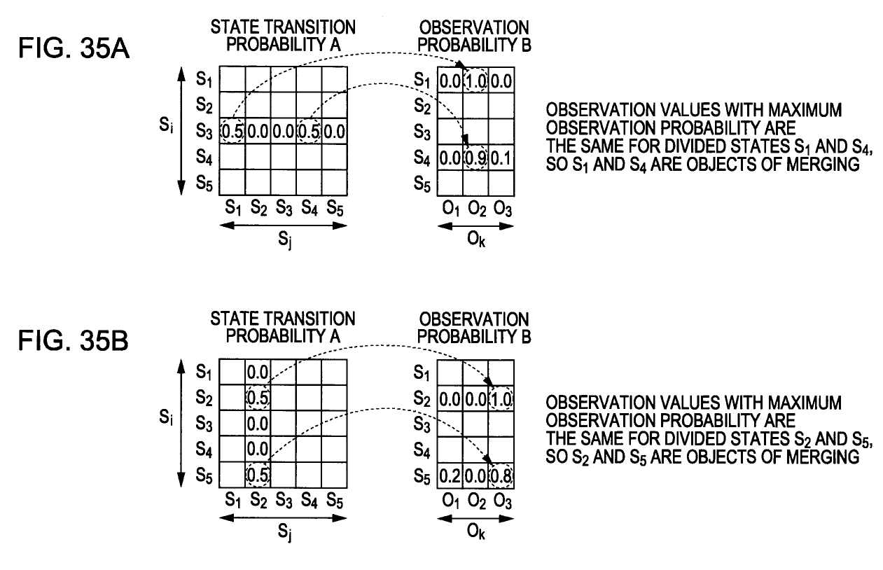

FIGS. 35A and 35B are diagrams for describing a method for detecting states which are the object of merging. The learning unit 21 detects, as states which are the object of merging, multiple states in an expanded HMM which are transition sources or transition destinations of state transition in the event that a predetermined action is performed, in which observation values of maximum observation probability observed at each of the multiple states match.

FIG. 35A illustrates a method for detecting multiple states which are the branching destination of forward-direction branching, as states which are the object of merging. That is to say, FIG. 35A illustrates a state transition probability plane A and observation probability matrix B regarding a certain action Uₘ.

With the state transition probability plane A regarding each action Uₘ, the state transition probability has been normalized with regard to each state Sᵢ such that the summation of state transition probabilities aᵢⱼ(Uₘ) of which the states Sᵢ are the transition source (the summation of aᵢⱼ(Uₘ) wherein the suffixes i and m are fixed and the suffix j is changed from 1 through N) is 1.0. Accordingly, the maximum value of the state transition probabilities of which the states Sᵢ are the transition source with regard to the certain action Uₘ (state transition probabilities arrayed in the horizontal direction on a certain row i on the state transition probability plane A regarding the action Uₘ) is 1.0 (or a value which can be deemed to be 1.0) in the event that there is no forward-direction branching of which the states Sᵢ are the transition source, and the state transition probabilities other than the maximum value are 0.0 (or a value which can be deemed to be 0.0).

On the other hand, the maximum value of a state transition probability of which a certain state Sᵢ is the transition source with regard to a certain action Uₘ, in the event that there is a forward-direction branching with the state Sᵢ serving as the branching source, is sufficiently smaller than 1.0, as can be seen from 0.5 shown in FIG. 35A, with a summation greater than the value 1/N obtained by uniformly dividing the state transition probability among the number N of states S₁ through S_{N} (average value).

Accordingly, a state which is the branching source of forward-direction branching can be detected by searching for a state Sᵢ of which the maximum value of state transition probability aᵢⱼ(Uₘ) (i.e., Aᵢⱼₘ) at row i on the state transition probability plane with regard to the action Uₘ is smaller than a threshold aₘₐₓ_{_{—}}ₜₕ which is smaller than 1.0, and also is greater than the average value 1/N, following Expression (19) in the same way as detecting the branching structure states described above.

Note that in this case, in Expression (19), the threshold aₘₐₓ_{_{—}}ₜₕ can be adjusted within the range of 1/N<aₘₐₓ_{_{—}}ₜₕ<1.0, depending on the degree of the sensitivity of detection of the state which is the branching source of forward-direction branching, and the closer the threshold aₘₐₓ_{_{—}}ₜₕ is set to 1.0, the higher the sensitivity of detection of the state which is the branching source will be.

Upon detecting a state which is the branching source in the forward direction branching (hereinafter, also referred to as “branching source state”) as described above, the learning unit 21 (FIG. 4) detects multiple states which are the branching destinations of forward-direction branching from the branching source state. That is to say, the learning unit 21 detects multiple states which are the branching destinations of forward-direction branching from the branching source state, following Expression (23), where the suffix m of the action Uₘ is U and the suffix i of the branching destination states Sᵢ of the forward-direction branching is S.

$${arg find}_{j , i = S , m = U} ( {a}_{min\_th 1} < {A}_{ijm} ) \qquad ( 23 )$$

Now, in Expression (23), Aᵢⱼₘ represents, on a three-dimensional state transition probability table, the state transition probability aᵢⱼ(Uₘ) which is the i'th position from the top in the i-axial direction, the j'th position from the left in the j-axial direction, and the m'th position from the near side in the action axial direction.

Also, in Expression (23), argfind(aₘᵢₙ_{_{—}}ₜₕ₁<Aᵢⱼₘ) represents all suffixes j of a state transition probability A_{S,j,U} satisfying the conditional expression aₘᵢₙ_{_{—}}ₜₕ₁<Aᵢⱼₘ in parentheses when the state transition probability A_{S,j,U} satisfying the conditional expression aₘᵢₙ_{_{—}}ₜₕ₁<Aᵢⱼₘ in parentheses has been searched (found) successfully, where the suffix m of the action Uₘ is U and the suffix i of the branching source states Sᵢ is S.

Also note that in Expression (23), the threshold aₘᵢₙ_{_{—}}ₜₕ₁ can be adjusted within the range of 0.0<aₘᵢₙ_{_{—}}ₜₕ₁<1.0 depending on the degree of sensitivity of detection of the multiple states which are the branching destinations of forward-direction branching, and the closer that the threshold aₘᵢₙ_{_{—}}ₜₕ₁ is set to 1.0, the more sensitively the multiple states which are the branching destinations of forward-direction branching can be detected.

The learning unit 21 (FIG. 4) takes a state Sⱼ with the suffix j, when the state transition probability Aᵢⱼₘ satisfying the conditional expression aₘᵢₙ_{_{—}}ₜₕ₁<Aᵢⱼₘ in parentheses in Expression (23) has been searched (found) successfully, as a candidate of a state which is a branching destination of forward-direction branching (also referred to as “branching destination state). Subsequently, in the event that multiple states are detected as candidates for branching destinations of forward-direction branching, the learning unit 21 determines whether or not the maximum observation values of observation probability observed at each of the multiple branching destination state candidates match. The learning unit 21 then takes, of the multiple branching destination state candidates, the candidate of which the observation value with the maximum observation probability matches, as the branching destination state of forward-direction branching.

That is to say, the learning unit 21 obtains the observation value Qₘₐᵣ with the maximum observation probability following Expression (24), for each of the multiple branching destination state candidates.

$${O}_{max} = {arg max}_{k , i = S} ( {B}_{ik} ) \qquad ( 24 )$$

where Bᵢₖ represents the observation probability bᵢ(Oₖ) of observing the observation value Oₖ in the state Sᵢ, and argmax(Bᵢₖ) represents the suffix k of the maximum observation probability B_{S,k} for the state of which the suffix of state Sᵢ is S in the observation probability matrix B.

In the event that the suffix k of the maximum observation probability B_{S,k} obtained by Expression (24), matches the suffixes i of each of the multiple states Sᵢ which are the multiple branching destination state candidates, the learning unit 21 detects those of the multiple branching destination state candidates matching the suffix k obtained by Expression (24) as branching destination states of forward-direction branching.

Now, in FIG. 35A, the state S₃ has been detected as a branching source state of forward-direction branching, and states S₁ and S₄, which both have a state transition probability of state transition from the branching source state S₃ of 0.5, are detected as branching destination state candidates of forward-direction branching. The states S₁ and S₄ which are branching destination state candidates of forward-direction branching have the observation value O₂ of which the observation probability is 1.0 and is maximum, observed in state S₁, and the observation value O₂ of which the observation probability is 0.9 and is maximum, observed in state S₄, that match, so the states S₁ and S₄ are detected as branching destination states of forward-direction branching.

FIG. 35B illustrates a method for detecting multiple states which are branching destinations of backward-direction branching, as states which are the object of merging. That is to say, FIG. 35B illustrates a state transition probability plane A regarding a certain action Uₘ and an observation probability matrix B.

As described with reference to FIG. 35A, with the state transition probability plane A regarding each action Uₘ, for each state Sᵢ, the state transition probability is normalized such that the summation of state transition probabilities aᵢⱼ(Uₘ) with the state Sᵢ as the transition source, is 1.0, but normalization has not been performed such that the summation of state transition probabilities aᵢⱼ(Uₘ) with the state Sᵢ as the transition destination (the summation of aᵢⱼ(Uₘ) with the suffixes j and m fixed and the suffix i changed from 1 through N) is 1.0.

Note, however, that in the event that there is the possibility of state transition from state Sᵢ to state Sᵢ, the state transition probability aᵢⱼ(Uₘ) with the state Sᵢ as the transition destination thereof is a positive value which is not 0.0 (or a value which can be deemed to be 0.0). Accordingly, a state which can be a branching state of backward-direction branching, and branching destination state candidates, can be detected following Expression (25).

$${arg find}_{i , j = S , m = U} ( {a}_{min\_th 2} < {A}_{ijm} ) \qquad ( 25 )$$

Now, in Expression (25), Aᵢⱼₘ represents, on a three-dimensional state transition probability table, the state transition probability aᵢⱼ(Uₘ) which is the i'th position from the top in the i-axial direction, the j'th position from the left in the j-axial direction, and the m'th position from the near side in the action axial direction.

Also, in Expression (25), argfind(aₘᵢₙ_{_{—}}ₜₕ₂<Aᵢⱼₘ) represents all suffixes i of a state transition probability A_{i,S,U} satisfying the conditional expression aₘᵢₙ_{_{—}}ₜₕ₂<Aᵢⱼₘ in parentheses when the state transition probability A_{i,S,U} satisfying the conditional expression aₘᵢₙ_{_{—}}ₜₕ₂<Aᵢⱼₘ in parentheses has been searched (found) successfully, where the suffix m of the action Uₘ is U and the suffix j of the branching destination states Sⱼ is S.

Also note that in Expression (25), the threshold aₘᵢₙ_{_{—}}ₜₕ₂ can be adjusted within the range of 0.0<aₘᵢₙ_{_{—}}ₜₕ₂<1.0 depending on the degree of sensitivity of detection of the branching source state of backward-direction branching and branching destination state candidates, and the closer that the threshold aₘᵢₙ_{_{—}}ₜₕ₂ is set to 1.0, the more sensitively the detection of the branching source state of backward-direction branching and branching destination state candidates can be detected.

The learning unit 21 (FIG. 4) takes a state S with the suffix j, when multiple state transition probabilities Aᵢⱼₘ satisfying the conditional expression aₘᵢₙ_{_{—}}ₜₕ₂<Aᵢⱼₘₘ in parentheses in Expression (25) have been searched (found) successfully, as a state which can be a branching source state of backward-direction branching. Further, the learning unit 21 detects, as branching destination state candidates, multiple states which are transition sources of state transition corresponding to multiple state transition probabilities Aᵢⱼₘ in the event that multiple state transition probabilities Aᵢⱼₘ satisfying the conditional expression aₘᵢₙ_{_{—}}ₜₕ₂<Aᵢⱼₘ in the parentheses in Expression (25) have been searched for successfully, i.e., multiple states Sᵢ having as suffixes thereof each i in the multiple state transition probabilities A_{i,S,U} satisfying the conditional expression aₘᵢₙ_{_{—}}ₜₕ₂<Aᵢⱼₘ in the parentheses in the event that multiple state transition probabilities A_{i,S,U} satisfying the conditional expression aₘᵢₙ_{_{—}}ₜₕ₂<Aᵢⱼₘ have been searched for successfully.

Subsequently, the learning unit 21 determines whether or not the observation values with the maximum observation probability observed at each of the multiple branching destination state candidates of backward-direction branching match. In the same way as when detecting the branching destination states of forward-direction branching, the learning unit 21 detects, of the multiple branching destination state candidates, candidates wherein the observation values with the maximum observation probability match, as branching destination states of backward-direction branching.

Now, in FIG. 35B, the state S₂ has been detected as a branching source state of backward-direction branching, and states S₂ and S₅, which both have a state transition probability of state transition to the branching source state S₂ of 0.5, are detected as branching destination state candidates of backward-direction branching. The states S₂ and S₅ which are branching destination state candidates of backward-direction branching have the observation value O₃ of which the observation probability is 1.0 and is maximum, observed in state S₂, and the observation value O₃ of which the observation probability is 0.8 and is maximum, observed in state S₅, that match, so the states S₂ and S₅ are detected as branching destination states of backward-direction branching.

Upon thus detecting a branching source state for forward-direction and backward-direction branching, and multiple branching destination states branching from the branching destination states, the learning unit 21 merges the multiple branching destination states into one representative state.

Here, the learning unit 21 takes, of the multiple branching destination states, a branching destination state with the smallest suffix for example, as the representative state, and merges the multiple branching destination states into the representative state. That is to say, in the event that three states have been detected as multiple branching destination states branching from a certain branching source state, the learning unit 21 takes the branching destination state with the smallest suffix thereof as the representative state, and merges the multiple branching destination states into the representative state.

Also, the learning unit 21 sets the remaining two states of the three branching destination states that were not taken as the representative state to an invalid state. Note that for merging of states, a representative state may be selected from invalid states rather than branching destination state. In this case, following multiple branching destination states being merged into the representative state, all of the multiple branching destination states are set to invalid.

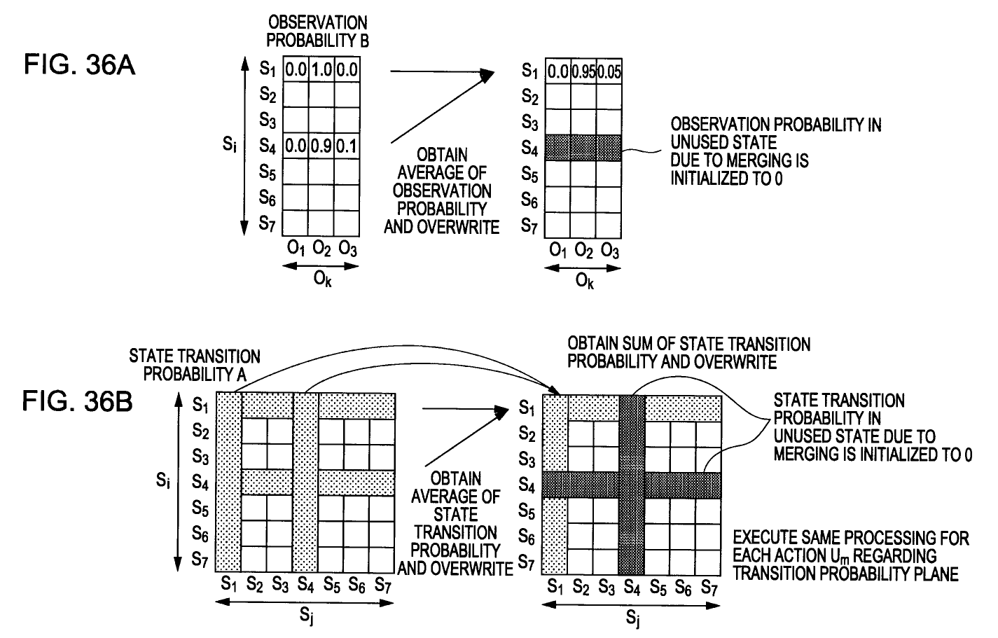

FIGS. 36A and 36B are diagrams for describing a method for merging multiple branching destination states branching from a certain branching source state into one representative state. In FIGS. 36A and 36B, the expanded HMM has seven states S₁ through S₇. Further, in FIGS. 36A and 36B, two states S₁ and S₄ are states which are the object of merging, with the two states S₁ and S₄ which are the object of merging being merged into one representative state S₁, taking the state S₁ having the smaller suffix of the two states S₁ and S₄ which are the object of merging as the representative state.

The learning unit 21 (FIG. 4) merges the two states S₁ and S₄ which are the object of merging into the one representative state S₁ as follows. That is to say, the learning unit 21 sets the observation probability b₁(Oₖ) that each observation value Oₖ will be observed at the representative state S₁ to the average value of the observation probabilities b₁(Oₖ) and b₄(Oₖ) that each observation value Oₖ will be observed at the representative states S₁ and S₄ which are multiple states that are the object of merging, and also sets the observation probability b₄(Oₖ) that each observation value Oₖ will be observed at the state S₄ which is that other than the representative state S₁ of the states S₁ and S₄ which are multiple states that are the object of merging.

Also, the learning unit 21 sets the state transition probability a_{1,m}(Uₘ) of state transition with the representative state S₁ as the transition source thereof, to the average value of transition probabilities a_{1,j}(Uₘ) and a_{4,j}(Uₘ) of state transition with the multiple states S₁ and S₄ each as the transition source thereof, and sets the state transition probability a_{1,j}(Uₘ) of state transition with the representative state S₁ as the transition destination thereof, to the sum of transition probabilities a_{i,1}(Uₘ) and a_{i,4}(Uₘ) of state transition with the multiple states S₁ and S₄ each as the transition destination thereof.

Further, the learning unit 21 the state transition probability a_{4,j}(Uₘ) of state transition of which the state S₄, which is that other than the representative state S₁ of the states S₁ and S₄ which are multiple states that are the object of merging, is the transition source thereof, and the state transition probability a_{i,4}(Uₘ) of state transition of which the state S₄ is the transition destination thereof, to 0.

FIG. 36A is a diagram for describing setting of observation probability performed for state merging. The learning unit 21 sets the observation probability b₁(O₁) that the observation value O₁ will be observed at the representative state S₁ to the average value (b₁(O₁) b₄(O₁))/2 of the observation probabilities b₁(O₁) and b₄(O₁) that the observation value O₁ will be observed at each of the states S₁ and S₄ which are the object of merging. The learning unit 21 also sets the observation probability b₁(Oₖ) that another observation value Oₖ will be observed at the representative state S₁ in the same way.

Further, the learning unit 21 also sets the observation probability b₄(Oₖ) that each observation value Oₖ will be observed at the state S₄, which is that other than the representative state Sᵢ of the states Sᵢ of the states Sᵢ and S₄ which are states that are the object of merging, to 0. Such setting of observation probability can be expressed as shown in Expression (26).

B(S₁,:)=(B(S₁,:)+B(S₄,:))/2

B(S₄,:)=0.0 (26)

where B(,) is a two-dimensional matrix, and the element B (S, O) of the matrix represents the observation probability that an observation value O will be observed in a state S.

Also, matrixes where the suffix is written as a colon (:) represent all elements of the dimensions for that colon. Accordingly, in Expression (26), the equation B(S₄,;)=0.0 for example means that all observation probabilities that each of the observation values will be observed in state S₄ are set to 0.0.

According to Expression (26), the observation probability bᵢ(Oₖ) that each observation value Oₖ will be observed at the representative state S₁, is set to the average value (B(S₁,:)=(B(S₁,:)+B(S₄,:))/2) of the observation probabilities b₁(Oₖ) and b₄(Oₖ) that each observation value Oₖ will be observed at each of the states S₁ and S₄ which are the object of merging. Further, in Expression (26), the observation probability b₄(Oₖ) that each observation value Oₖ will be observed at the state S₄, which is that other than the representative state S₁ of the states S₁ and S₄ which are states that are the object of merging, is set to 0.

FIG. 36B is a diagram for describing setting of state transition probability performed in state merging. State transitions with each of multiple states which are the object of merging as the transition source do not universally match. A state transition of which the transition source is a representative state obtained by merging states which are the object of merging, should be capable of state transition with each of the multiple states which are the object of merging as the transition source. Accordingly, as shown in FIG. 36B, the learning unit 21 sets the state transition probability a_{1,j}(Uₘ) of state transition with the representative state S₁ as the transition source to the average value of the state transition probabilities a_{1,j}(Uₘ) and a_{4,j}(Uₘ) of state transition with the states S₁ and S₄ which are the object of merging as the respective transition sources.

On the other hand, state transitions with each of multiple states which are the object of merging as the transition destination do not universally match. A state transition of which the transition destination is a representative state obtained by merging states which are the object of merging, should be capable of state transition with each of the multiple states which are the object of merging as the transition destination. Accordingly, as shown in FIG. 36B, the learning unit 21 sets the state transition probability a_{i,1}(Uₘ) of state transition with the representative state S₁ as the transition destination to the sum of the state transition probabilities a_{i,1}(Uₘ) and a_{i,4}(U.) of state transition with the states S₁ and S₄ which are the object of merging as the respective transition destinations.

Note that the reason why the sum of the state transition probabilities a_{i,1}(Uₘ) and a_{i,4}(Uₘ) of state transition with the states S₁ and S₄ which are the object of merging as the respective transition destinations is employed for the state transition probability a_{i,1}(Uₘ) of state transition with the representative state S₁ as the transition destination, as opposed to the average value of the state transition probabilities a_{1,j}(Uₘ) and a_{4,j}(Uₘ) of state transition with the states S₁ and S₄ which are the object of merging as the respective transition sources being employed for the state transition probability a_{1,j}(Uₘ) of state transition with the representative state S₁ as the transition source, is that the state transition probability aᵢⱼ(Uₘ) has been normalized at the state transition probability plane A regarding each action Uₘ such that the summation of state transition probability aᵢⱼ(Uₘ) with the state S₁ as the transition source is 1.0, while normalization has not been performed such that the state transition probability aᵢⱼ(Uₘ) with the state Sⱼ as the transition destination is 1.0.

Besides setting the state transition probability of which the transition source is the representative step S₁ and the state transition probability of which the transition destination is the representative step S₁, the learning unit 21 sets the state transition probability that the state S₄, which is the object of merging (state which is the object of merging other than the representative state) that is no longer indispensable in expression of the structure of the action environment due to the states S₁ and S₄ which are the object of merging being merged into the representative state S₁, will be the transition source, and the state transition probability of being the transition destination, to 0. Such setting of state transition probability is expressed as shown in Expression (27).

A(S₁,:,:)=(A(S₁,:,:)+A(S₄,:,:))/2

A(:,S₁,:)=A(:,S₁,:)+A(:,S₄,:)

A(S₄,:,:)=0.0

A(:,S₄,:)=0.0 (27)

In Expression (27), A(,,) represents a three-dimensional matrix, and the element A(S,S′,U) of the matrix represents the state transition probability of state transition to state S′ with state S as the transition source in the event that an action U is performed. Also, in the same way as with Expression (26), matrixes where the suffix is written as a colon (:) represent all elements of the dimensions for that colon.

Accordingly, in Expression (27), A(S₁,:,:) for example, represents the state transition probability of state transition to each state with the transition source as state S₁ in the event that each action is performed. Also, in Expression (27), A(:,S₁,:) for example represents all state transition probabilities of transition from each state to step S₁ with the state S₁ as the transition destination in the event that each action is performed.

Also, in Expression (27), the state transition probability of transition with the representation state S₁ as the transition source for all actions is set to the average value of the state transition probabilities a_{1,j}(Uₘ) and a_{4,j}(Uₘ) of state transition with the states S₁ and S₄ which are the object of merging as the transition source, i.e., A(S₁,:,:)=(A(S₁,:,:)+A(S₄,:,:))/2. Further, the state transition probability of state transition with the representation state S₁ as the transition destination for all actions is set to the sum value of the state transition probabilities a_{i,1}(Uₘ) and a_{i,4}(Uₘ) of state transition with the states S₁ and S₄ which are the object of merging as the transition destinations, i.e., A(:,S₁,:)=A(:,S₁,:)+A(:,S₄,:).

Moreover, in Expression (27), the state transition probability that the state S₄, which is the object of merging that is no longer indispensable in expression of the structure of the action environment due to the states S₁ and S₄ which are the object of merging being merged into the representative state S₁, will be the transition source, and the state transition probability of being the transition destination, for all actions, is set to 0, i.e., A(S₄,:,:)=0.0,A(:,S₄,:)=0.0.

As described above, by setting to 0.0 the state transition probability that the state S₄, which is the object of merging that is no longer indispensable in expression of the structure of the action environment due to the states S₁ and S₄ which are the object of merging being merged into the representative state S₁, will be the transition source, and the state transition probability of being the transition destination, and setting to 0.0 the observation probability that each observation value will be observed at the state S₄, which is the object of merging that is no longer indispensable, the state S₄, which is the object of merging and is no longer indispensable thus becomes a state which is not valid.

Expanded HMM Learning Under One-state one-observation-value Constraint

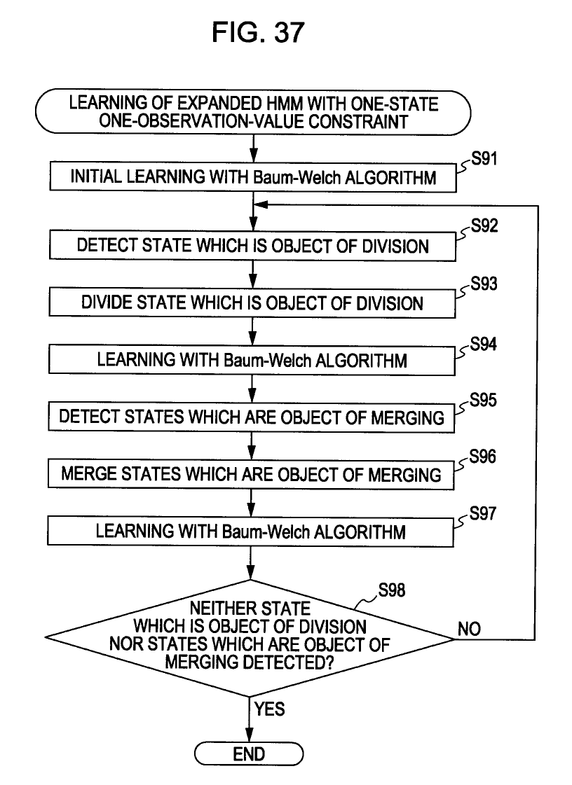

FIG. 37 is a flowchart for describing processing of expanded HMM learning which the learning unit 21 shown in FIG. 4 performs under the one-state one-observation-value constraint.

In step S91, the learning unit 21 performs initial learning for expanded HMM following Baum-Welch re-estimation, using the observation value series and action series serving as learning data stored in the history storage unit 14, i.e., performs processing the same as with steps S21 through S24 in FIG. 7. Upon the model parameters of the expanded HMM converging in the initial learning in step S91, the learning unit 21 stores the model parameters of the expanded HMM in the model storage unit 22 (FIG. 4), and the processing proceeds to step S92.

In step S92, the learning unit 21 detects states which are the object of dividing from the expanded HMM stored in the model storage unit 22, and the processing proceeds to step S93. However, in the event that the learning unit 21 does not detect any states which are the object of dividing in step S92, i.e., in the event that there are no states which are the object of dividing in the expanded HMM stored in the model storage unit 22, the processing skips steps S93 and S94, and proceeds to step S95.

In step S93, the learning unit 21 performs state dividing for dividing the state which is the object of dividing that has been detected in step S92 into multiple post-dividing states, and the processing proceeds to step S94.

In step S94, the learning unit 21 performs learning for the expanded HMM stored in the model storage unit 22 regarding which state dividing has been performed in the immediately-preceding step S93 following Baum-Welch re-estimation, using the observation value series and action series serving as learning data stored in the history storage unit 14, i.e., performs processing the same as with steps S22 through S24 in FIG. 7. Note that with the learning in step S94 (as well as the later-described step S97), the model parameters of the expanded HMM stored in the model storage unit 22 are used as initial values of model parameters as they are. Upon the model parameters of the expanded HMM converging in the learning in step S94, the learning unit 21 stores (overwrites) the model parameters of the expanded HMM in the model storage unit 22 (FIG. 4), and the processing proceeds to step S95.

In step S95, the learning unit 21 detects states which are the object of merging from the expanded HMM stored in the model storage unit 22, and the processing proceeds to step S96. However, in the event that the learning unit 21 does not detect any states which are the object of merging in step S95, i.e., in the event that there are no states which are the object of merging in the expanded HMM stored in the model storage unit 22, the processing skips steps S96 and S97, and proceeds to step S98.

In step S96, the learning unit 21 performs merging of states where the states which are the object of merging that have been detected in step S95 into a representative state, and the processing proceeds to step S97.

In step S97, the learning unit 21 performs learning for the expanded HMM stored in the model storage unit 22 regarding which state merging has been performed in the immediately-preceding step S96 following Baum-Welch re-estimation, using the observation value series and action series serving as learning data stored in the history storage unit 14, i.e., performs processing the same as with steps S22 through S24 in FIG. 7. Upon the model parameters of the expanded HMM converging in the learning in step S97, the learning unit 21 stores (overwrites) the model parameters of the expanded HMM in the model storage unit 22 (FIG. 4), and the processing proceeds to step S98.

In step S98, the learning unit 21 determines whether or not no state which is the object of dividing has been detected in the processing in step S92 immediately before, for detecting states which are the object of dividing, and further, whether or not no states which are the object of merging has been detected in the processing in the immediately preceding step S95 for detecting states which are the object of merging. In the event that either a state which is the object of dividing or states which are the object of merging are detected in step S98, the processing returns to step S92, and the same processing is repeated thereafter. On the other hand, in the event that neither a state which is the object of dividing nor states which are the object of merging are detected in step S98, the processing for expanded HMM learning ends.

As described above, state dividing, expanded HMM learning after state dividing, stage merging, and expanded HMM learning after state merging, are repeated until neither a state which is the object of dividing nor states which are the object of merging are detected, whereby learning which satisfies the one-state one-observation-value constraint is performed, and an expanded HMM wherein one and only one observation value is observed in one state can be obtained.

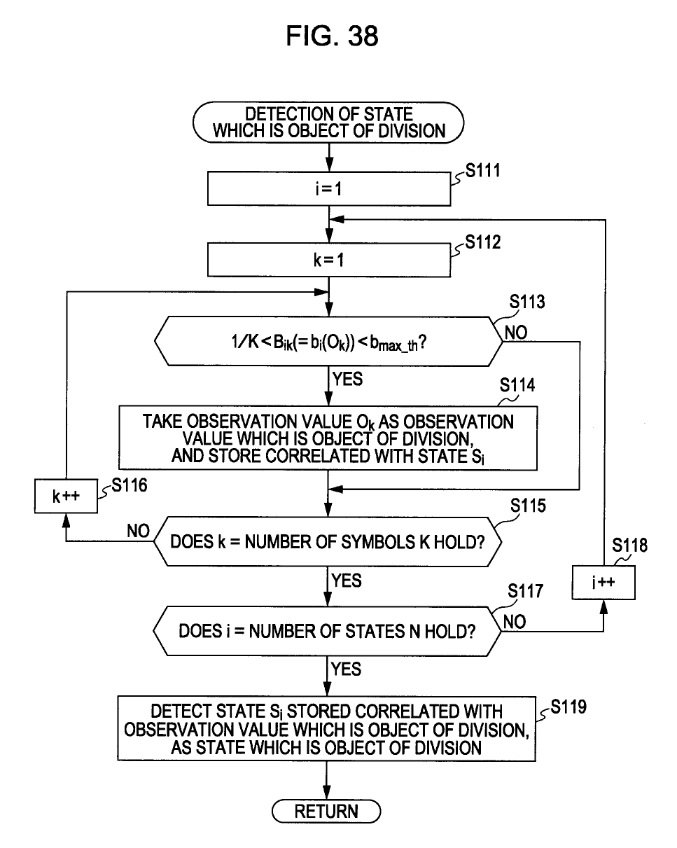

FIG. 38 is a flowchart for describing processing for detecting a state which is the object of dividing, which the learning unit 21 shown in FIG. 4 performs in step S92 in FIG. 37.

In step S111, the learning unit 21 initializes the variable i which represents the suffix of the state Sᵢ to 1 for example, and the processing proceeds to step S112.

In step S112, the learning unit 21 initializes the variable k which represents the suffix of the observation value Oₖ to 1 for example, and the processing proceeds to step S113.

In step S113, the learning unit 21 determines whether or not the observation probability Bᵢₖ=bᵢ(Oₖ) that the observation value Oₖ will be observed in the state Sᵢ satisfies the conditional expression 1/K<Bᵢₖ<bₘₐₓ_{_{—}}ₜₕ in the parentheses in Expression (20). In the event that determination is made in step S113 that the observation probability Bₗₖ=bᵢ(Oₖ) does not satisfy the conditional expression 1/K<Bᵢₖ<bₘₐₓ_{_{—}}ₜₕ, the processing skips step S114 and proceeds to step S115.

On the other hand, in the event that determination is made in step S113 that the observation probability Bᵢₖ=bᵢ(Oₖ) satisfies the conditional expression 1/K<Bᵢₖ<bₘₐₓ_{_{—}}ₜₕ, the processing proceeds to step S114, where the learning unit 21 takes the observation value Oₖ as an observation value which is the object of dividing (an observation value to be assigned one apiece to states following dividing), correlates with the state Sᵢ, and temporarily stores in unshown memory.

Subsequently, the processing proceeds from step S114 to step S115, where determination is made regarding whether or not the suffix k is equal to the number K of observed values (hereinafter also referred to as “number of symbols”). In the event that determination is made in step S115 that the suffix k is not equal to the number of symbols K, the processing proceeds to step S116, and the learning unit 21 increments the suffix k by 1. The processing then returns from step S116 to step S113, and thereafter the same processing is repeated.

Also, in the event that determination is made in step S115 that the suffix k is equal to the number of symbols K, the processing proceeds to step S117, where determination is made regarding whether or not the suffix i is equal to the number of states N (the number of states of the expanded HMM).

In the event that determination is made in step S117 that the suffix i is not equal to the number of states N, the processing proceeds to step S118, and the learning unit 21 increments the suffix i by 1. The processing returns from step S118 to step S112, and thereafter the same processing is repeated.

In the event that determination is made in step S117 that the suffix i is equal to the number of states N, the processing proceeds to step S119, and the learning unit 21 detects each of the states Sᵢ stored in step S114 correlated with the observation values which are the object of dividing, as states which are the object of dividing, and the processing returns.

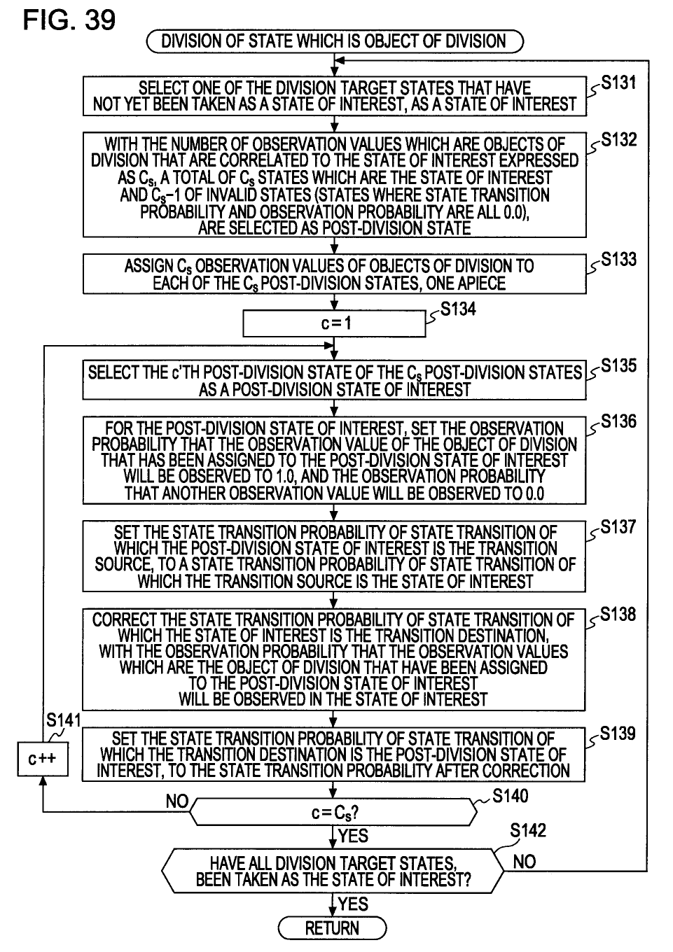

FIG. 39 is a flowchart for describing processing of dividing states (dividing of states which are the object of dividing) which the learning unit 21 (FIG. 4) performs in step S93 in FIG. 37.

In step S131, the learning unit 21 selects one state of the states which are the object of dividing that has not been taken as a state of interest yet, as the state of interest, and the processing proceeds to step S132.

In step S132, the learning unit 21 takes the number of observation values which are the object of dividing that are correlated to the state of interest, as the number of post-division states of the state of interest (hereinafter also referred to as “number of divisions”) Cₛ, and selects, from the states of the expanded HMM, the state of interest, and C_{S}−1 states from states which are not valid, for a total of C_{S} states, as post-division states.

Subsequently, the processing proceeds from step S132 to step S133, where the learning unit 21 assigns one apiece of the C_{S} observation values which are the object of dividing, that have been correlated to the state of interest, to each of the C_{S} post-division states, and the processing proceeds to step S134.

In step S134, the learning unit 21 initializes the variable c to count the C_{S} post-division states to 1 for example, and the processing proceeds to step S135.

In step S135, the learning unit 21 selects, of the C_{S} post-division states, the c'th post-division state as the post-division state of interest, and the processing proceeds to step S136.

In step S136, the learning unit 21 sets the observation probability that the observation value which is the object of dividing that has been assigned to the post-division state of interest to 1.0, for the post-division state of interest, sets the observation probability that another observation value will be observed to 0.0, and the processing proceeds to step S137.

In step S137, the learning unit 21 sets the state transition probability of state transition with the post-division state of interest as the transition source to the state transition probability of state transition with the state of interest as the transition source, and the processing proceeds to step S138.

As described with FIG. 33, in step S137, the learning unit 21 corrects the state transition probability of state transition with the state of interest as the transition source thereof, using the observation probability that the observation value of the state which is the object of dividing, assigned to the state following dividing of interest, will be observed at the state of interest, and obtains a correction value for the state transition probability, and the processing proceeds to step S139.

In step S139, the learning unit 21 sets the state transition probability of state transition with the state following dividing of interest as the transition destination, to the correction value obtained in the immediately preceding step S138, and the processing proceeds to step S140.

In step S140, the learning unit 21 determines whether or not the variable c is equal to the number of divisions C_{S}. In the event that determination is made in step S140 that the variable c is not equal to the number of divisions C_{S}, the processing proceeds to step S141 where the learning unit 21 increments the variable c by 1, and the processing returns to step S135.

Also, in the event that determination is made in step S140 that the variable c is equal to the number of divisions C_{S}, the processing proceeds to step S142, where the learning unit 21 determines whether all of the states which are the object of dividing have been selected as the state of interest. In the event that determination is made in step S142 that all of the states which are the object of dividing have not yet been selected as the state of interest, the processing returns to step S131, and thereafter the same processing is repeated. On the other hand, in the event that determination is made in step S142 that all of the states which are the object of dividing have been selected as the state of interest, i.e., in the event that dividing of all of the states which are the object of dividing has been completed, the processing returns.

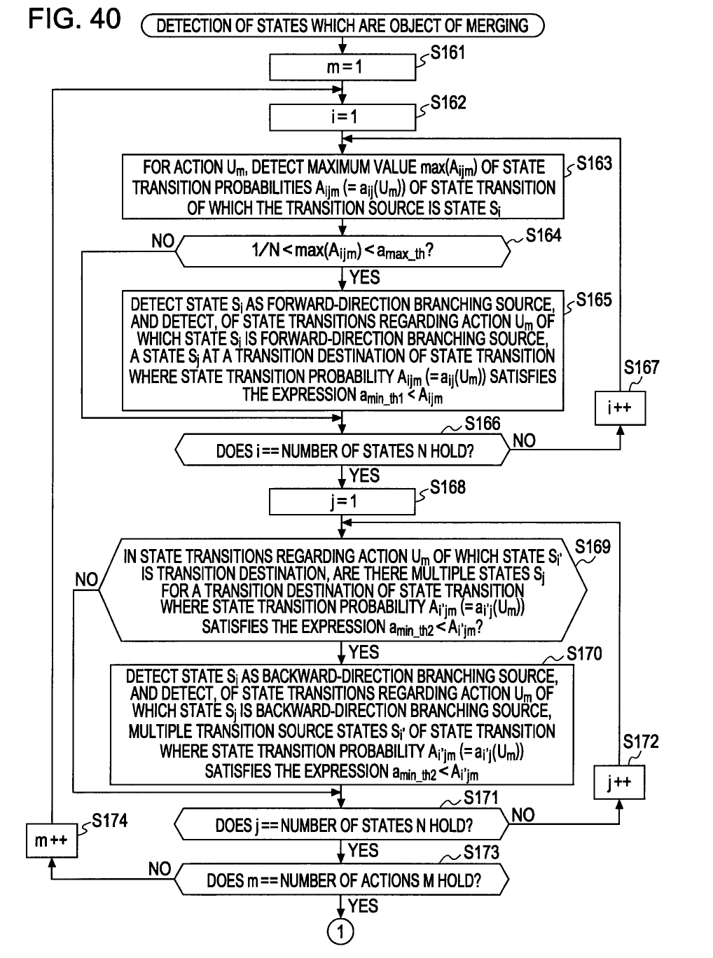

FIG. 40 is a flowchart for describing processing for detecting states which are the object of merging, which the learning unit 21 shown in FIG. 4 performs in step S95 of FIG. 37.

In step S161, the learning unit 21 initializes the variable m which represents the suffix of action Uₘ to 1 for example, and the processing proceeds to step S162.

In step S162, the learning unit 21 initializes the variable i which represents the suffix of the state Sᵢ to 1 for example, and the processing proceeds to step S163. In step S163, the learning unit 21 detects the maximum value max(Aᵢⱼₘ) of the state transition probabilities Aᵢⱼₘ=aᵢⱼ(Uₘ) of state transition to the states Sⱼ with the state Sᵢ as the transition source, for an action Uₘ in the expanded HMM stored in the model storage unit 22, and the processing proceeds to step S164.

In step S164, the learning unit 21 determines whether or not the maximum value max(Aᵢⱼₘ) satisfies Expression (19), i.e., whether or not 1/N<max(Aᵢⱼₘ)<aₘₐₓ_{_{—}}ₜₕ is satisfied.

In the event that determination is made in step S164 that the maximum value max(Aᵢⱼₘ) does not satisfy Expression (19), the processing skips step S165, and proceeds to step S166.

Also, in the event that determination is made in step S164 that the maximum value max(Aᵢⱼₘ) satisfies Expression (19), the processing proceeds to step S165, and the learning unit 21 detects the state Sᵢ as a branching source state for forward-direction branching.

Further, out of the state transitions with the state Sᵢ as a branching source state for forward-direction branching regarding the action Uₘ, the learning unit 21 detects a state Sⱼ which is the transition destination of state transition where the state transition probability Aᵢⱼₘ, =aᵢⱼ(Uₘ) satisfies the conditional expression aₘᵢₙ_{_{—}}ₜₕ₁<Aᵢⱼₘ within the parentheses in Expression (23) as the branching destination state of forward-direction branching, and the processing proceeds from step S165 to step S166.

In step S166, the learning unit 21 determines whether or not the suffix i is equal to the number of states N. In the event that determination is made in step S166 that the suffix i is not equal to the number of states N, the processing proceeds to step S167, where the learning unit 21 increments the suffix i by 1, and the processing returns to step S163. On the other hand, in the event that determination is made in step S166 that the suffix i is equal to the number of states N, the processing proceeds to step S168, where the learning unit 21 initializes the variable j representing the suffix of the state Sⱼ to 1 for example, and the processing proceeds to step S169.

In step S169, the learning unit 21 determines whether or not there exist, in the state transitions from the states S_{i′} with the state Sⱼ as the transition destination thereof for the action Uₘ, multiple transition source states S_{i′} with state transition where the state transition probability T_{i′jm}=_{i′j}(Uₘ) satisfies the conditional expression aₘᵢₙ_{_{—}}ₜₕ₂<A_{i′jm} within the parentheses in Expression (25).

In the event that determination is made in step S169 that there are not multiple transition source states S_{i′} with state transition where satisfying the conditional expression aₘᵢₙ_{_{—}}ₜₕ₂<_{i′jm} within the parentheses in Expression (25), the processing skips step S170 and proceeds to step S171. In the event that determination is made in step S169 that there exist multiple transition source states S_{i′}, with state transition satisfying the conditional expression aₘᵢₙ_{_{—}}ₜₕ₂<A_{i′jm} within the parentheses in Expression (25), the processing proceeds to step S170, and the learning unit 21 detects the state Sⱼ as a branching source state for backward-direction branching.

Further, the learning unit 21 detects, from the state transitions from the states S_{i′} with the state Sⱼ which is the branching source for backward-direction branching for the action Uₘ as the transition destination thereof multiple transition source states S_{i′} with state transition where the state transition probability A_{i′jm}=a_{i′j}(Uₘ) satisfies the conditional expression aₘᵢₙ_{_{—}}ₜₕ₂<A_{i′jm} within the parentheses in Expression (25), as branching destination states for backward-direction branching, and the processing proceeds from step S170 to step S171.

In step S171, the learning unit 21 determines whether or not the suffix j is equal to the number of states N. In the event that determination is made in step S171 that the suffix j is not equal to the number of states N, the processing proceeds to step S172, and the learning unit 21 increments the suffix j by 1 and the processing returns to step S169.

On the other hand, in the event that determination is made in step S171 that the suffix j is equal to the number of states N, the processing proceeds to step S173, and the learning unit 21 determines whether or not the suffix m is equal to the number M of actions Uₘ (hereinafter also referred to as “number of actions”).

In the event that determination is made in step S173 that the suffix m is not equal to the number M of actions, the processing advances to step S174, where the learning unit 21 increments the suffix m by 1, and the processing returns to step S162.

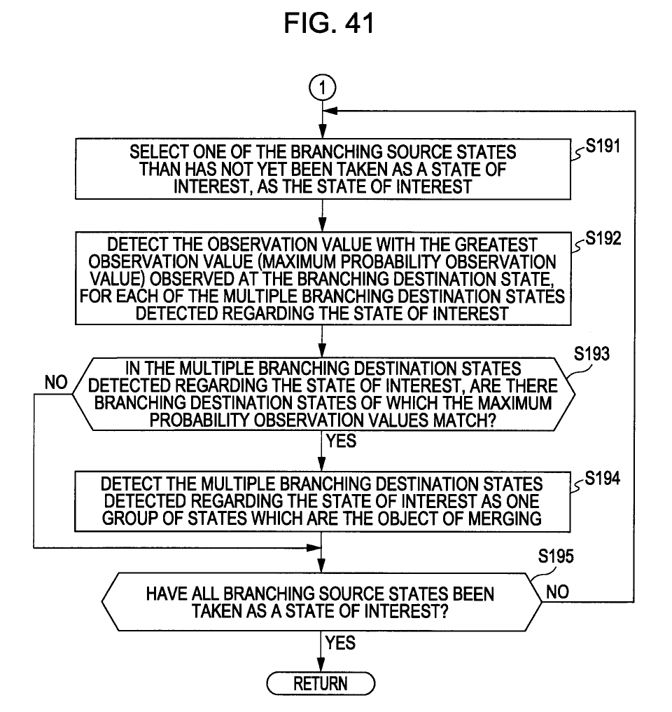

Also, in the event that determination is made in step S173 that the suffix m is equal to the number M of actions, the processing advances to step S191 in FIG. 41, which is a flowchart following after FIG. 40.

In step S191 in FIG. 41, the learning unit 21 selects, from the branching source states detected by the processing in steps S161 through S174 in FIG. 40 but not yet taken as a state of interest, one as the state of interest, and the processing proceeds to step S192.

In step S192, the learning unit 21 detects an observation value Oₘₐₓ of which the observation probability is the greatest (hereinafter also referred to as “maximum probability observation value”) observed as the branching destination states for each of the multiple branching destination state (candidates) detected with regard to the state of interest, i.e., multiple branching destination state (candidates) branching with the state of interest as the branching source thereof, following Expression (24), and the processing proceeds to step S193.

In step S193, the learning unit 21 determines whether or not there are branching destination states in the multiple branching destination states detected with regard to the state of interest, where the maximum probability observation value Oₘₐₓ matches. In the event that determination is made in step S193 that there are no branching destination states in the multiple branching destination states detected with regard to the state of interest, where the maximum probability observation value Oₘₐₓ matches, the processing skips step S194 and proceeds to step S195.

In the event that determination is made in step S193 that there are branching destination states in the multiple branching destination states detected with regard to the state of interest, where the maximum probability observation value Oₘₐₓ matches, the processing proceeds to step S194, and the learning unit 21 detects multiple branching destination states in the multiple branching destination states detected with regard to the state of interest where the maximum probability observation value Oₘₐₓ matches as one group of states which are the object of merging, and the processing proceeds to step S195.

In step S195, the learning unit 21 determines whether or not all branching source states have been selected as the state of interest. In the event that determination is made in step S195 that not all branching source states have been selected as the state of interest yet, the processing returns to step S191. On the other hand, in the event that determination is made in step S195 that all branching source states have been selected as the state of interest, the processing returns.

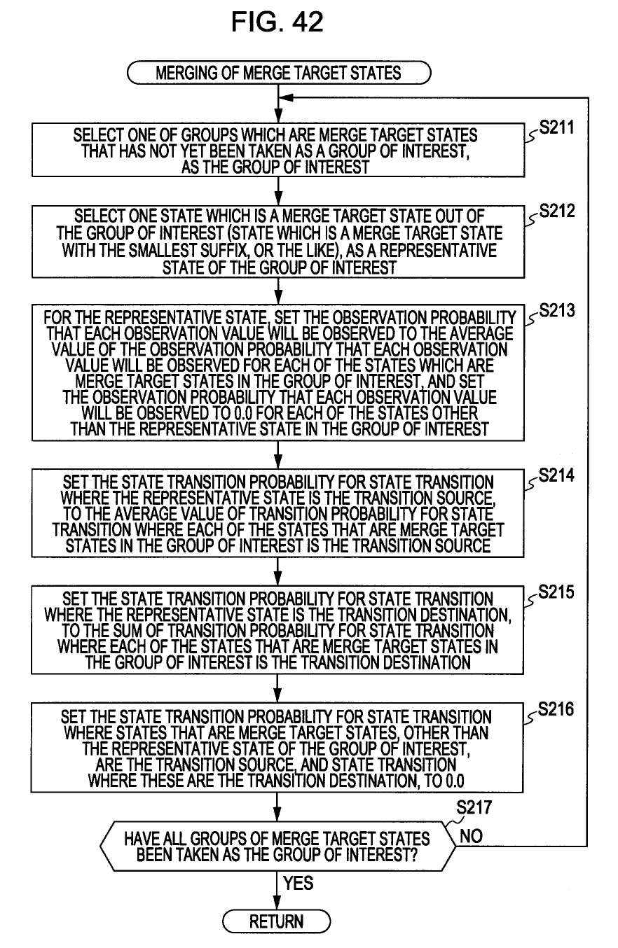

FIG. 42 is a flowchart for describing processing for state merging (merging of states which are the object of merging), which the learning unit 21 in FIG. 4 performs in step S96 of FIG. 37.

In step S211, the learning unit 21 selects, of groups of states which are the object of merging, a group which has not yet been taken as the group of interest, as the group of interest, and the processing proceeds to step S212.

In step S212, the learning unit 21 selects, of the multiple states which are the object of merging in the group of interest, a state which is the object of merging which has the smallest suffix, for example, as the representative state of the group of interest, and the processing proceeds to step S213.

In step S213, the learning unit 21 sets the observation probability that each observation value will be observed in the representative state, to the average value of observation probability that each observation value will be observed in each of the multiple states which are the object of merging in the group of interest.

Further, in step S213, the learning unit 21 sets the observation probability that each observation value will be observed in states which are the object of merging other than the representative state of the group of interest, to 0.0, and the processing proceeds to step S214.

In step S214, the learning unit 21 sets the state transition probability of state transition with the representative state as the transition source thereof, to the average value of state transition probabilities of state transition with each of the states which are the object of merging in the group of interest as the transition source thereof, and the processing proceeds to step S215.

In step S215, the learning unit 21 sets the state transition probability of state transition with the representative state as the transition destination thereof, to the sum of state transition probabilities of state transition with each of the states which are the object of merging in the group of interest as the transition destination thereof, and the processing proceeds to step S216.

In step S216, the learning unit 21 sets the state transition probabilities of state transition with states, which are the object of merging other than the representative state of the group of interest, as the transition source, and state transition with states, which are the object of merging other than the representative state of the group of interest, as the transition destination, to 0.0, and the processing proceeds to step S217.

In step S217, determination is made by the learning unit 21 regarding whether or not all groups which are the object of merging, have been selected as the group of interest. In the event that determination is made in step S217 that not all groups which are the object of merging have been selected as the group of interest, the processing returns to step S211. On the other hand, in the event that determination is made in step S217 that all groups which are the object of merging have been selected as the group of interest, the processing returns.

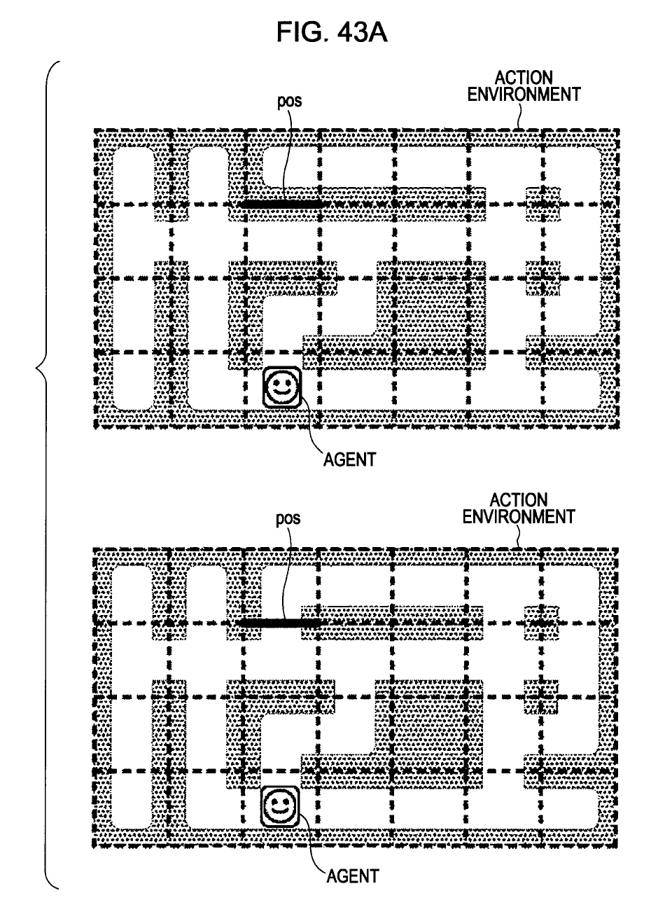

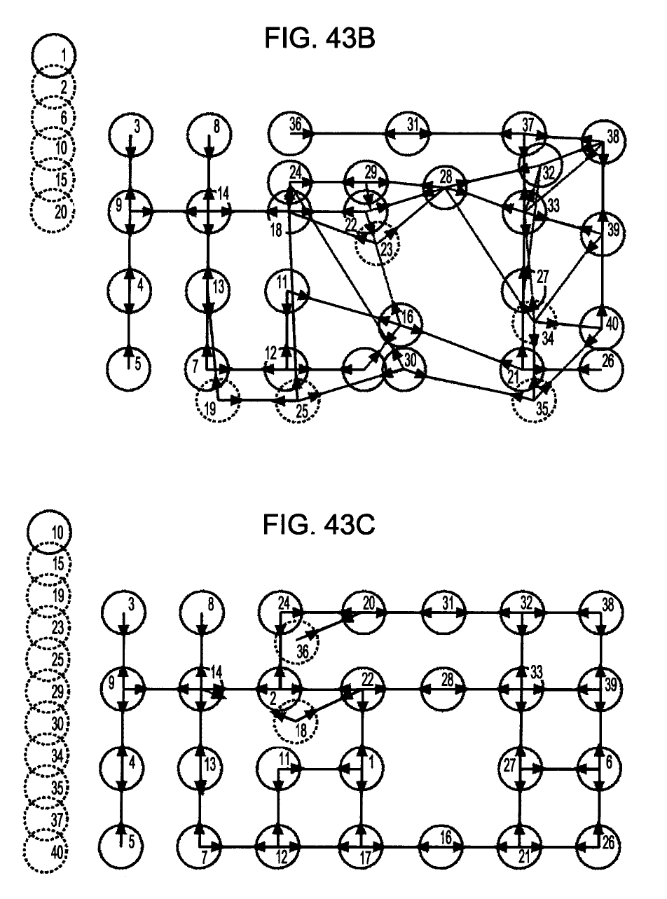

FIGS. 43A through 43C are diagrams for describing a simulation of expanded HMM learning under the one-state one-observation-value constraint, which the Present Inventor carried out. FIG. 43A is a diagram illustrating an action environment employed with a simulation. With the simulation, an environment was selected for the action environment where a configuration is converted into a first configuration and a second configuration.

With the action environment according to the first configuration, a position pos is a wall and is impassable, while with the action environment according to the second configuration, the position pos is a passage and is passable. In the simulation, expanded HMM learning was performed obtaining observation series and action series to serve as learning data in each of the action environments according to the first and second configurations.

FIG. 43B illustrates an expanded HMM obtained as the result of learning performed without the one-state one-observation-value constraint, and FIG. 43C illustrates an expanded HMM obtained as the result of learning performed with the one-state one-observation-value constraint. In FIGS. 43B and 43C, the circles represent the states of the expanded HMM, and the numerals within the circles are the suffixes of the states which the circles represent. Further, the arrows between the states represented as circles represent possible state transitions (state transitions of which the state transition probability can be deemed to be other than 0.0). Also, the circles representing the states arrayed in the vertical direction at the left side of FIGS. 43B and 43C represent states not valid in the expanded HMM.

In the expanded HMM in FIG. 43B, with learning without the one-state one-observation-value constraint, the model parameters become trapped in local minimums with a mixture in the expanded HMM following learning of cases of the first and second configurations of the action environment with a changing configuration being represented by observation probability having distribution, and cases of being represented by having a branching configuration of state transition. Consequently, it can be seen that the configuration of the action environment of which the configuration changes is not being appropriately represented by state transition of the expanded HMM.

On the other hand, in the expanded HMM in FIG. 43C, with learning with the one-state one-observation-value constraint, in the expanded HMM following learning, the first and second configurations of the action environment with a changing configuration are represented only by having a branching configuration of state transition. Consequently, it can be seen that the configuration of the action environment of which the configuration changes is appropriately represented by state transition of the expanded HMM.

In learning with the one-state one-observation-value constraint, in a case wherein the configuration of the action environment changes, the portion of which the configuration does not change is stored in common in the expanded HMM, and the portion of which the configuration changes is expressed in the expanded HMM by a branched structure of state transition (which is to say that there are multiple state transitions to different states for state transitions occurring in a case that a certain action has been performed).

Accordingly, an action environment where the configuration changes can be suitable expressed with a single expanded HMM, rather than preparing models for each structure, so modeling of an action environment where the environment changes can be performed with fewer storage resources.

### Processing for Recognition Action Mode for Determining Action in Accordance With Predetermined Strategy

Now, with the recognition action mode processing in FIG. 8, the current situation of the agent is recognized, a current state which is the state of the expanded HMM corresponding to the current situation, and an action for achieving the target state from the current state is determined, assuming that the agent shown in FIG. 4 is situated at a known region in the action environment (in the event that learning of the expanded HMM has been performed using the observation value series and action series observed at that region, that region (learned region)). However, the agent is not in known regions at all times, and may be in an unknown region (unlearned region).

In the event that the agent is situated in an unknown region, an action determined as described with reference to FIG. 8 may not be a suitable action for achieving the target state; rather, the action may be a wasteful or redundant action wandering through the unknown region.

Now, the agent can determine in the recognition action mode whether the current situation of the agent is an unknown situation (a situation where observation value series and action series which have not been observed so far are being obtained, i.e., a situation not captured by the expanded HMM), or a known situation (a situation where observation value series and action series which have been already observed are being obtained, i.e., a situation captured by the expanded HMM), and an appropriate action can be determined based on the determination results.

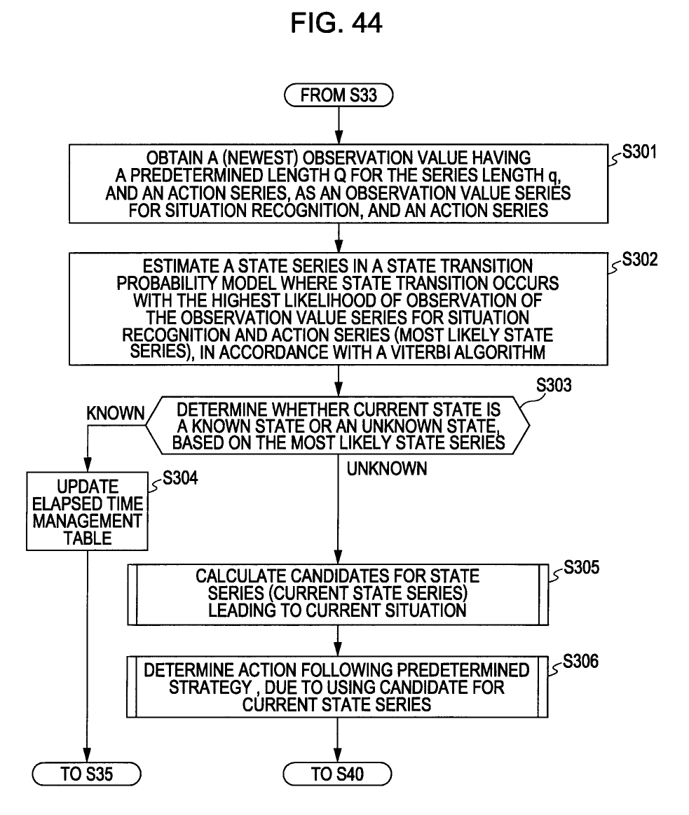

FIG. 44 is a flowchart for describing such recognition action mode processing. With the recognition action mode in FIG. 44, the agent performs processing the same as with steps S31 through S33 in FIG. 8.

Subsequently, the processing advances to step S301, where the state recognizing unit 23 (FIG. 4) of the agent obtains the newest observation value series with a series length (the number of values making up the series) q having a predetermined length Q, and an action series of an action performed when the observation values of that observation value series are observed, by reading these from the history storage unit 14 as a recognition observation value series to be used for recognition of the current situation of the agent, and an action series.

The processing then proceeds from step S301 to step S302, where the state recognizing unit 23 observes the recognition observation value series and action series in the learned expanded HMM stored in the model storage unit 22, and obtains the optimal state probability δₜ(j) which is the maximum value of the state probability of being in state Sⱼ at point-in-time t, and the optimal path ψₜ(j) which is the state series where the optimal state probability δₜ(j) is obtained, following the above-described Expressions (10) and (11), based on the Viterbi algorithm.

Further, the state recognizing unit 23 observes the recognition observation value series and action series, and obtains the most likely state series which is the state series of reaching the state Sⱼ where the optimal state probability δₜ(j) in Expression (10) is maximal at point-in-time t, from the optimal path ψₜ(j) in Expression (11).

Subsequently, the processing advances from step S302 to step S303, where the state recognizing unit 23 determines whether the current situation of the agent is a known situation or an unknown situation, based on the most likely state series.

Here, the recognition observation value series (or the recognition observation value series and action series) will be represented by O, and the most likely state series where the recognition observation value series O and action series is observed will be represented by X. Note that the number of states making up the most likely state series X is equal to the series length q of the recognition observation value series O.

Also, with the point-of-time t at which the first observation value of the recognition observation value series O is observed as 1 for example, the state of the most likely state series X at the point-of-time t will be represented as Xₜ, and the state transition probability of state transition from the state Xₜ at point-in-time t to state Xₜ₊₁ at point-in-time t+1 will be represented as A(Xₜ,Xₜ₊₁). Moreover, the likelihood that the recognition observation value series O will be observed in the most likely state series X will be represented as P(OIX).

In step S303, the state recognizing unit 23 determines whether or not Expressions (28) and (29) are satisfied.

A(Xₜ,Xₜ₊₁)>Thresₜᵣₐₙₛ(0<t<q) (28)

P(O|X)>Thres_{obs} (29)

where Thresₜᵣₐₙₛ in Expression (28) is a threshold value for differentiating between whether or not there can be state transition from state Xₜ to state Xₜ₊₁, and Thres_{obs} in Expression (29) is a threshold value for differentiating between whether or not there can be observation of the recognition observation value series O in the most likely state series X. Values enabling such differentiation to be appropriately performed are set for the thresholds Thresₜᵣₐₙₛ and Thres_{obs} by simulation or the like, for example.

In the event that at least one of Expressions (28) and (29) is not satisfied, the state recognizing unit 23 determines in step S303 that the current situation of the agent is an unknown situation. On the other hand, in the event that both Expressions (28) and (29) are satisfied, the state recognizing unit 23 determines in step S303 that the current situation of the agent is a known situation. In the event that determination is made in step S303 that the current situation of the agent is a known situation, the state recognizing unit 23 obtains (estimates) the last state of the most likely state series X as the current state sₜ, and the processing proceeds to step S304.

In step S304, the state recognizing unit 23 updates the elapsed time management table stored in the elapsed time management table storage unit 32 (FIG. 4) based on the current state sₜ, in the same way as with the case of step S34 in FIG. 8. Thereafter, processing is performed with the agent in the same manner as with step S35 and on in FIG. 8.

On the other hand, in the event that determination is made in step S303 that the current situation of the agent is an unknown situation, the processing proceeds to step S305, where the state recognizing unit 23 calculates one or more candidates of a current state series which is a state series for the agent to reach the current situation, based on the expanded HMM stored in the model storage unit 22. Further, the state recognizing unit 23 supplies the one or more candidates of a current state series to the action determining unit 24 (FIG. 4), and the processing proceeds from step S305 to step S306.

In step S306, the action determining unit 24 uses the one or more candidates of a current state series from the state recognizing unit 23 to determine the action for the agent to perform next, based on a predetermined strategy. Thereafter, processing is performed with the agent in the same manner as with step S40 and on in FIG. 8.

As described above, in the event that the current situation is an unknown situation, the agent calculates one or more candidates of a current state series, and the action of the agent is determined using the one or more candidates of a current state series, following a predetermined strategy. That is to say, in the event that the current situation is an unknown situation, the agent obtains, from state series of state transition occurring at the learned expanded HMM (hereinafter also referred to as “experienced state series”), the newest observation series of a certain series length q, and a state series where an action series is observed, as a candidate for the current state series. The agent then uses (reuses) the current state series which is an experienced state series to determine the action of the agent following the predetermined strategy.

### Calculation of Current State Series Candidates

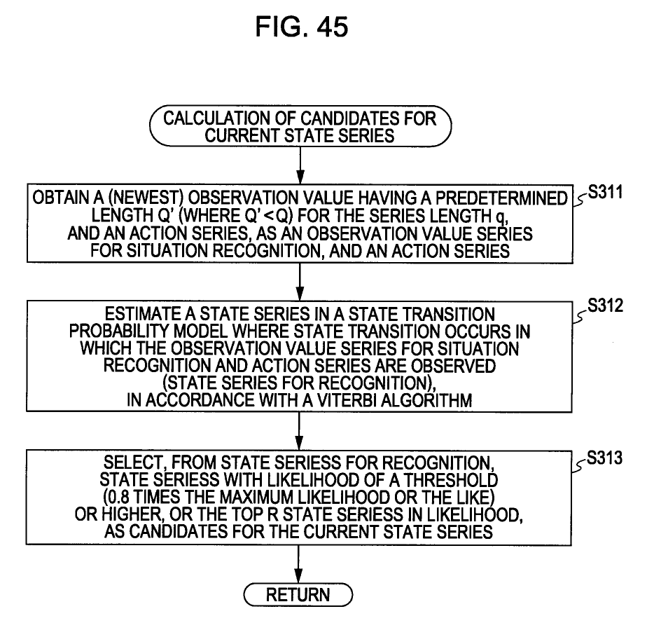

FIG. 45 is a flowchart describing processing for the state recognizing unit 23 to calculate candidates for the current state series, performed in step S305 in FIG. 44.

In step S311, the state recognizing unit 23 obtains the newest observation value series with a series length q of a predetermined length Q′, and the action series of an action performed at the time that each observation value of the observation value series was observed (the newest action series with a series length q of a predetermined length Q′ for an action which the agent has performed, and the observation value series of observation values observed at the agent when the action of that action series was performed), from the history storage unit 14 (FIG. 4), as a recognition observation value series and action series.

Note that the length Q′ for the series length q of the recognition observation value series which the state recognizing unit 23 obtains in step S311 is that which is shorter than the length Q of the series length q of the observation value series obtained in step S301 in FIG. 44, such as 1 or the like, for example.

That is to say, as described above, the agent obtains, from the experienced state series, the newest measurement value series, and a recognition observation value series which is an action series, and a state series where the action series is observed, as candidates for a current state series, but there are cases where the series length q of the recognition observation value series and action series is too long, and as a result, there is no recognition observation value series or action series of such a long series length q in the experienced state series (or the likelihood of such is practically none) in the experienced state series.

Accordingly, in step S311, the state recognizing unit 23 obtains a recognition observation value series and action series with a short series length q, so that the recognition observation value series and state series where the action series is observed, can be obtained from the experienced state series.

Following step S311, the processing proceeds to step S312, where the state recognizing unit 23 observes the recognition observation value series and action series obtained in step S311 at the learned expanded HMM stored in the model storing unit 22, and obtains the optimal state probability δₜ(j) which is the maximum value of the state probability of being at state Sⱼ at point-in-time t, and the optimal path ψₜ(j) which is a state series where the optimal state probability δₜ(j) is obtained, following the above-described Expressions (10) and (11) based on the Viterbi algorithm. That is to say, the state recognizing unit 23 obtains, from the experienced state series, an optimal path ψₜ(i) which is a state series of which the series length q is Q′ in which the recognition observation value series and action series is observed.

Now, a state series which is which is the optimal path ψₜ(j) obtained (estimated) based on the Viterbi algorithm is also called a “recognition state series”. In step S312, an optimal state probability δₑ(j) and recognition state series (optimal path ωₜ(j)) are obtained for each of the N states Sⱼ of the expanded HMM.

In step S312, upon the recognition state series being obtained, the processing proceeds to step S313, where the state recognizing unit 23 selects one or more recognition state series from the recognition state series obtained in step S312, as candidates for current state series, and the processing returns. Note that in step S313, recognition state series with a likelihood, i.e., an optimal state probability δₑ(j) of a threshold (e.g., a value 0.8 times the maximum value (maximum likelihood) of the optimal state probability δₑ(j)) or higher are selected as candidates for current state series. Alternatively, R (where R is an integer of 1 or greater) recognition state series from the top order in optimal state probability δₑ(j) are selected as candidates for current state series.

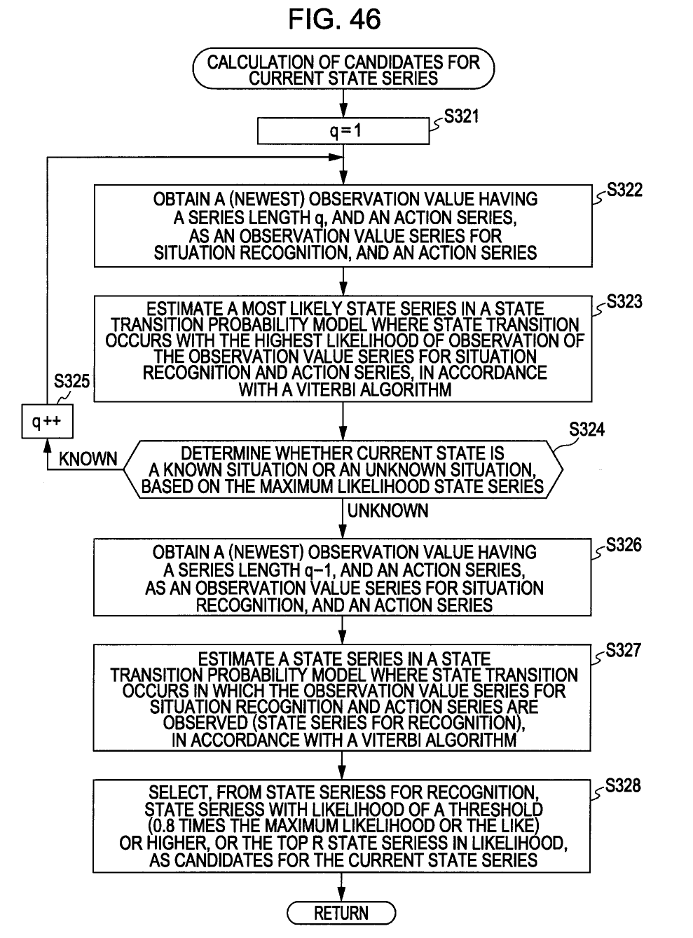

FIG. 46 is a flowchart for describing another example of processing for calculation of candidates for current state series, which the state recognizing unit 23 shown in FIG. 4 performs in step S305 in FIG. 44. With the processing for calculating candidates for current state series in FIG. 45, the series length q of the recognition observation value series and action series is fixed to a short length Q′, so recognition state series of the length Q′, and accordingly candidates for current state series of the length Q′, are obtained.

Conversely, with the processing for calculating candidates for current state series in FIG. 46, the agent autonomously adjusts the series length q of the recognition observation value series and action series, and accordingly, a configuration which is closer to the configuration of the current position of the agent in the action environment configuration which the expanded HMM has captured, i.e., a state series where the recognition observation value series and action series (newest recognition observation value series and action series) are observed, having the longest series length q in the experienced state series, is obtained as a candidate for current state series.

With the processing for calculating candidates for current state series in FIG. 46, in step S321, in step S321, the state recognizing unit 23 (FIG. 4) initializes the series length q to, for example, the smallest value which is 1, and the processing proceeds to step S322.

In step S322, the state recognizing unit 23 reads out the newest observation value series with a series length of q, and an action series of action performed when each observation value of the observation value series is observed, from the history storage unit 14 (FIG. 4), as a recognition observation value series and action series, and the processing proceeds to step S323.

In step S323, the state recognizing unit 23 observes the recognition observation value series with series length of q, and action series, in the learned expanded HMM stored in the model storing unit 22, and obtains the optimal state probability δₜ(j) which is the maximum value of the state probability of being at state Sⱼ at point-in-time t, and the optimal path ψₜ(j) which is a state series where the optimal state probability δₜ(j) is obtained, following the above-described Expressions (10) and (11) based on the Viterbi algorithm.

Further, the state recognizing unit 23 observes the recognition observation value series and the action series, and obtains a most likely state series which is a state series which reaches state S₃ where the optimal state probability δₜ(j) in Expression (10) is greatest at point-in-time t, from the optimal path ψₜ(j) in Expression (11).

Subsequently, the processing proceeds from step S323 to step S324, where the state recognizing unit 23 determines whether the current situation of the agent is a known situation or an unknown situation, based on the most likely state series, in the same way as with the case of step S303 in FIG. 44. In the event that determination is made in step S324 that the current situation is a known situation, i.e., a state series where the recognition observation value series and action series (newest recognition observation value series and action series) are observed, having a series length q, can be obtained from the experienced state series, the processing proceeds to step S325, and the state recognizing unit 23 increments the series length q by 1. The processing then returns from step S325 to step S322, and thereafter, the same processing is repeated.

On the other hand, in the event that determination is made in step S324 that the current situation is an unknown situation, i.e., a state series where the recognition observation value series and action series (newest observation value series and action series) are observed, having a series length q, is not obtainable from the experienced state series, the processing proceeds to step S326, and the state recognizing unit 23 obtains a state series where the recognition observation value series and action series (newest recognition observation value series and action series) are observed, having the longest series length in the experienced state series, as a candidate for current state series, in the steps 5326 through 5328.

That is to say, in steps 5322 through 5325, the series length q for the recognition observation value series and action series is incremented one at a time, at which time determination is made regarding whether the current situation of the agent is known or unknown, based on the most likely state series of the recognition observation value series and action series being observed.

Accordingly, in step S324, a most likely state series where the recognition observation value series and action series are observed with the series length of q−1 in which the series length q has been decremented by 1, immediately following determination having been made that the current situation is an unknown situation, exists in the experienced state series as a state series where the recognition observation value series and action series are observed, having the longest series length (or one of the longest).

Accordingly, in step S326, the state recognizing unit 23 reads out the newest observation value series with a series length of q−1, and an action series of action performed when each observation value of the observation value series is observed, from the history storage unit 14 (FIG. 4), as a recognition observation value series and action series, and the processing proceeds to step S327.

In step S327, the state recognizing unit 23 observes the recognition observation value series with series length of q−1, and action series, obtained in step S326, in the learned expanded HMM stored in the model storing unit 22, and obtains the optimal state probability δₜ(j) which is the maximum value of the state probability of being at state Sⱼ at point-in-time t, and the optimal path ψₜ(j) which is a state series where the optimal state probability δₜ(j) is obtained, following the above-described Expressions (10) and (11) based on the Viterbi algorithm.

That is to say, the state recognizing unit 23 obtains, from the state series of state transition occurring in the learned expanded HMM, an optimal path ψₜ(j) (recognition state series) which is a state series of which the series length is q−1 in which the recognition observation value series and action series are observed.

Upon the recognition state series being obtained in step S327, the processing proceeds to step S328, where the state recognizing unit 23 selects one or more recognition state series from the recognition state series obtained in step S327, as candidates for the current state series, in the same way as with the case of step S313 in FIG. 45, and the processing returns.

As described above, by incrementing the series length q, and obtaining a recognition observation value series and action series with the series length of q−1 in which the series length q has been decremented by 1, immediately following determination having been made that the current situation is an unknown situation, an appropriate candidate for the current state series (a state series corresponding to a configuration closer to the configuration of the current position of the agent in the action environment configuration which the expanded HMM has captured) can be obtained from the experienced state series.

That is to say, in the event that the series length is fixed for the recognition observation value series and action series used for obtaining candidates for the current state series, an appropriate candidate for the current state series may not be obtained if the fixed series length is too short or too long.

Specifically, in the event that the series length of the recognition observation value series and action series is too short, there will be a great number of state series with high likelihood of observation of the recognition observation value series and action series with such a series length in the experienced state series, so a great number of recognition observation value series with high likelihood will be obtained. Selecting candidates for the current state series from such a great number of recognition observation value series with high likelihood will result in a higher possibility of a state series expressing the current situation better not being selected as a candidate for the current state series from the experienced state series.

On the other hand, in the event that the series length of the recognition observation value series and action series is too long, there is a greater possibility that there will be no state series with high likelihood of observation of the recognition observation value series and action series with such a series length that is too long in the experienced state series, and consequently, there is a high possibility that no candidates can be obtained for the current state series.

In comparison with these, with the arrangement described with reference to FIG. 46, a most likely state series which is a state series where state transition occurs in which the likelihood of the recognition observation value series and action series being observed is the highest. Determination regarding whether or not the current situation of the agent is a known situation that has been captured by the expanded HMM or an unknown situation that has not been captured by the expanded HMM based on the most likely state series, while incrementing the series length of the recognition observation value series and action series, repeatedly, until determination is made that the current situation of the agent is an unknown situation. One or more recognition state series which is a state series where state transition occurs in which the recognition observation value series where the series length is q−1 which is one sample shorter than the series length q when determination was made that the current situation of the agent is an unknown situation, and the action series, are observed, are estimated. One or more current state series candidates are selected from the one or more recognition state series, whereby a state series closer to the configuration of the current position of the agent in the action environment configuration which the expanded HMM has captured, can be obtained as a current state series candidate. Consequently, actions can be determined maximally using the experienced state series.

### Action Determination Following Strategy

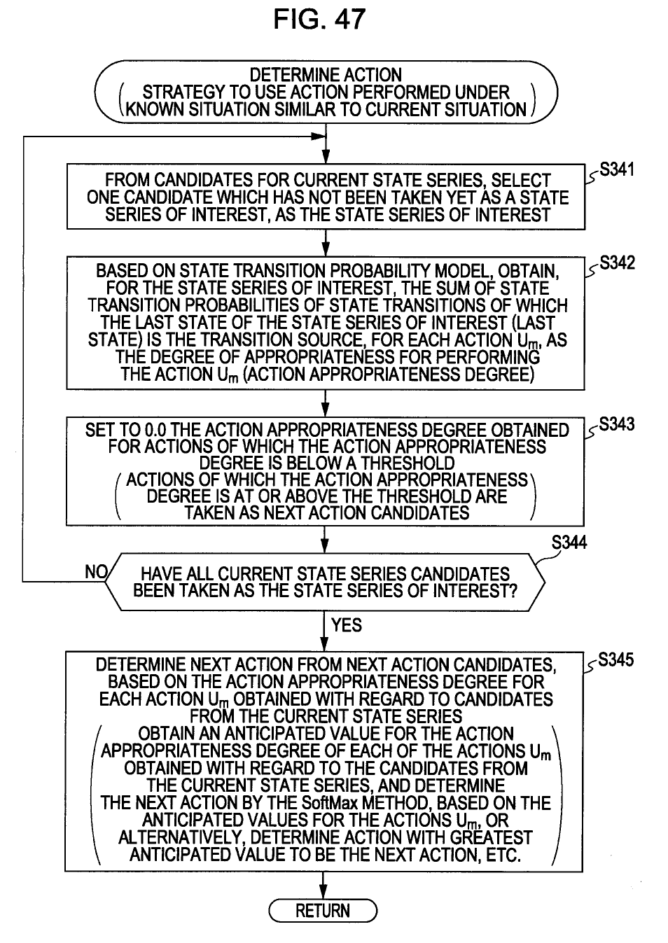

FIG. 47 is a flowchart for describing processing for determining action following strategy, which the action determining unit 24 shown in FIG. 4 performs in step S306 in FIG. 44. In FIG. 47, the action determining unit 24 determines an action following a first strategy of performing an action that the agent has performed in a known situation similar to the current situation of the agent, out of known situations captured at the expanded HMM.

That is to say, in step S341, the action determining unit 24 selects from the one or more current state series from the state recognizing unit 23 (FIG. 4) a candidate which has not yet been taken as a state series of interest, as the state series of interest, and the processing proceeds to step S342.

In step S342, the action determining unit 24 obtains, with regard to the state series of interest, the sum of state transition probabilities of state transition of which the transition source is the last state of the state series of interest (hereinafter also referred to as “last state”), as action suitability for each action Uₘ representing the suitability for performing the action Uₘ (following the first strategy), based on the expanded HMM stored in the model storage unit 22.

That is to say, expressing the last state as S_{I} (here I is an integer between 1 and N), the action determining unit 24 obtains the sum of state transition probabilities a_{I,1}(Uₘ), a_{I,2}(Uₘ), . . . a_{I,N}(Uₘ) arrayed in the j-axial direction (horizontal direction) on the state transition probability plane for each action Uₘ, as the action suitability.

Subsequently, the processing proceeds from step S342 to step S343, where the action determining unit 24 takes, out of the M (types of) actions U₁ through U_{M} regarding which action suitability has been obtained, the action suitability obtained regarding an action Uₘ of which the action suitability is below a threshold, to be 0.0. That is to say, the action determining unit 24 sets the action suitability obtained regarding an action Uₘ of which the action suitability is below a threshold to 0.0, thereby eliminating actions Uₘ of which the action suitability is below a threshold from candidates for the next action to be performed following the first strategy with regard to the state series of interest, consequently selecting actions Uₘ of which the action suitability is at or above the threshold candidates for the next action to be performed following the first strategy.

After step S343, the processing proceeds to step S344, where the action determining unit 24 determines whether or not all current state series candidates have been taken as the state series of interest. In the event that determination is made in step S344 that not all current state series candidates have been taken as the state series of interest yet, the processing returns to step S341. In step S341 the action determining unit 24 newly selects, from the one or more current state series from the state recognizing unit 23, a candidate which has not yet been taken as a state series of interest, as the state series of interest, and thereafter the same processing is repeated.

On the other hand, in the event that determination is made in step S344 that all current state series candidates have been taken as the state series of interest, the processing proceeds to step S345, where the action determining unit 24 determines the next action from the candidates for the next action, based on the action suitability regarding the actions Uₘ obtained for each of the one or more current state series candidates from the state recognizing unit 23, and the processing returns. That is to say, the action determining unit 24 determines a candidate of which the action suitability is greatest to be the next action.

Alternatively, the action determining unit 24 may obtain an anticipated value (average value) for action suitability regarding each action Uₘ, and determine the next action based on the anticipated value. Specifically, the action determining unit 24 may obtain an anticipated value (average value) for action suitability regarding each action Uₘ obtained corresponding to each of the one or more current state series candidates for each action Uₘ, and determine the action Uₘ with the greatest anticipated value, for example, to be the next action, based on the anticipated values for each action Uₘ.

Alternatively, the action determining unit 24 may determine the next action by the SoftMax method, for example, based on the anticipated values for each action Uₘ. That is to say, the action determining unit 24 randomly generates integers m of the range of 1 through M corresponding to the suffixes of the M actions U₁ through U_{M}, corresponding to a probability according to the anticipated value for the actions Uₘ with the integer m as the suffix thereof, and determines the action Uₘ having the generated integer m as the suffix thereof to be the next action.

As described above, in the event of determining an action following the first strategy, the agent performs an action which the agent has performed under a known situation similar to the current situation. Accordingly, with the first strategy, in the event that the agent is in an unknown situation, and the agent is desired to perform an action the same as an action taken under a known situation, the agent can be made to perform a suitable action. With the action determining following this first strategy, not only can actions be determined in cases where the agent is in an unknown situation, but also in cases where the agent has reached the above-described open end, for example.

Now, in the event that the agent is in an unknown situation and is caused to perform an action the same as an action taken under a known situation, the agent may wander through the action environment. When the agent wanders through the action environment, there is a possibility that the agent will return to a known location (region), which means that the current situation will become a known situation, and there is a possibility that the agent will develop an unknown location, which means that the current situation will be kept an unknown situation.

Accordingly, if the agent is desired to return to a known location, or if the agent is desired to develop an unknown location, an action where the agent wanders through the action environment is far from desirable. Thus, the action determining unit 24 is arranged so as to be able to determine the next action based on, in addition to the first strategy, a second and third strategy which are described below.

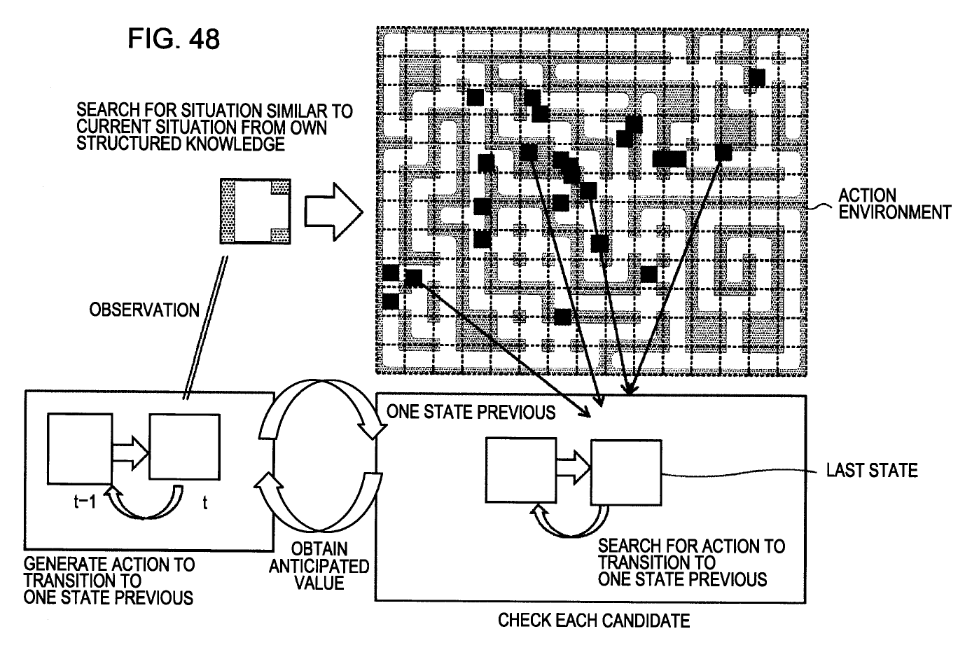

FIG. 48 is a diagram illustrating the overview of action determining following the second strategy. The second strategy is a strategy wherein information, enabling the current situation of the agent to be recognized, is increased, and by determining an action following this second strategy, a suitable action can be determined as an action for the agent to return to a known location, and consequently, the agent can efficiently return to a known location. That is to say, with action determining following the second strategy, the action determining unit 24 determines, as the next action, an action wherein there is generated state transition from the last state sₜ of one or more current state series candidates from the state recognizing unit 23, to an immediately preceding state Sₜ₋₁ immediately before the last state sₜ, for example, as shown in FIG. 48.

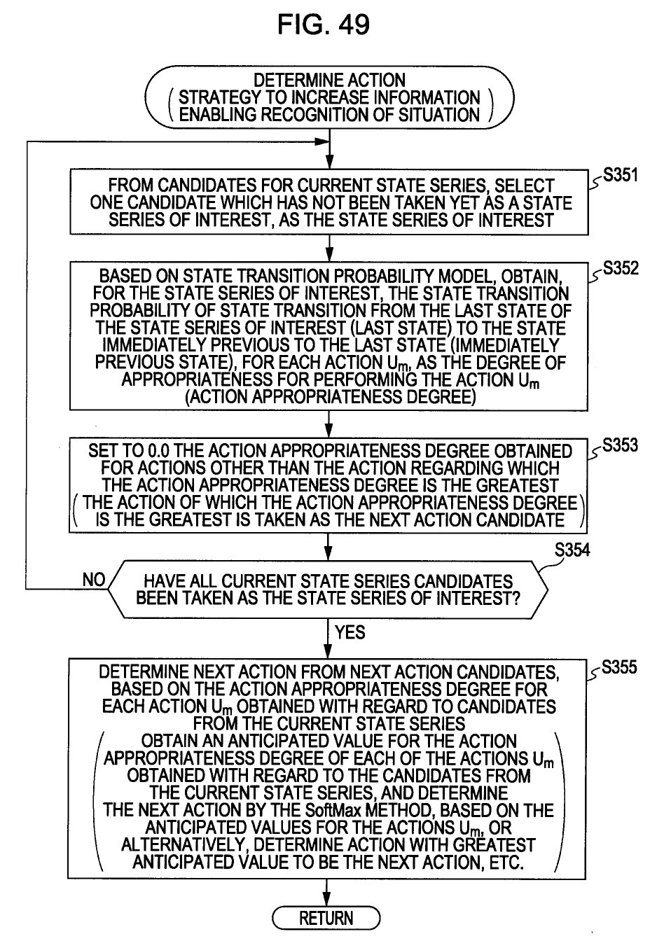

FIG. 49 is a flowchart describing processing for action determining following the second strategy, which the action determining unit 24 shown in FIG. 4 performs in step S306 in FIG. 44.

In step S351, the action determining unit 24 selects, from the one or more current state series candidates from the state recognizing unit 23, a candidate which has not been taken as a state series of interest yet, as the state series of interest, and the processing proceeds to step S352.

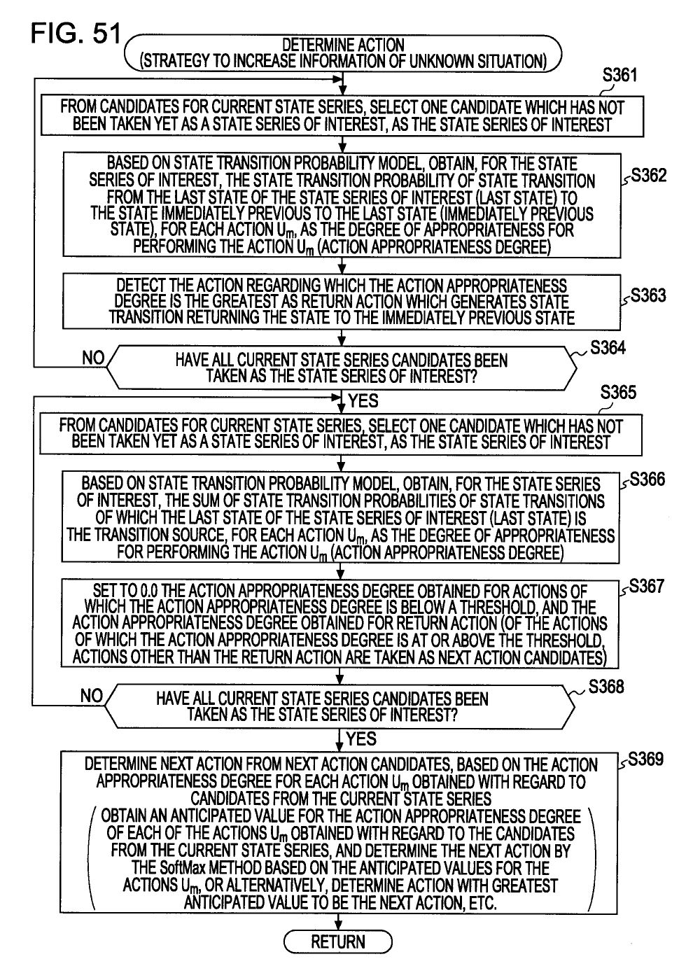

Here, in the event that the series length of a current state series candidate from the state recognizing unit 23 is 1, and there is no immediately preceding state which immediately precedes the last state, the action determining unit 24 refers to the expanded HMM (or the state transition probability thereof) stored in the model storage unit 22 before performing the processing in step S351, to obtain states for which the last state can serve as a transition destination of state transition, for each of the one or more current state series candidates from the state recognizing unit 23. The action determining unit 24 handles a state series in which are arrayed a state for which the last state can serve as a transition destination of state transition, and the last state, as a candidate of the current state series, for each of the one or more current state series candidates from the state recognizing unit 23. This also holds true for the later-described FIG. 51.

In step S352, the action determining unit 24 obtains, for the state series of interest, the state transition probability of state transition from the last state of the state series of interest to an immediately-preceding state which immediately precedes the last state, as action suitability representing the suitability of performing the action Uₘ (following the second strategy), for each action Uₘ. That is to say, the action determining unit 24 obtains the state transition probability aᵢⱼ(Uₘ) of state transition from the last state Sᵢ to the immediately-preceding state Sⱼ in the event that an action Uₘ is performed, as the action suitability for the action Uₘ.

Subsequently, the processing advances from step S352 to S353, where the action determining unit 24 sets the action suitability obtained for actions of the M (types of) actions U₁ through Uₘ other than the action regarding which the action suitability is the greatest, to 0.0. That is to say, the action determining unit 24 sets the action suitability for actions other than the action regarding which the action suitability is the greatest, to 0.0, consequently selecting the action with the greatest action suitability as a candidate for the next action to be performed for the state series of interest following the second strategy.

Following step S353, the processing advances to step S354, where the action determining unit 24 determines whether or not all current state series candidates have been taken as the state series of interest. In the event that determination is made in step S354 that not all current state series candidates have been taken as the state series of interest yet, the processing returns to step S351. In step S351 the action determining unit 24 newly selects, from the one or more current state series from the state recognizing unit 23, a candidate which has not yet been taken as a state series of interest, as the state series of interest, and thereafter the same processing is repeated.

On the other hand, in the event that determination is made in step S354 that all current state series candidates have been taken as the state series of interest, the processing proceeds to step S355, where the action determining unit 24 determines the next action from the candidates for the next action, based on the action suitability regarding the actions Uₘ obtained for each of the one or more current state series candidates from the state recognizing unit 23, and the processing returns. That is to say, the action determining unit 24 determines a candidate of which the action suitability is greatest to be the next action in the same way as with the case of step S345 in FIG. 47, and the processing returns.

As described above, in the event of determining an action following the second strategy, the agent performs actions to retrace the path which it came, consequently increasing information (observation values) which makes the situation of the agent recognizable. Accordingly, with the second strategy, if the agent is in an unknown situation and it is desired to make the agent return to a known location, the agent can perform suitable actions.

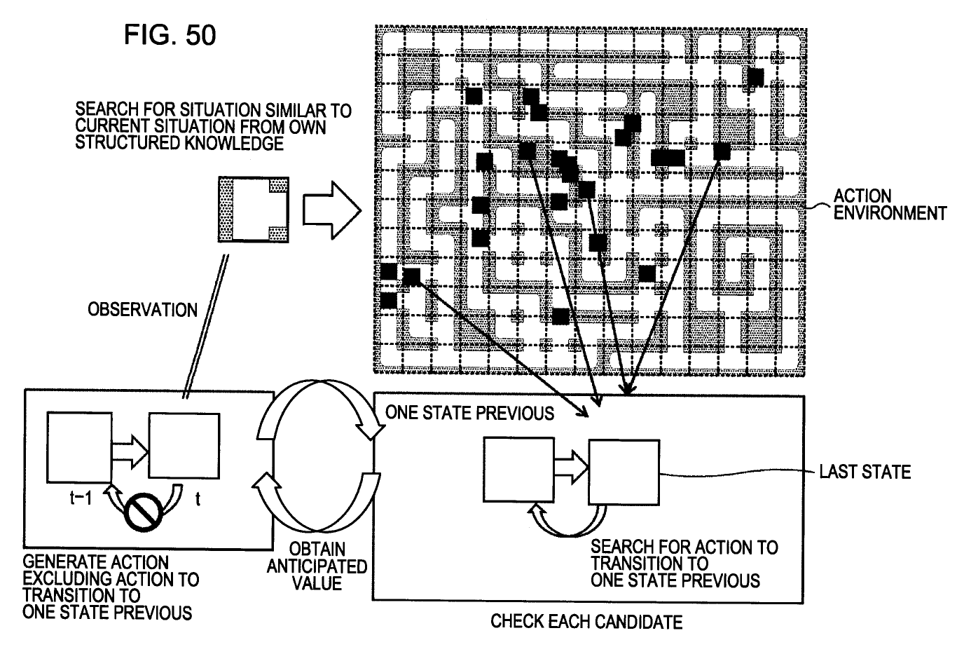

FIG. 50 is a diagram illustrating the overview of action determining following the third strategy. The third strategy is a strategy wherein information (observation values) of an unknown situation not captured at the expanded HMM is increased, and by determining an action following this third strategy, a suitable action can be determined as an action for the agent to develop an unknown location, and consequently, the agent can efficiently develop an unknown location. That is to say, with action determining following the third strategy, the action determining unit determines, as the next action, an action wherein there is generated state transition from the last state sₜ of one or more current state series candidates from the state recognizing unit 23, to other than an immediately preceding state Sₜ₋₁ immediately before the last state sₜ, for example, as shown in FIG. 50.

FIG. 51 is a flowchart describing processing for action determining following the third strategy, which the action determining unit 24 shown in FIG. 4 performs in step S306 in FIG. 44.

In step S361, the action determining unit 24 selects, from the one or more current state series candidates from the state recognizing unit 23, a candidate which has not been taken as a state series of interest yet, as the state series of interest, and the processing proceeds to step S362.

In step S362, the action determining unit 24 obtains, for the state series of interest, the state transition probability of state transition from the last state of the state series of interest to an immediately-preceding state which immediately precedes the last state, as action suitability representing the suitability of performing the action Uₘ (following the second strategy), for each action Uₘ. That is to say, the action determining unit 24 obtains the state transition probability aᵢⱼ(Uₘ) of state transition from the last state Sᵢ to the immediately-preceding state Sⱼ in the event that an action Uₘ is performed, as the action suitability for the action Uₘ.

Subsequently, the processing advances from step S362 to S363, where the action determining unit 24 detects an action with action suitability obtained for the M (types of) actions U₁ through Uₘ which is the greatest, as an action which generates state transition returning the state to the immediately-preceding state (also called “return action”).

Following step S363, the processing advances to step S364, where the action determining unit 24 determines whether or not all current state series candidates have been taken as the state series of interest. In the event that determination is made in step S364 that not all current state series candidates have been taken as the state series of interest yet, the processing returns to step S361. In step S361 the action determining unit 24 newly selects, from the one or more current state series from the state recognizing unit 23, a candidate which has not yet been taken as a state series of interest, as the state series of interest, and thereafter the same processing is repeated.

On the other hand, in the event that determination is made in step S364 that all current state series candidates have been taken as the state series of interest, the action determining unit 24 resets the fact that all current state series candidates have been taken as the state series of interest, and the processing proceeds to step S365. In step S365, in the same way as with step S361, the action determining unit 24 selects, from the one or more current state series candidates from the state recognizing unit 23, a candidate which has not been taken as a state series of interest yet, as the state series of interest, and the processing proceeds to step S366.

In step S366, in the same way as with the case of step S342 in FIG. 47, the action determining unit 24 obtains, for the state series of interest, the sum of state transition probabilities of state transition of which the transition source is the last state of the state series of interest, as action suitability for each action Uₘ representing the suitability for performing the action Uₘ (following the third strategy), based on the expanded HMM stored in the model storage unit 22.

Subsequently, the processing advances from step S362 to S363, where the action determining unit 24 takes, out of the M (types of) actions U₁ through U_{M} regarding which action suitability has been obtained, the action suitability obtained regarding an action Uₘ of which the action suitability is below a threshold, and also the action suitability obtained regarding return actions, to be 0.0. That is to say, the action determining unit 24 sets the action suitability obtained regarding an action Uₘ of which the action suitability is below a threshold to 0.0, thereby eliminating actions Uₘ of which the action suitability is below a threshold from candidates for the next action to be performed following the first strategy with regard to the state series of interest. The action determining unit 24 also sets the action suitability obtained regarding return actions in actions Uₘ of which the action suitability is at or above the threshold to 0.0, consequently selecting actions other than return actions as candidates for the next action to be performed following the third strategy.

Following step S367, the processing advances to step S368, where the action determining unit 24 determines whether or not all current state series candidates have been taken as the state series of interest. In the event that determination is made in step S368 that not all current state series candidates have been taken as the state series of interest yet, the processing returns to step S365. In step S365 the action determining unit 24 newly selects, from the one or more current state series from the state recognizing unit 23, a candidate which has not yet been taken as a state series of interest, as the state series of interest, and thereafter the same processing is repeated.

On the other hand, in the event that determination is made in step S368 that all current state series candidates have been taken as the state series of interest, the processing proceeds to step S369, where the action determining unit 24 determines the next action from the candidates for the next action, based on the action suitability regarding the actions Uₘ obtained for each of the one or more current state series candidates from the state recognizing unit 23, in the same way as with the case of step S345 in FIG. 47, and the processing returns.

As described above, in the event of determining an action following the third strategy, the agent performs actions other than return actions, i.e., actions to develop unknown locations, consequently increasing information of unknown situations not captured at the extended HMM. Accordingly, with the third strategy, if the agent is in an unknown situation and it is desired to make the agent develop an unknown location, the agent can perform suitable actions.

As described above, candidates of current state series which are state series leading to the current situation of the agent are calculated based on the expanded HMM, and an action for the agent to perform next is determined using the state series candidates following a predetermined strategy, so the agent can decide actions based on experience captured by the expanded HMM, even if no metrics for actions to be taken, such as a reward function for calculating a reward corresponding to an action.

Note that Japanese Unexamined Patent Application Publication No. 2008-186326, for example, describes a method for determining an action with one reward function as an action determining technique in which situational ambiguity is resolved. The recognition action mode processing in FIG. 44 differs from the action determining technique according to Japanese Unexamined Patent Application Publication No. 2008-186326 in that, for example, candidates for current state series which are state series whereby the agent reached the current situation are calculated based on the expanded HMM, and the current state series candidates are used to determine actions, and also in that a state series of which the series length q is the longest in state series which the agent has experienced where a recognition observation value series and action series are observed, can be obtained as a candidate for the current state series (FIG. 46), and further in that strategies to follow to determine actions can be switched (selected from multiple strategies) as described later, and so on.

Now as described above, the second strategy is a strategy for increasing information to enable recognition of the state of the agent, and the third strategy is a strategy for increasing unknown information that has not been captured at the expanded HMM, so both the second and third strategies are strategies which increase information of some sort. Determining of actions following the second and third strategies which increase information of some sort can be performed as described below, besides the methods described with reference to FIGS. 48 through 51.

The probability Pₘ(O) that an observation value O will be observed in the event that the agent performs an action Uₘ at a certain point-in-time t is expressed by Expression (30)

$${P}_{m} ( O ) = {\sum }_{i = 1}^{N} {\sum }_{j = 1}^{N} {ρ}_{i} {a}_{ij} ( {U}_{m} ) {b}_{j} ( O ) \qquad ( 30 )$$

where ρᵢ represents the state probability of being in state Sᵢ at point-in-time t.

If we way that the amount of information where the probability of occurring represented by probability Pₘ(O) is represented by I(Pₘ(O)), the suffix m′ of an action U_{m′} determined following a strategy which increases information of some sort is expressed as in Expression (31)

$${m}^{′} = arg {max}_{m} \{ I ( {P}_{m} ( O ) ) \} \qquad ( 31 )$$

where argmax{I(Pₘ(O))} represents, of the suffixes m of the action Uₘ, a suffix m′ which maximizes the amount of information I(Pₘ(O)) in the parentheses.

Now, if we employ information enabling recognition of the situation of the agent (hereinafter also referred to as “recognition-enabling information”) as information, determining the action U_{m′}, following Expression (31) means determining the action following the second strategy which increases recognition-enabling information. Also, if we employ information of an unknown situation not captured by the expanded HMM (hereinafter also referred to as “unknown situation information”) as information, determining the action U_{m′} following Expression (31) means determining the action following the third strategy which increases unknown situation information.

Now, if we represent entropy of information, of which the occurrence probability is represented by the probability Pₘ(O), with H^{o}(Pₘ), Expression (31) can equivalently be expressed as follows, i.e., entropy H^{o}(Pₘ) can be expressed by Expression (32).

$${H}^{o} ( {P}_{m} ) = {\sum }_{O = {O}_{1}}^{{O}_{K}} ( - {P}_{m} ( O ) \times log ( {P}_{m} ( O ) ) ) \qquad ( 32 )$$

In the event that the entropy H^{o}(Pₘ) in Expression (32) is great, the probability Pₘ(O) that the observation value O will be observed is uniform at each observation value, leading to ambiguity where it is not known what sort of observation value will be observed, and accordingly, where the agent is not known. Accordingly, the probability of capturing information that the agent does not know, of an unknown world as if it were, is higher.

Accordingly, a greater entropy H^{o}(Pₘ) increases unknown situation information, so the Expression (31) for determining actions following the third strategy for increasing unknown situation information can be equivalently expressed by Expression (33) where the entropy H^{o}(Pₘ) is maximized

$${m}^{′} = arg {max}_{m} \{ {H}^{o} ( {P}_{m} ) \} \qquad ( 33 )$$

where argmax{H^{o}(Pₘ)} represents, of the suffixes m of the action Uₘ, a suffix m′ which maximizes the entropy H^{o}(Pₘ) in the parentheses.

On the other hand, in the event that the entropy H^{o}(Pₘ) in Expression (32) is small, the probability Pₘ(O) that the observation value O will be observed is high at only a particular observation value, resolving ambiguity where it is not known what sort of observation value will be observed, and accordingly, where the agent is not known. Accordingly, the location of the agent is more readily determined.

Accordingly, a smaller entropy H^{o}(Pₘ) increases recognition-enabling information, so the Expression (31) for determining actions following the second strategy for increasing recognition-enabling information can be equivalently expressed by Expression (34) where the entropy H^{o}(Pₘ) is minimized

$${m}^{′} = arg {max}_{m} \{ {H}^{o} ( {P}_{m} ) \} \qquad ( 34 )$$

where argmin{H^{o}(Pₘ)} represents, of the suffixes m of the action Uₘ, a suffix m′ which minimizes the entropy H²(Pₘ) in the parentheses.

Alternatively, with regard to the relational magnitude of the maximum value of the probability Pₘ(O) and the threshold, for example, an action Uₘ which maximizes the probability Pₘ(O) can be determined as the next action. In the event that the maximum value of the probability Pₘ(O) is greater than the threshold (or is equal or greater), determining an action Uₘ which maximizes the probability Pₘ(O) as the next action means determining an action so as to resolve ambiguity, i.e., to determine an action following the second strategy. On the other hand, in the event that the maximum value of the probability Pₘ(O) is equal to or smaller than the threshold (or is smaller), determining an action Uₘ which maximizes the probability Pₘ(O) as the next action means determining an action so as to increase ambiguity, i.e., to determine an action following the third strategy.

In the arrangement described above, an action is determined using the probability Pₘ(O) that an observation value O will be observed in the event that the agent performs an action Uₘ at a certain point-in-time t, but alternatively, an arrangement may be made wherein an action is determined using the probability Pₘⱼ of Expression (35) that state transition will occur from state Sᵢ to state Sⱼ in the event that the agent performs an action Uₘ at a certain point-in-time t.

$${P}_{mj} = {\sum }_{i = 1}^{N} {ρ}_{i} {a}_{ij} ( {U}_{m} ) \qquad ( 35 )$$

That is to say, the suffix m′ of an action U_{m′}, in a case of determining an action following the strategy for increasing the amount of information I(Pₘⱼ) of which the probability of occurring is expressed by probability Pₘⱼ, is represented by Expression (36)

$${m}^{′} = arg {max}_{m} \{ I ( {P}_{mj} ) \} \qquad ( 36 )$$

where argmax{I(Pₘⱼ)} represents, of the suffixes m of the action Uₘ, a suffix m′ which maximizes the amount of information I(Pₘⱼ) in the parentheses.

Now, if we employ recognition-enabling information as information, determining the action U_{m′} following Expression (36) means determining the action following the second strategy which increases recognition-enabling information. Also, if we employ unknown situation information as information, determining the action U_{m′} following Expression (36) means determining the action following the third strategy which increases unknown situation information.

Now, if we represent entropy of information, of which the occurrence probability is represented by the probability Pₘⱼ, with H^{j}(Pₘ), Expression (36) can equivalently be expressed as follows, i.e., entropy H^{j}(Pₘ) can be expressed by Expression (37).

$${H}^{j} ( {P}_{m} ) = {\sum }_{j = 1}^{N} ( - {P}_{mj} \times log ( {P}_{mj} ) ) \qquad ( 37 )$$

In the event that the entropy H^{j}(Pₘ) in Expression (37) is great, the probability Pₘⱼ that state transition will occur from state Sᵢ to state Sⱼ will occur is uniform at each state transition, leading to increase in ambiguity where it is not known what sort of state transition will occur, and accordingly, where the agent is not known. Accordingly, the probability of capturing information that the agent does not know of an unknown world is higher.

Accordingly, a greater entropy H^{j}(Pₘ) increases unknown situation information, so the Expression (36) for determining actions following the third strategy for increasing unknown situation information can be equivalently expressed by Expression (38) where the entropy H^{j}(Pₘ) is maximized

$${m}^{′} = arg {max}_{m} \{ {H}^{j} ( {P}_{m} ) \} \qquad ( 38 )$$

where argmax{H^{j}(Pₘ)} represents, of the suffixes m of the action Uₘ, a suffix m′ which maximizes the entropy H(Pₘ) in the parentheses.

On the other hand, in the event that the entropy H^{j}(Pₘ) in Expression (37) is small, the probability Pₘⱼ that state transition will occur from state Sᵢ to state Sⱼ is high at only a particular state transition, resolving ambiguity where it is not known what sort of observation value will be observed, and accordingly, where the agent is not known. Accordingly, the location of the agent is more readily determined.

Accordingly, a smaller entropy H^{j}(Pₘ) increases recognition-enabling information, so the Expression (36) for determining actions following the second strategy for increasing recognition-enabling information can be equivalently expressed by Expression (39) where the entropy H^{o}(Pₘ) is minimized

$${m}^{′} = arg {min}_{m} \{ {H}^{j} ( {P}_{m} ) \} \qquad ( 39 )$$

where argmin{H(P)} represents, of the suffixes m of the action Uₘ, a suffix m′ which minimizes the entropy H^{j}(Pₘ) in the parentheses.

Alternatively, with regard to the relational magnitude of the maximum value of the probability Pₘⱼ and the threshold, for example, an action Uₘ which maximizes the probability Pₘⱼ can be determined as the next action. In the event that the maximum value of the probability Pₘⱼ is greater than the threshold (or is equal or greater), determining an action Uₘ which maximizes the probability Pₘⱼ as the next action means determining an action so as to resolve ambiguity, i.e., to determine an action following the second strategy. On the other hand, in the event that the maximum value of the probability Pₘⱼ is equal to or smaller than the threshold (or is smaller), determining an action Uₘ which maximizes the probability Pₘⱼ as the next action means determining an action so as to increase ambiguity, i.e., to determine an action following the third strategy.

With yet another arrangement, determining an action such that ambiguity is resolved, i.e., determining an action following the second strategy, can be performed using the posterior probability P(X|O) of being at state S_{X} when observation value O is observed. The posterior probability P(X|O) is expressed in Expression (40).

$$P ( X \vert O ) = \frac{P ( X , O )}{P ( O )} = \frac{{\sum }_{i = 1}^{N} {ρ}_{i} {a}_{ix} ( {U}_{m} ) {b}_{x} ( O )}{{\sum }_{i = 1}^{N} {\sum }_{j = 1}^{N} {ρ}_{i} {a}_{ij} ( {U}_{m} ) {b}_{j} ( O )} \qquad ( 40 )$$

Determining an action following the second strategy can be realized by representing the entropy of the posterior probability P(X|O) as H(P(X|O)), and determining an action such that the entropy H(P(X|O)) is small. That is to say, determining an action following the second strategy can be realized by determining an action Uₘ following Expression (41)

$${m}^{′} = {argmin}_{m} \{ {\sum }_{O = {O}_{1}}^{{O}_{K}} P ( O ) H ( P ( X \vert O ) ) \} \qquad ( 41 )$$

where argmin{ } represents, of the suffixes m of the action Uₘ, a suffix m′ that minimizes the value within the brackets.

The ΣP(O)H(P(X|O)) within the brackets in argmin{ } in Expression (41) is the summation of observation value O varied from observation values O₁ through O_{K}, in the product of the probability P(O) that the observation value O will be observed, and the entropy H(P(X|O)) of the posterior probability P(X|O) of being at the state S_{X} when the observation value O is observed, representing the entire entropy where observation values O₁ through O_{K} are observed when the action Uₘ is performed.

According to Expression (41), the action which minimizes the entropy ΣP(O)H(P(X|O)), i.e., the action regarding which the probability of the observation value O being uniquely determined being high, is determined to be the next action. Thus, determining an action following Expression (41) means determining an action so as to resolve ambiguity, i.e., to determine an action following the second strategy.

Also, determining an action so as to increase ambiguity, i.e., determining an action following the third strategy, can be performed by taking the amount of reduction of entropy H(P(X|O)) of posterior probability P(X|O) as to the entropy H(P(X)) of prior probability P(X) of being a state S_{X}, as an amount of unknown situation information, and maximizing the amount of reduction. The prior probability P(X) is as expressed in Expression (42).

$$P ( X ) = {\sum }_{i = 1}^{N} {ρ}_{i} {a}_{ix} ( {U}_{m} ) \qquad ( 42 )$$

An action U_{m′} which maximizes the amount of reduction entropy H(P(X|O)) of posterior probability P(X|O) as to the entropy H(P(X)) of prior probability P(X) of being a state S_{X} can be determined following Expression (43)

$${m}^{′} = {argmax}_{m} \{ {\sum }_{O = {O}_{1}}^{{O}_{K}} P ( O ) ( H ( P ( X ) ) - H ( P ( X \vert 0 ) ) ) \} \qquad ( 43 )$$

where argmax{ } represents, of the suffixes m of the action Uₘ, a suffix m′ that maximizes the value within the brackets.

According to Expression (43), the difference H(P(X))−H(P(X|O)) between the entropy H(P(X)) of prior probability P(X) that is the state probability of being a state S_{X} in the event that the observation value O is unknown, and the entropy H(P(X|O)) of the posterior probability P(X|O) of the observation value O being observed and of being a state S_{X} in the event that an action Uₘ is performed, is multiplied by the probability P(O) that the observation value O will be observed, to obtain a multiplication value P(O) (H(P(X))−H(P(X|O))), and the summation IP(O)(H(P(X))−H(P(X|O))) with the observation value O varied from observation values O₁ through O_{K} is taken as the amount of unknown situation information that has increased by the action Uₘ having been performed, and an action which maximizes the amount of unknown situation information is determined to be the next action.

### Selecting a Strategy

As described with reference to FIGS. 47 through 51, the agent can determine an action following the first through third strategies. A strategy to follow when determining an action may be set beforehand, or may be adaptively selected from multiple strategies, i.e., the first through third strategies.

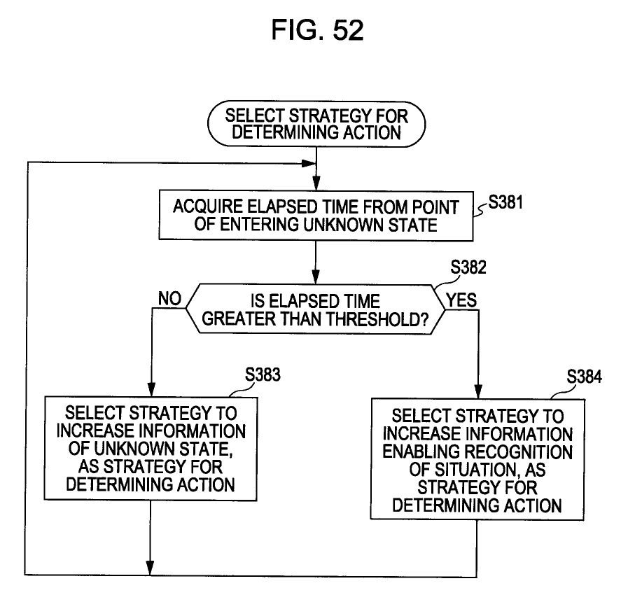

FIG. 52 is a flowchart for describing processing for an agent to select a strategy to follow when determining an action, from multiple strategies. Now, according to the second strategy, actions are determined so that recognition-enabling information increases and ambiguity is resolved, i.e., so that the agent returns to a known location (region). On the other hand, according to the third strategy, actions are determined so that unknown situation information increases and ambiguity increases, i.e., so that the agent develops unknown locations. According to the first strategy, it is not known whether the agent will return to a known location or develop an unknown location, but actions which the agent has performed under known situations similar to the current situation of the agent are performed.

Now, in order to broadly capture the configuration of the action environment, i.e., to increase the knowledge of the agent (known world), actions have to be determined so that the agent develops unknown locations.

On the other hand, in order for the agent to capture unknown locations as known locations, the agent has to return to a known location from an unknown location and perform expanded HMM learning (additional learning) to connect the unknown location with a known location. This means that in order for the agent to be able to capture an unknown location as a known location, the agent has to determine actions so as to return to a known location.

A good balance between determining actions such that the agent will develop unknown locations, and determining actions so as to return to a known location, enables efficient expanded HMM modeling of the overall configuration of the action environment. An arrangement may be made for this wherein the agent selects a strategy to follow when determining an action from the second and third strategies, based on the amount of time elapsed from the point that the situation of the agent has become an unknown situation, as shown in FIG. 52.

In step S381, the action determining unit 24 (FIG. 4) obtains the amount of time elapsed from the point that the situation of the agent has become an unknown situation (hereinafter also referred to as “unknown situation elapsed time”) based on the recognition results of the current situation at the state recognizing unit 23, and the processing proceeds to step S382.

Note that “unknown situation elapsed time” refers to the number of consecutive times that the state recognizing unit 23 yields recognition results that the current situation is an unknown situation, and in the vent that a recognition result is obtained that the current situation is a known situation, the unknown situation elapsed time is reset to 0. Accordingly, the unknown situation elapsed time in a case wherein the current situation is not an unknown situation (a case of a known situation) is 0.

In step S382, the action determining unit 24 determines whether or not the unknown situation elapsed time is greater than a predetermined threshold. In the event that determination is made in step S382 that the unknown situation elapsed time is not greater than the predetermined threshold, i.e., that the amount of time elapsed since the situation of the agent has become an unknown situation is not that great, the processing proceeds to step S383, where the action determining unit 24 selects the third strategy which increases unknown situation information, from the second and third strategies, as the strategy to follow for determining an action, and the processing returns to step S381.

In the event that determination is made in step S382 that the unknown situation elapsed time is greater than the predetermined threshold, i.e., that the amount of time elapsed since the situation of the agent has become an unknown situation is substantial, the processing proceeds to step S384, where the action determining unit 24 selects the second strategy which increases recognition-enabling information, from the second and third strategies, as the strategy to follow for determining an action, and the processing returns to step S381.

While description has been made with reference to FIG. 52 that the strategy to follow when determining an action is determined based on the amount of time elapsed since the situation of the agent has become an unknown situation, an arrangement may be made other than this wherein the strategy to follow when determining an action is determined based on, for example, the ratio of time in a known situation or time in an unknown situation, out of a predetermined period of recent time.

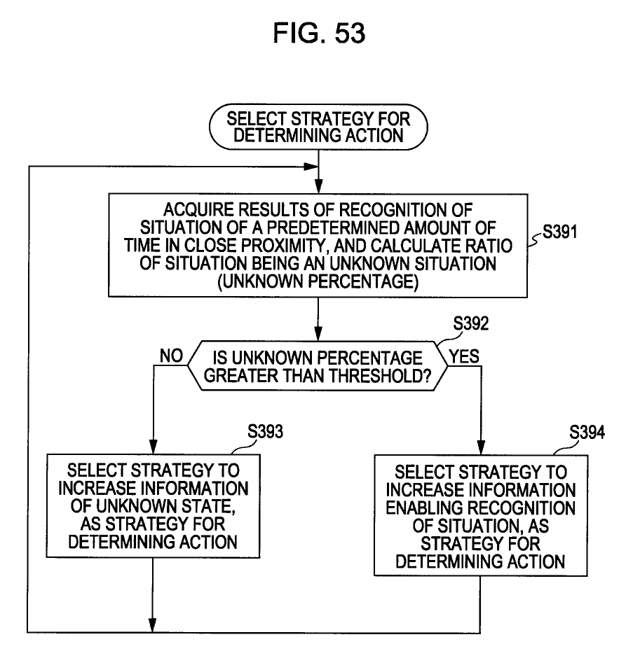

FIG. 53 is a flowchart for describing processing for selecting a strategy to follow for determining an action, based on the ratio of time in a known situation or time in an unknown situation, out of a predetermined period of recent time.

In step S391, the action determining unit 24 (FIG. 4) obtains from the state recognizing unit 23 recognition results of the current situation over a predetermined period of recent time, calculates the ratio of the situation being an unknown situation (hereinafter, also referred to as “unknown percentage”) from the recognition results, and the processing proceeds to step S392.

In step S392, the action determining unit 24 determines whether or not the unknown percentage is greater than a predetermined threshold. In the event that determination is made in step S392 that the unknown percentage is not greater than the predetermined threshold, i.e., that the ratio of the situation of the agent being in an unknown situation is not that great, the processing proceeds to step S393, where the action determining unit 24 selects the third strategy which increases unknown situation information, from the second and third strategies, as the strategy to follow for determining an action, and the processing returns to step S391.

In the event that determination is made in step S392 that the unknown percentage is greater than the predetermined threshold, i.e., that the ratio of the situation of the agent being in an unknown situation is substantial, the processing proceeds to step S394, where the action determining unit 24 selects the second strategy which increases recognition-enabling information, from the second and third strategies, as the strategy to follow for determining an action, and the processing returns to step S391.

While description has been made with reference to FIG. 53 that the strategy to follow when determining an action is determined based on the ratio of the situation of the agent being in an unknown situation (unknown percentage) out of a predetermined period of recent time in the recognition results, an arrangement may be made other than this wherein the strategy to follow when determining an action is determined based on the ratio of the situation of the agent being in an known situation (hereinafter also referred to as “known percentage”) out of a predetermined period of recent time in the recognition results. In the event of performing strategy selection based on the known percentage, the third strategy is selected as the strategy for determining the action in the event that the known percentage is greater than the threshold, and the second strategy is selected in the event that the known percentage is not greater than the threshold.

An arrangement may also be made in step S383 in FIG. 52 and step S393 in FIG. 53 where the first strategy is selected as a strategy for determining actions instead of the third strategy, once every predetermined number of times, or the like.

Selecting strategies as described above enables efficient expanded HMM modeling of the overall configuration of the action environment.

Description of Computer to which the Present Invention has been Applied

Now, the above-described series of processing can be executed by hardware or by software. In the event that the series of processing is performed by software, a program making up the software is installed in a general-purpose computer or the like.

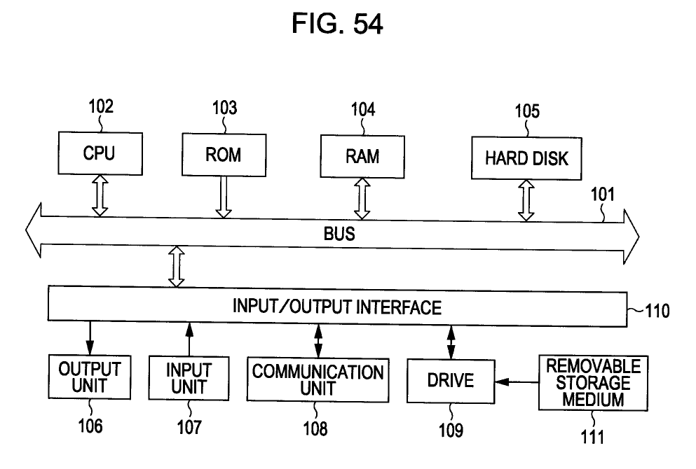

FIG. 54 illustrates the configuration example of an embodiment of a computer to which a program for executing the above-described series of processing is installed. The program can be recoded beforehand in a hard disk 105 or ROM 103, serving as recording media built into the computer.

Alternatively, the program can be stored (recorded) in a removable recording medium 111. Such a removable recording medium 111 can be provided as so-called packaged software. Examples of the removable recording medium 111 include flexible disks, CD-ROM (Compact Disc Read Only Memory) discs, MO (Magneto Optical) discs, DVD (Digital Versatile Disc), magnetic disks, semiconductor memory, and so on.

Besides being installed to a computer from the removable recording medium 111 such as described above, the program may be downloaded to the computer via a communication network or broadcasting network, and installed to the built-in hard disk 105. That is to say, the program can be, for example, wirelessly transferred to the computer from a download site via a digital broadcasting satellite, or transferred to the computer by cable via a network such as a LAN (Local Area Network) or the Internet or the like.

The computer has built therein a CPU (Central Processing Unit) 102 with an input/output interface 110 being connected to the CPU 102 via a bus 101. Upon a command being input by an input unit 107 being operated by the user or the like via the input/output interface 110, the CPU 102 executes a program stored in ROM (Read Only Memory) 103, or loads a program stored in the hard disk 105 to RAM (Random Access Memory) 104 and executes the program.

Accordingly, processing following the above-described flowcharts, or processing performed by the configurations of the block diagrams described above, is performed by the CPU 102. The CPU 102 outputs the processing results thereof from an output unit 106 via the input/output interface 110, for example, or transmits the processing results from a communication unit 108, or further records in the hard disk 105, or the like, as appropriate.

The input unit 107 is configured of a keyboard, mouse, microphone, or the like. The output unit 106 is configured of an LCD (Liquid Crystal Display), speaker, or the like.

It should be noted that with the Present Specification, the processing which the computer performs following the program does not have to be performed in the time-sequence following the order described in the flowcharts; rather, the processing which the computer performs following the program includes processing executed in parallel or individually e.g., parallel processing or object-oriented processing) as well.

Also, the program may be processed by a single computer (processor), or may be processed by decentralized processing by multiple computers. Moreover, the program may be transferred to a remote computer and executed.

It should be noted that embodiments of the Present Invention are not restricted to the above-described embodiment, and that various modifications may be made without departing from the spirit and scope of the Present Invention.

The present application contains subject matter related to that disclosed in Japanese Priority Patent Application JP 2009-140065 filed in the Japan Patent Office on Jun. 11, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
calculating means configured to calculate a current-state series candidate that is a state series for an agent capable of actions reaching the current state, based on a state transition probability model obtained by
performing learning of said state transition probability model stipulated by
a state transition probability that a state will be transitioned according to each of actions performed by an agent capable of actions, and
an observation probability that a predetermined observation value will be observed from said state,
using
an action performed by said agent, and
an observation value observed at said agent when said agent performs an action; and
determining means configured to determine an action to be performed next by said agent using said current-state series candidate in accordance with a predetermined strategy.

2. The information processing device according to claim 1, wherein said determining means determine an action in accordance with a strategy for increasing information of an unknown situation not obtained at said state transition probability model.

3. The information processing device according to claim 2, wherein said calculating means estimate, with an action series of actions performed by said agent, and an observation value series of observation values observed at said agent when said actions are performed as an action series for recognition for recognizing the situation of an agent, and an observation value series, one or more state series for recognition that are state series wherein state transition occurs in which said action series for recognition and said observation value series are observed, and select one or more candidates of said current-state series out of one or more of said state series for recognition;
and wherein said determining means detect an action of which the state transition probability of state transition from a final state that is the final state of said current-state series candidate to an immediate before state that is a state immediately before said final state is the maximum as a return action wherein state transition for returning the state to said immediate before state regarding each of one or more candidates of said current-state series, obtain the sum of the state transition probabilities of state transitions with said final state as the transition source for each action as an action suitability degree representing suitability for performing the action thereof regarding each of one or more candidates of said current-state series, obtain an action other than said return action of actions of which said action suitability degree is equal to or greater than a predetermined threshold, as an action candidate to be performed next regarding each of one or more candidates of said current-state series, and determine an action to be performed next out of said action candidates to be performed next.

4. The information processing device according to claim 1, wherein said determining means determine an action in accordance with a strategy for increasing information whereby the situation of said agent is recognizable.

5. The information processing device according to claim 4, wherein said calculating means estimate, with an action series of actions performed by said agent, and an observation value series of observation values observed at said agent when said actions are performed as an action series for recognition for recognizing the situation of an agent, and an observation value series, one or more state series for recognition that are state series wherein state transition occurs in which said action series for recognition and said observation value series are observed, and select one or more candidates of said current-state series out of one or more of said state series for recognition;
and wherein said determining means detect an action of which the state transition probability of state transition from a final state that is the final state of said current-state series candidate to an immediate before state that is a state immediately before said final state is the maximum as an action to be performed next regarding each of one or more candidates of said current-state series, and determine an action to be performed next out of said action candidates to be performed next.

6. The information processing device according to claim 1, wherein said determining means determine an action in accordance with a strategy for performing an action performed by said agent in a known situation similar to the current situation of said agent of known situations obtained at said state transition probability model.

7. The information processing device according to claim 6, wherein said calculating means estimate, with an action series of actions performed by said agent, and an observation value series of observation values observed at said agent when said actions are performed as an action series for recognition for recognizing the situation of an agent, and an observation value series, one or more state series for recognition that are state series wherein state transition occurs in which said action series for recognition and said observation value series are observed, and select one or more candidates of said current-state series out of one or more of said state series for recognition;
and wherein said determining means obtain the sum of the state transition probabilities of state transitions with a final state that is the final state of said current-state series candidate as the transition source for each action as an action suitability degree representing suitability for performing the action thereof regarding each of one or more candidates of said current-state series, obtain an action of which said action suitability degree is equal to or greater than a predetermined threshold, as an action candidate to be performed next regarding each of one or more candidates of said current-state series, and determine an action to be performed next out of said action candidates to be performed next.

8. The information processing device according to claim 1, wherein said determining means select a strategy for determining an action out of a plurality of strategies, and determine an action in accordance with the strategy thereof.

9. The information processing device according to claim 8, wherein said determining means select a strategy for determining an action out of a strategy for increasing information of an unknown situation not obtained at said state transition probability model, and a strategy for increasing information whereby the situation of said agent is recognizable.

10. The information processing device according to claim 9, wherein said determining means select a strategy based on elapsed time since an unknown situation not obtained at said state transition probability model.

11. The information processing device according to claim 9, wherein said determining means select a strategy based on the time of a known situation obtained at said state transition probability model, or the percentage of an unknown situation not obtained at said state transition probability model, of imminent predetermined time.

12. The information processing device according to claim 1, wherein said calculating means repeat to estimate, with an action series of actions performed by said agent, and an observation value series of observation values observed at said agent when said actions are performed as an action series for recognition for recognizing the situation of an agent, and an observation value series, a most likely state series that is a state series where state transition occurs in which likelihood for said action series for recognition, and said observation value series being observed is the highest, and to determine whether the situation of said agent is a known situation obtained at said state transition probability model, or an unknown situation not obtained at said state transition probability model based on said most likely state series while increasing the series lengths of said action series for recognition and said observation value series until determination is made that the situation of said agent is said unknown situation, estimate one or more of state series for recognition that are state series where state transition occurs in which said action series for recognition and said observation value series, of which the series lengths are shorter than said series lengths at the time of determination being made that the situation of said agent is said unknown situation by one sample worth are observed, and select one or more candidates of said current state series out of said one or more state series for recognition;
and wherein said determining means determine an action using one or more candidates of said current state series.

13. An information processing method comprising the steps of:
calculating of a current-state series candidate that is a state series for an agent capable of actions reaching the current state, based on a state transition probability model obtained by
performing learning of said state transition probability model stipulated by
a state transition probability that a state will be transitioned according to each of actions performed by an agent capable of actions, and
an observation probability that a predetermined observation value will be observed from said state,
using
an action performed by said agent, and
an observation value observed at said agent when said agent performs an action; and
determining an action to be performed next by said agent using said current-state series candidate in accordance with a predetermined strategy.

14. A program causing a computer serving as:
calculating means configured to calculate a current-state series candidate that is a state series for an agent capable of actions reaching the current state, based on a state transition probability model obtained by
performing learning of said state transition probability model stipulated by
a state transition probability that a state will be transitioned according to each of actions performed by an agent capable of actions, and
an observation probability that a predetermined observation value will be observed from said state,
using
an action performed by said agent, and
an observation value observed at said agent when said agent performs an action; and
determining means configured to determine an action to be performed next by said agent using said current-state series candidate in accordance with a predetermined strategy.

15. An information processing device comprising:
a calculating unit configured to calculate a current-state series candidate that is a state series for an agent capable of actions reaching the current state, based on a state transition probability model obtained by
performing learning of said state transition probability model stipulated by
a state transition probability that a state will be transitioned according to each of actions performed by an agent capable of actions, and
an observation probability that a predetermined observation value will be observed from said state,
using
an action performed by said agent, and
an observation value observed at said agent when said agent performs an action; and
a determining unit configured to determine an action to be performed next by said agent using said current-state series candidate in accordance with a predetermined strategy.

16. A program causing a computer serving as:
a calculating unit configured to calculate a current-state series candidate that is a state series for an agent capable of actions reaching the current state, based on a state transition probability model obtained by
performing learning of said state transition probability model stipulated by
a state transition probability that a state will be transitioned according to each of actions performed by an agent capable of actions, and
an observation probability that a predetermined observation value will be observed from said state,
using
an action performed by said agent, and
an observation value observed at said agent when said agent performs an action; and
a determining unit configured to determine an action to be performed next by said agent using said current-state series candidate in accordance with a predetermined strategy.
